(19) United States
(12) Patent Application Publication
(10) Pub. No.: US 2025/0368087 A1
(43) Pub. Date: Dec. 4, 2025

(54) SERVICE BASE ELECTRIC ENERGY SUPPLY AND SUPPLIED VEHICLE THROUGH SUPPLY SYSTEM OF INTERNET OF THINGS ARCHITECTURE

(71) Applicant: LEI HAN, SR., Beijing (CN)

(72) Inventor: LEI HAN, SR., Beijing (CN)

(21) Appl. No.: 18/863,629

(22) PCT Filed: Sep. 8, 2022
(86) PCT No.: PCT/CN2022/117820

§ 371 Date: Nov. 12, 2024

(30) Foreign Application Priority Data
May 8, 2022 (CN) 202210495566.0

(51) Int. Cl. B60L 53/68; B60L 53/66; B60L 53/80

(52) U.S. Cl. CPC B60L 53/68; B60L 53/66; B60L 53/80

(57) ABSTRACT

Various electric energy supply vehicles and electric energy supply vehicle control system; a to-be-replaced electric vehicle and an electric vehicle battery replacement control system; a robot, a robot driving system, a carrying robot and a carrying robot control system; a plurality of programmable controllers, a plurality of wireless programmable controllers, a plurality of charging and replacing cabinets, a charging and replacing cabinet control system, a plurality of programmable controllers, a plurality of wireless programmable controllers, a plurality of to-be-replaced electric vehicles with different structures, a constructed electric vehicle finding mode, a plurality of electric vehicles to be subjected to battery replacement, a construction battery swapping station link is omitted, one electric energy supply vehicle can provide replenishment for a plurality of electric vehicles, an electric energy supply vehicle is put according to the amount of electric vehicles, invalid investment is avoided, and a vehicle owner does not need to center the battery again.

### TECHNICAL FIELD

The invention relates to the field of electric vehicles, in particular to a supply system of a service base electric energy supply and supplied vehicle through an Internet of Things architecture.

### BACKGROUND

The “Paris Agreement” is achieved on the state that the climate change of the United Country Climate Change Framework is about 200 of the weather change frame of the United States in 2015, which plays a role in promoting the development of the electric vehicle through the attention of countries in the world to the environmental protection. The charging problem troubles the development of the electric vehicle, and the current best solution is the electric vehicle battery replacement mode. However, the current battery swap station also simulates the mode that the gasoline vehicle goes through the oil filling mode of the gasoline vehicle, that is, the electric vehicle battery replacement station finds the mode of replacing the power-deficient battery. The idea of the gas station is used for building a battery swap station to restrict the development of the electric vehicle. An electric vehicle battery replacement system needs to be built in a battery replacement mode with current as a characteristic. However, the number of existing fixed battery replacing stations is small, and the vehicle to be subjected to battery replacing needs to find the battery replacing station to carry out battery replacing so as to restrict the development of the automobile with power. The service thought of taking the battery swap station as the center is adopted. The service is changed into a service centered on a vehicle to be subjected to battery replacement.

### SUMMARY OF THE PRESENT INVENTION

The number of existing fixed battery replacing stations is small, a battery replacing station needs to find a battery replacing station to carry out battery replacing, and the development of an automobile taking the battery as power is restricted. In order to solve the problem, the invention provides a current situation that a battery replacing system is built by using the thought conforming to current characteristics, namely the electric vehicle finding mode, and the current situation that the number of current battery replacing stations is smaller than that of vehicles at present is solved. The service thought of taking the battery replacing station as the center is changed, the service thought of taking the battery replacing vehicle as the center is changed, the intelligent battery replacing trolley becomes a nymnam of the electric automobile, and a driver of the electric automobile is not subjected to de-battery service of the battery center of the battery any more. In order to achieve the purpose, the service base electric energy supply and replenishment vehicle provided by the invention is composed of the following systems through a supply system of the Internet of Things architecture: a plurality of intelligent battery replacement vehicles and an intelligent battery replacement control system; a robot and a robot driving system, a carrying robot and a carrying robot control system The light supplementing lamp, the manipulator control system, the robot slider control system, the rear vehicle door control system, the side vehicle door control system, the plurality of charging and replacing cabinets and the charging and replacing cabinet control system, the plurality of programmable controllers, the plurality of wireless programmable controllers and the plurality of to-be-replaced electric vehicles with different structures.

The method has the following beneficial effects that the service base electric energy supply and supply vehicle carries out battery replacement service on the battery to be replaced through an electric vehicle finding mode constructed by a supply system of the Internet of Things architecture, the construction battery swap station link is omitted, the condition of large-scale investment building and battery swap station is reduced, operation is easy and convenient, the site is saved, one intelligent battery replacement vehicle can provide replenishment for a plurality of electric vehicles, the intelligent battery replacement vehicle can be put according to the amount of electric vehicles, and invalid investment is avoided. The vehicle owner is battery-removed, so that the vehicle owner does not need to center the battery.

### BRIEF DESCRIPTION OF THE DRAWINGS

FIG. 1 is a structural diagram of a supply system of a service base electric energy supply and replenishment vehicle passing through an Internet of Things architecture according to the present application;

FIG. 2 is a schematic structural diagram of a rear door system of an intelligent battery replacement vehicle according to the present application;

FIG. 3 is a side view of an intelligent battery replacing vehicle in a headquarters base charging pile charging and intelligent battery replacing vehicle according to the present application;

FIG. 4 is a schematic structural diagram of an open state of a rear hydraulic folding door of an intelligent battery replacing vehicle of the present application;

FIG. 5 is a schematic diagram of a charging system of an intelligent battery replacement vehicle of the present application;

FIG. 6 is a schematic structural diagram of a side portion of an intelligent battery replacement vehicle on a door open top rail according to the present application;

FIG. 7 is a top view of an intelligent battery replacing vehicle in a public charging pile charging and intelligent battery replacing vehicle according to the present application;

FIG. 8 is a coordinate system diagram of a robot, a first, a second and a third charging and replacing cabinet of the intelligent battery replacing vehicle of the present application;

FIG. 9 is a schematic structural diagram of a robot according to the present application;

FIG. 10 is a structural diagram of a first leveling control system of the present application;

FIG. 11 is a perspective view of a robot moving device of the present application;

FIG. 12 is a perspective view of a remote console according to the present application;

FIG. 13 is a top view of a manipulator of the present application;

FIG. 14 is a side cross-sectional view of a robot manipulator of the present application;

FIG. 15 is a schematic side view of a first process when a battery box is held in a manipulator holding area of the present application;

FIG. 16 is a schematic side view of a second process when the battery box is held in the manipulator holding area of the present application;

FIG. 17 is a block diagram of a manipulator control system of the present application;

FIG. 18 is a block diagram of a robot mobile device control system of the present application;

FIG. 19 to FIG. 23 are schematic structural diagrams of a first battery box system 243 of a first charging and replacing cabinet and a second charging and replacing cabinet of the present application;

FIG. 24 is a front view of a first bracket of the present application;

FIG. 25 is a top view of a first support of the present application;

FIG. 26 is a block diagram of a first battery box control system of the present application;

FIG. 27 is a perspective view of a floating plug body of a magnetic attraction plug-in dual-effect connector of the present application;

FIG. 28 is a front cross-sectional view of a magnetic attraction plug-in dual-acting connector plug of the present application;

FIG. 29 is a common connection mode of a power supply surge protector and a power line in a circuit in parallel;

FIG. 30 is a front cross-sectional view of a magnetic attraction plug-in dual-acting connector socket of the present application;

FIG. 31 is a schematic diagram after the magnetic attraction plug-in dual-acting connector is inserted in place according to the present application;

FIG. 32 is a front view of a magnetic attraction plug-in dual-acting connector plug of the present application;

FIG. 33 is a perspective view of a magnetic attraction plug-in dual-acting connector floating socket body of the present application;

FIG. 34 is a front view of a magnetic attraction plug-in dual-acting connector socket of the present application;

FIG. 35 is a connection diagram of a rear door control system, a side door control system and a first to twelfth battery compartment control system and a first programmable controller according to the present application;

FIG. 36 is a schematic diagram of connection between a third charging and replacing cabinet front view and a third charging and replacing cabinet and a charging pile in the present application;

FIG. 37 is a structural diagram of a battery box bin of a third charging and replacing cabinet according to the present application;

FIG. 38 is a perspective view of a third charging and replacing cabinet cooling bin of the present application;

FIG. 39 is an internal logic equivalent diagram of a first wireless programmable controller of the present application;

FIG. 40 is a structural diagram of a thirteenth charging and replacing battery box control system to a sixteenth charging and replacing battery box control system in the present application;

FIG. 41 is a top view of a transfer robot of the present application;

FIG. 42 is a perspective view of a deviation rectifying mechanism of a carrying robot of the present application;

FIG. 43 is a structural diagram of a lifting mechanism of a carrying robot of the present application;

FIG. 44 and FIG. 46 are structural diagrams of a terminal platform of a carrying robot of the present application;

FIG. 45 is a structural diagram of a transfer robot according to the present application;

FIG. 47 is a block diagram of a control system of a handling robot according to the present application;

FIG. 48, FIG. 49, FIG. 51 and FIG. 53 are structural diagrams of a first lifter and a fourth lifter on an electric vehicle chassis according to the present application;

FIG. 50 is a structural diagram of a second double-acting multi-stage hydraulic cylinder system according to the present application;

FIG. 52 is a two-dimensional code setting diagram arranged on an electric vehicle and a chassis according to the present application;

FIG. 53 is a top view of an electric vehicle landing leg lifting system of the present application;

FIG. 54 is a structural diagram of a battery box and a two-dimensional code arranged on the battery box according to the present application;

FIG. 55, FIG. 56, and FIG. 57 are structural diagrams of a two-dimensional code used in the present application;

FIG. 58 to FIG. 61 and FIG. 54 are schematic structural diagrams of a battery box controller on an electric vehicle chassis according to the present application;

FIG. 62 is a block diagram of an electric vehicle battery replacement control system of the present application;

FIG. 63 to FIG. 66 are pattern diagrams of first, second, third and fourth driving paths of a transfer robot released by the intelligent battery replacement vehicle of the present application;

FIG. 64 is a battery replacement operation diagram of a third to-be-replaced electric vehicle and an intelligent battery replacement vehicle in the present application;

FIG. 65 and FIG. 63 are a mode diagram of a third driving path of a transfer robot released by the intelligent battery replacement vehicle of the present application;

FIG. 65 and FIG. 66 are a mode top view of a fourth driving path of a transfer robot released by the intelligent battery replacement vehicle of the present application;

FIG. 67 is a block diagram of a robot control system of the present application;

FIG. 68 is a battery replacement operation diagram of a second electric vehicle to be subjected to battery replacement and an intelligent battery replacement according to the present application;

FIG. 69 is a battery replacement operation diagram of a second to-be-replaced electric vehicle and a fourth charging and replacing cabinet in the present application;

FIG. 70, FIG. 76 and FIG. 77 are structural diagrams of a replacement system of a battery box of a second electric vehicle of an electric vehicle to be subjected to battery replacement according to a second embodiment of the present application;

FIG. 75 is a structural diagram of a battery replacement control system of an electric vehicle to be subjected to battery replacement according to a second embodiment of the present application;

FIG. 78 and FIG. 83 are structural diagrams of a lifting system of a second carrying robot of the present application;

FIG. 84 is a block diagram of a second transport robot control system of the present application;

FIG. 85 to FIG. 87 are a protection plate rotation system structure of a third electric vehicle to be subjected to battery replacement according to the present application;

FIG. 88 is a diagram of a third electric vehicle control system to be subjected to battery replacement according to the present application.

### DETAILED DESCRIPTION OF THE EMBODIMENTS

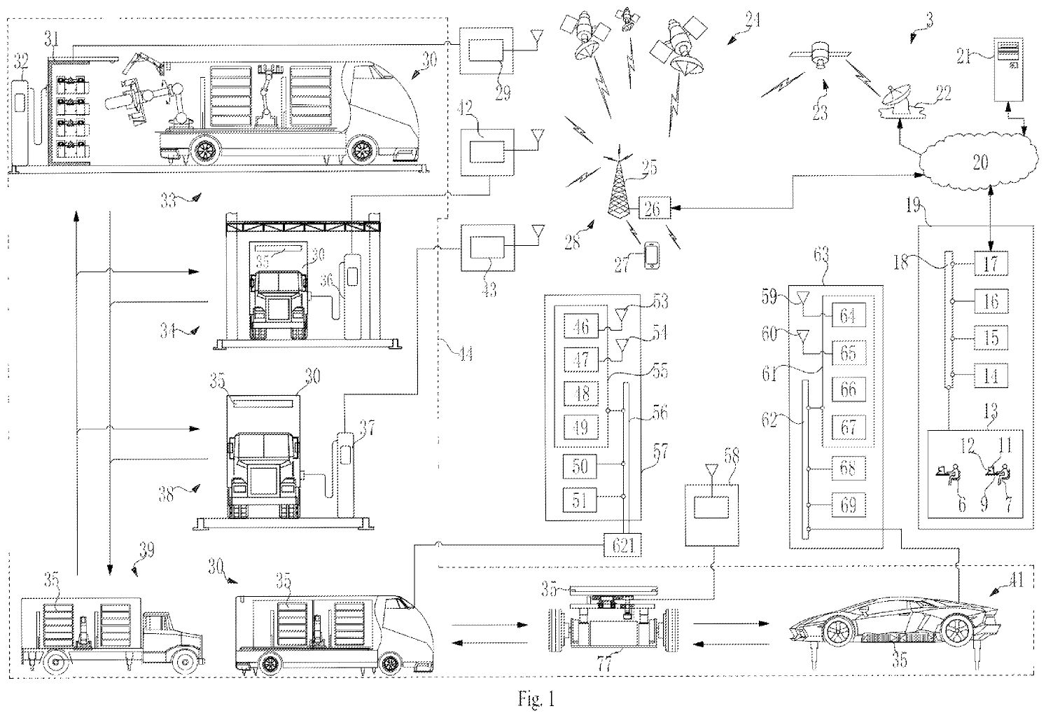

As shown in FIG. 1-88, the service base electric energy supply and replenishment vehicle is composed of a remote control system 2, an intelligent battery replacement control system 45, a carrying robot control system 442, an electric vehicle battery replacement control system 600, a third charging and replacing cabinet control system 362, a first supply base system 34 and a second supply base system 38 and supports the circulation of the battery box conveying network 44.

The remote control system 2 is provided with a remote communication system 1, a standby remote communication system 4 and a remote service terminal system 19.

The remote communication system 1 has a wireless carrier system 28, a global navigation satellite system 24, a communication satellite 23, an uplink transmitting station 22, a computer 21, and a ground network 20.

The wireless carrier system 28 is a cellular telephone system having a cellular tower 25, a mobile switching center 26, and other networking components required to connect the wireless carrier system 28 to the terrestrial network 20. The cellular tower 25 has a transmitting and receiving antenna and a base station, a base station from different cellular towers 25 is directly connected to the mobile switching center 27 or a communication technology implemented by an intermediate device of the base station controller is connected to the mobile switching center 27 wireless carrier system 28, and the communication technology implemented by the wireless carrier system 28 has an AMPS analog technology and a CDMA and GSM/GPRS digital technology.

A global navigation satellite system 24 is a space-based radio navigation positioning system capable of providing all-weather three-dimensional coordinates and speed and time information for a user at any place on the earth surface or near-earth space.

The communication satellite 23 serves as an artificial earth satellite of a radio communication relay station, and the communication satellite can transmit telephone and data information.

An uplink transmitting station 22, an uplink finger signal, from a mobile station to a physical channel of a base station.

The computer 21 provides a computer for Internet connection access, provides a DNS service and serves as a network address server, which uses DHCP or other appropriate protocols to assign IP addresses to the intelligent battery swapping vehicle 30 and the electric vehicle 41.

The terrestrial network 20 has a public switched telephone network (PSTN) and an Internet Protocol (IP) network, a standard wired network, an optical fiber network, a cable network, and a wireless network.

The remote service terminal system 19 has a second switch 17, a server 16, a database 15, a computer device 14, and a remote console system 13 communicatively connected via a wired and wireless local area network 18.

The second switch 17 routes an input signal, transmits voice transmission to a remote client attendant 6 of the remote console system 13, and transmits the data transfer to the computer device 14 for demodulation and further signal processing.

A computer device 14 has an encoder connected to a server 16 and a database 15.

The server 16 transmits and receives data information stored in a database 15, a first telematics unit 55, and a second telematics unit 61.

The database 15 can store account information, user authentication information and a vehicle identifier, and can also perform data transmission through a wireless system 422.11 X and GPRS. The remote console system 13 has a remote console 5, a remote operator 7, and a remote client attendant 6.

An input device 9, a display device 10, a second memory 11 (RAM, ROM), and a second processor 12 (CPU, GPU) having a remote console 5 are communicatively connected by a third communication bus 8. The input device 9 has a keyboard of a plurality of operating keys for receiving an input operation of a remote operator 7. The display device 10 displays data for the LCD organic EL display as an image to the remote operator 7, the remote operator 7 starts to execute remote control work after the remote console 5 activates the second processor 12, and the remote client attendant 6 is responsible for voice and text services of the client.

The standby remote communication system 4 completes one-way communication and two-way communication between the remote service terminal system 19 and the first charging base communication system 29, the second charging base communication system 42, the third charging base communication system 43, the intelligent battery replacement communication system 57 and the electric vehicle communication system 63 by using the communication satellite 23 and the uplink transmitting station 22.

As shown in FIG. 1, the third communication bus 8 of the remote communication system 1 is connected with the wired and wireless local area network 18, the second processor 12 is connected with the first switch 13, the first switch 13 is connected with the wired and wireless local area network 18, the wired and wireless local area network 18 is connected with the second switch 17, the second switch 17 is connected with the ground network 20, the ground network 20 is connected with the mobile switching center 26, the mobile switching center 26 is connected with the wireless carrier system 28, and the wireless carrier system 28 is wirelessly connected with the first charging base communication system 29, the second charging base communication system 42, the third charging base communication system 43, the intelligent battery replacement communication system 57 and the electric vehicle communication system 63. A first cellular chipset 47 included in a first telematics unit 55 of a wireless carrier system 28 and an intelligent tram communication system 57 performs cellular communication via a first main antenna 54 via a cellular protocol. A first communication bus 56 having a smart battery swapping communication system 57 is connected to a data acquisition device 621 of a robot control system 618. The first short-range wireless communication circuit 46 is connected to the wireless communication unit 343 via a second antenna 355 of the first transfer robot 77 via a first short-range wireless communication antenna 53. A second cellular chipset 64 included in a second telematics unit 61 of the wireless carrier system 28 and the electric vehicle communication system 63 performs cellular communication via a second main antenna 59 via a cellular protocol. The wireless carrier system 28 is connected with a second wireless programmable logic controller 361 through a first antenna 354 and a cellular wireless network antenna interface 347, and the second wireless programmable logic controller 361 is connected with a thirteenth battery compartment control system 653, a fourteenth battery compartment control system 654, a fifteenth battery compartment control system 655 and a sixteenth battery compartment control system 656.

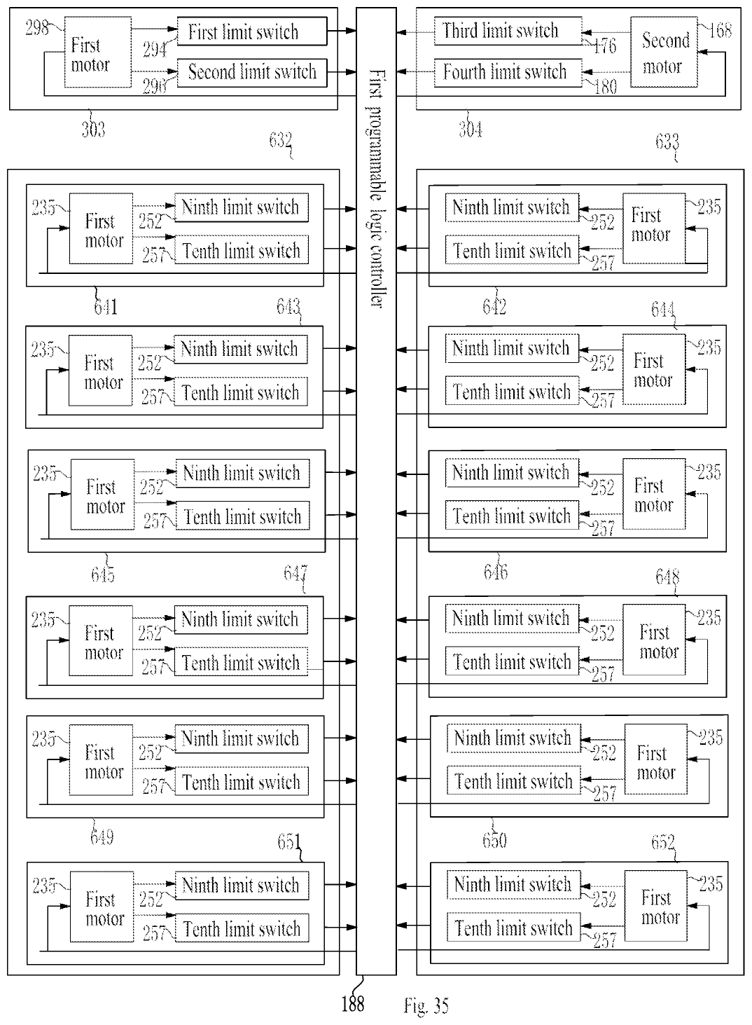

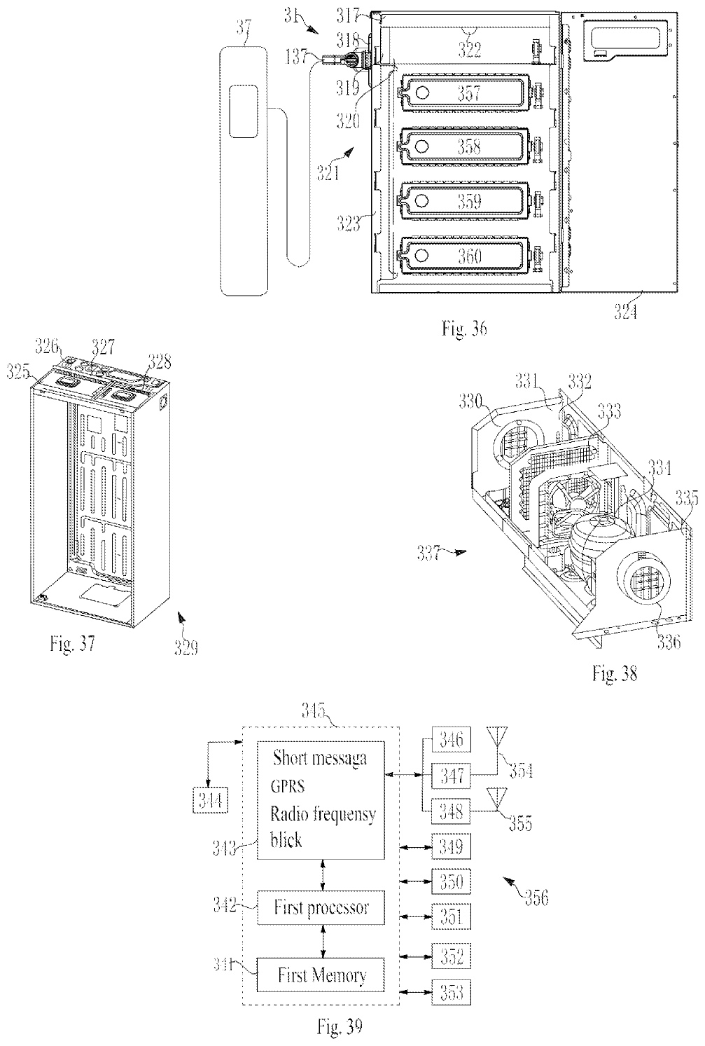

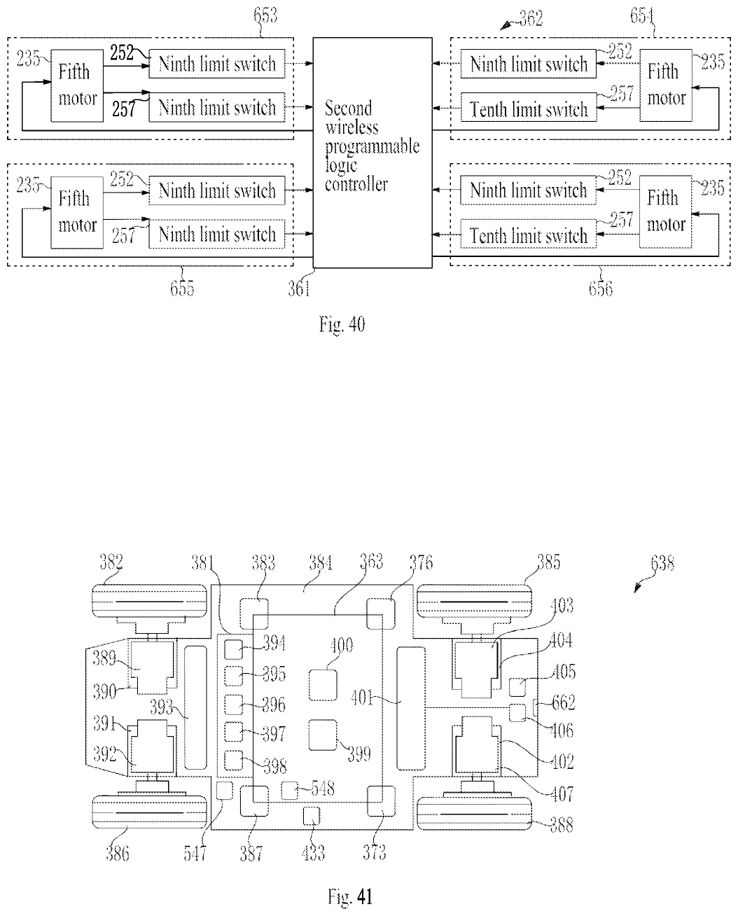

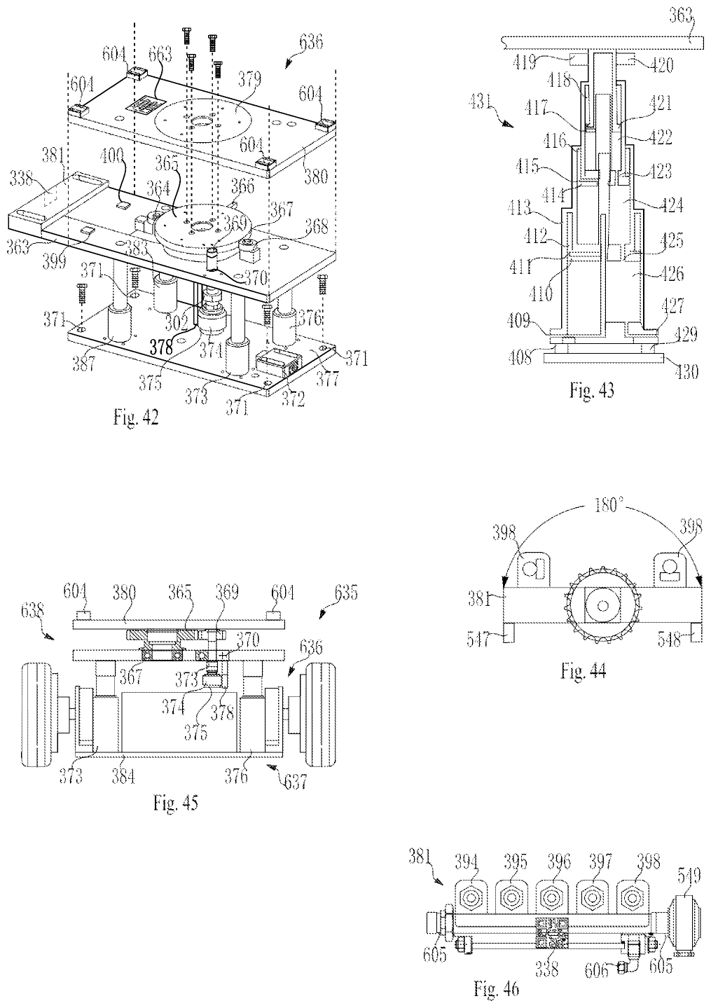

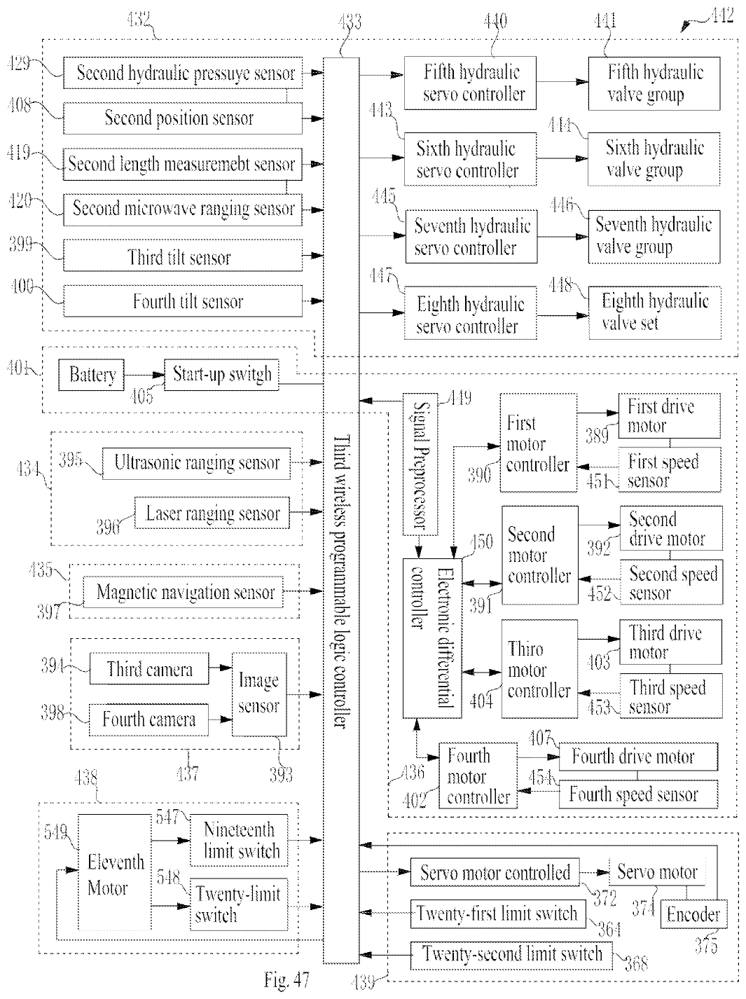

As shown in FIG. 1 to FIG. 47 and FIG. 67, the intelligent battery replacement control system 45 is provided with a tool of a transport battery box 35 capable of driving, an intelligent battery replacement vehicle 30 with a passenger car body and a second intelligent battery replacement vehicle 39 with a container as a vehicle body, and the intelligent battery replacement control system 45 is provided with an intelligent battery replacement communication system 57, an intelligent battery replacement charging system 128, a rear vehicle door control system 303 and a rear vehicle door system 146; a side door control system 304, and a side door system 158; a robot slider control system 226, and a robot slider system 83; a first leveling control system 197, a manipulator control system 225 and a manipulator system 200; a first charging and replacing cabinet control system 632, a first charging and replacing cabinet 72, a second charging and replacing cabinet control system 633, a second charging and replacing cabinet 75, a magnetic attraction and plugging double-acting connector system 278, a robot control system 618, a robot 78, a third charging and replacing cabinet control system 362, a third charging and replacing cabinet 31, a carrying robot control system 442, a carrying robot system 638, a first carrying robot 77, a second carrying robot 79, a monitor 73, a first bracket 80, a second bracket 81 and a plurality of supporting legs: a first supporting leg 84, a second supporting leg 85, a third supporting leg 86 and a fourth supporting leg 87.

A first telematics unit 55, a first global navigation satellite system receiver 50, and a first on-board computer 51 are communicatively connected by a first communication bus 56. The first communication bus 56 provides a network connection to the intelligent tram communication system 57 using a network protocol. A first global navigation satellite system receiver 50 receives radio signals from a global navigation satellite system 24. The first global navigation satellite system receiver 50 may be configured for various GNSS systems. The first telematics unit 55 has a first short-range wireless communication circuit 46, a first cellular chipset 47, a first processor 48, a first memory 49, a first short-range wireless communication antenna 53, and a first main antenna 54 that are connected to the first short-range wireless communication antenna 53 and the first short-range wireless communication circuit 46. The first main antenna 54 is connected to the first cellular chipset 47. The first remote information processing unit 55 is configured to perform any one of wireless communication, Wi-Fi™, Itaion™, Wi-Fi™ Direct, other IEEE 802.11 protocols, Geiger EE™, Bluetooth™, and Bluetooth™ according to the first short-range wireless communication circuit 46. The first processor 48 is a device for processing electronic instructions having a microprocessor, a microcontroller, a main processor, a controller, a vehicle communication processor, and an application specific integrated circuit (ASIC)).

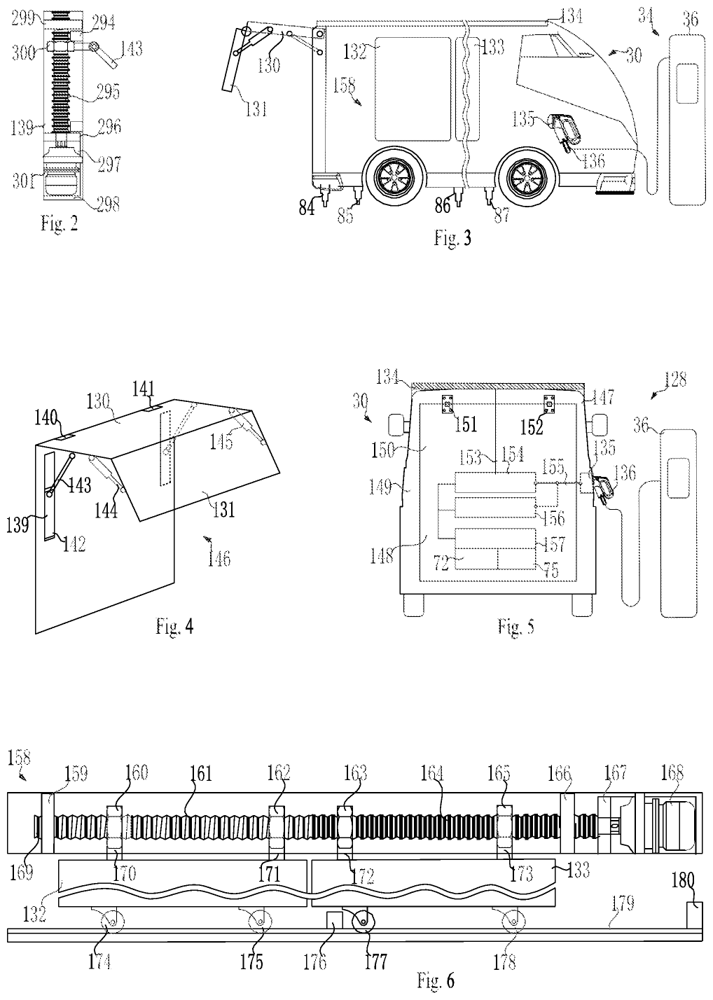

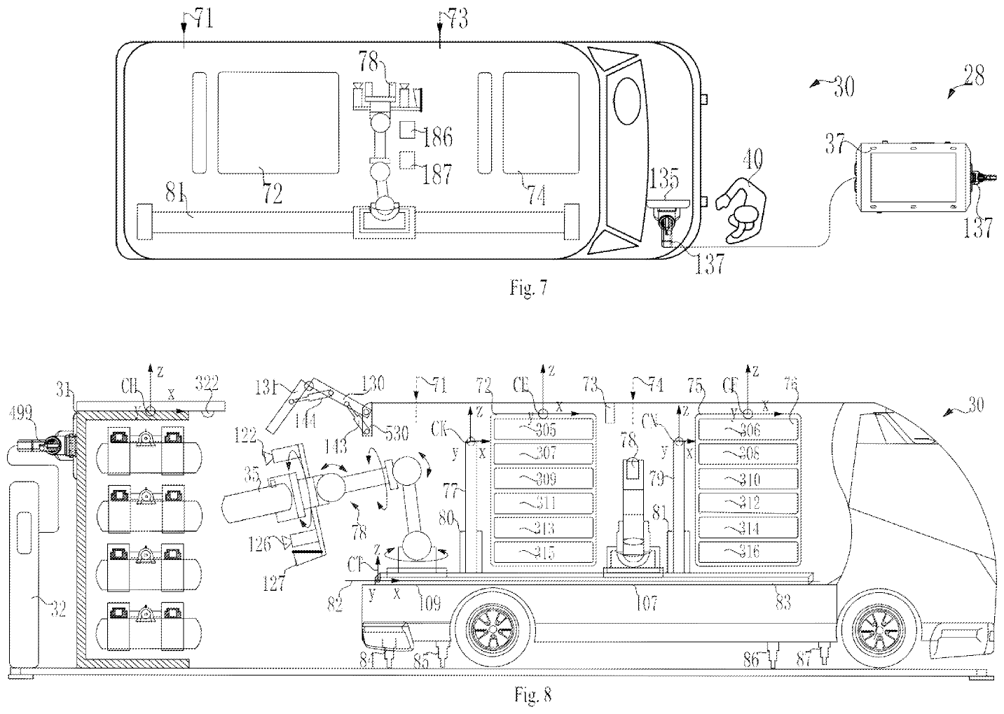

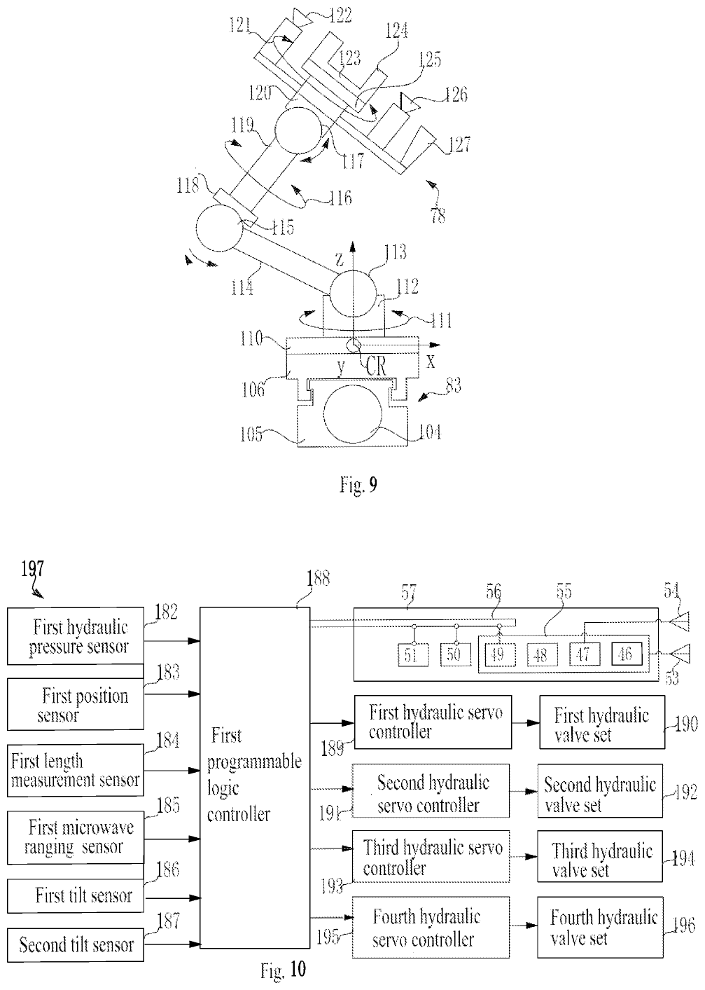

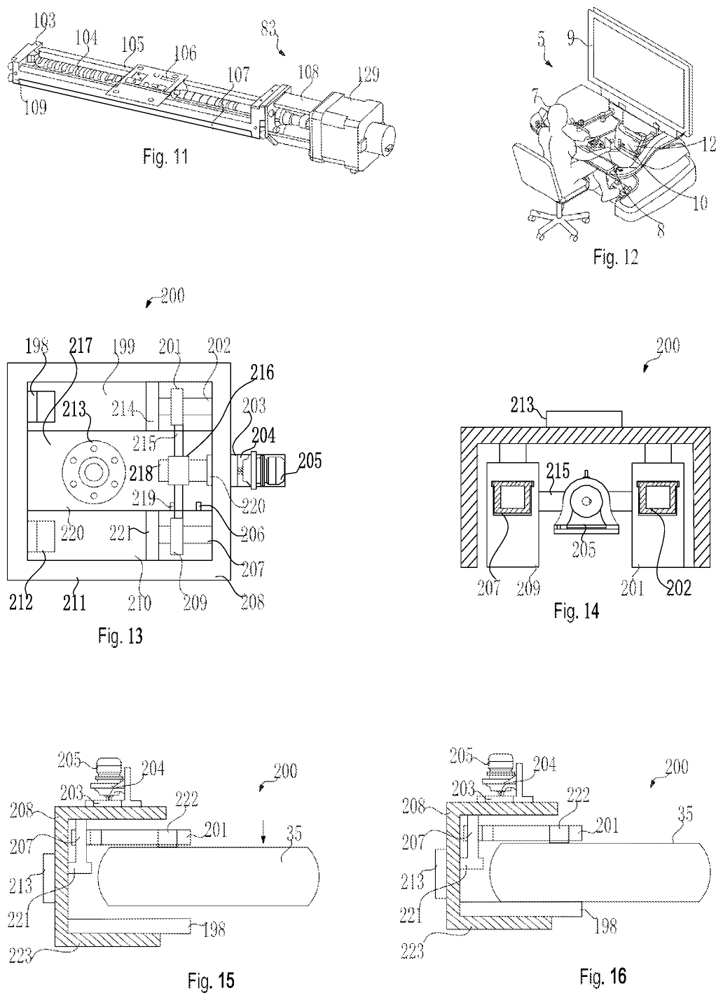

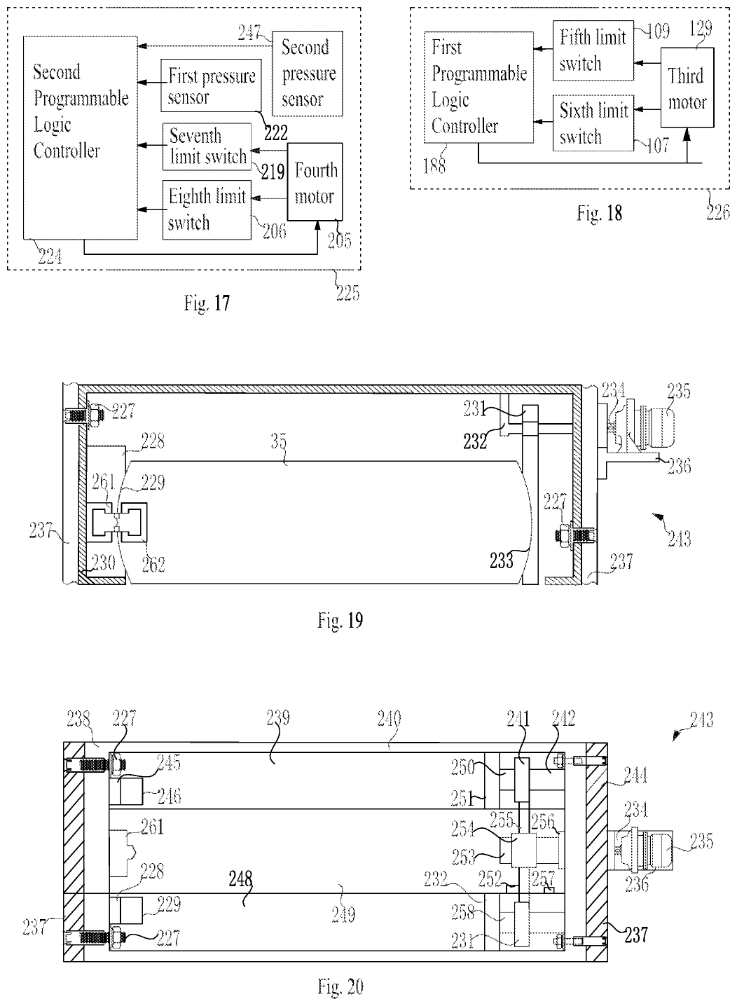

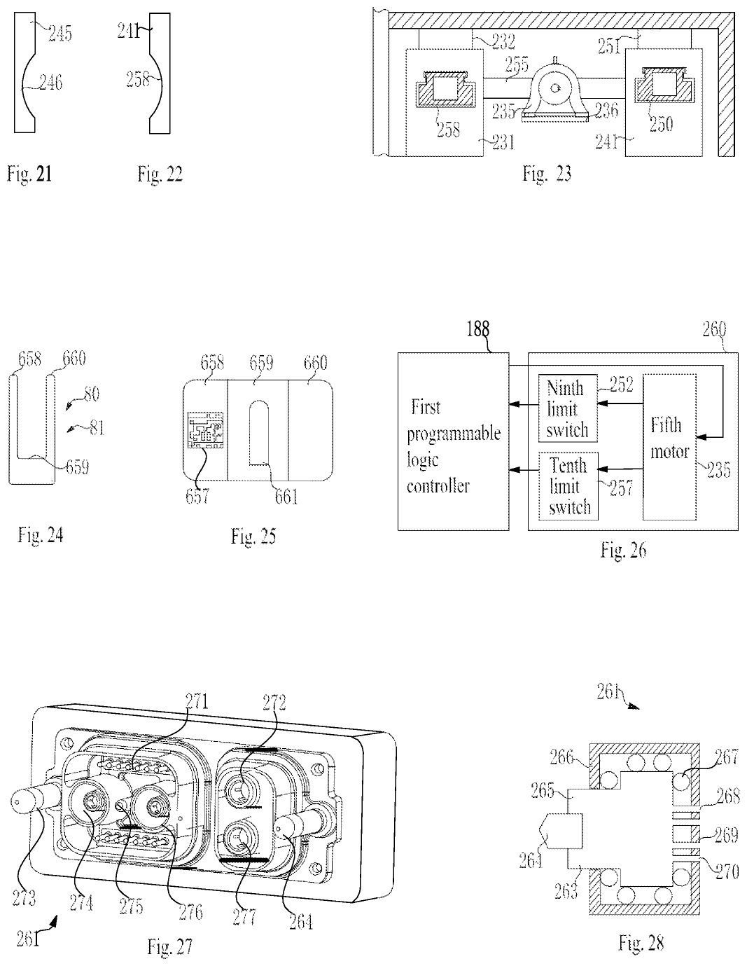

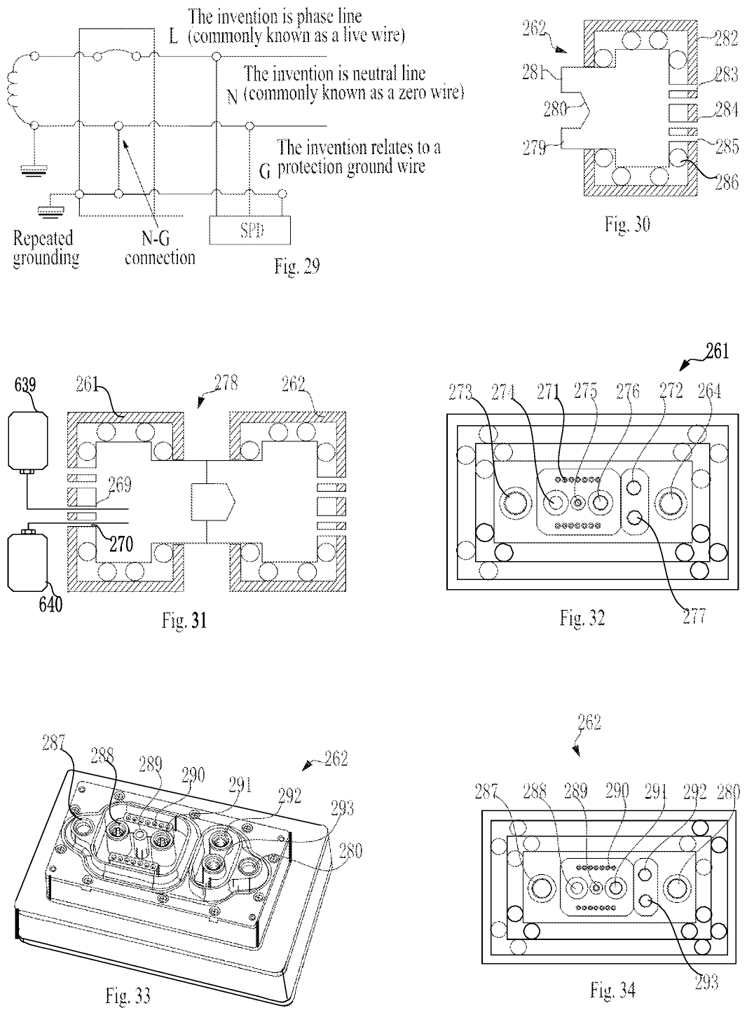

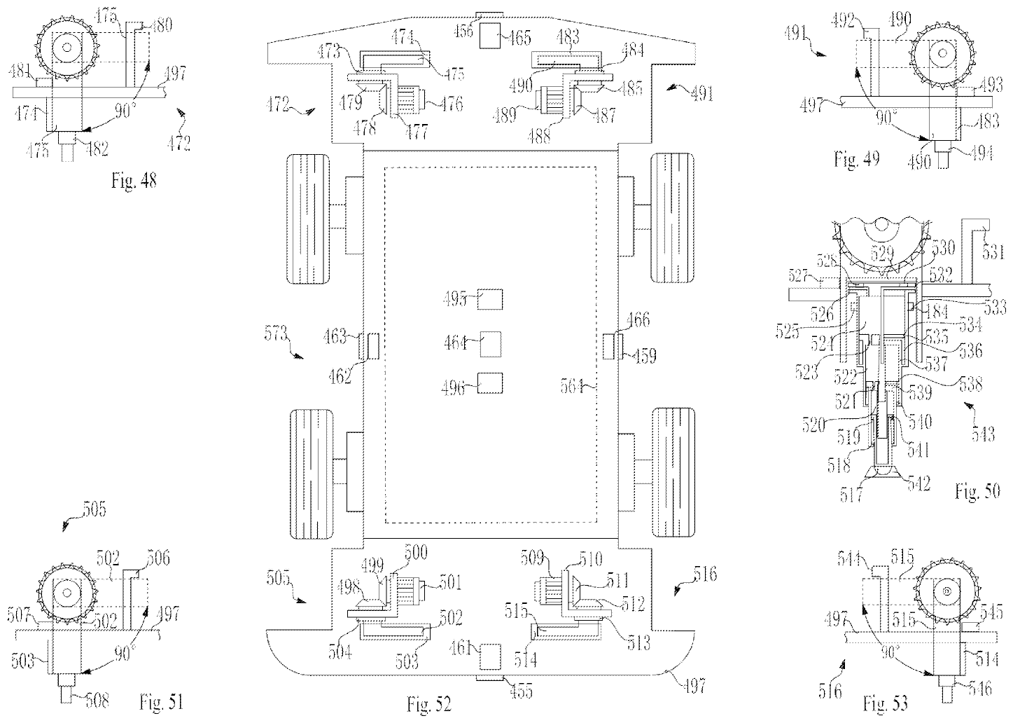

As shown in FIG. 3 and FIG. 5, the intelligent battery replacing charging system 128 of the intelligent battery replacing system 33 is provided with a photovoltaic cell layer 134, a charging controller 154, a vehicle-mounted charging device (OBC) 156, a battery management system (BMS) 157, a first charging and replacing cabinet 72 and a second charging and replacing cabinet 75, and the charging controller 154 controls rapid charging; the on-board charging device (OBC) 156 controls slow charging, and the battery management system (BMS) 157 manages and charges the first charging and replacing cabinet 72 and the second charging and replacing cabinet 75. A charging controller 154, an on-board charging device (OBC) 156, and a battery management system (BMS) 157 are communicatively connected by a controller area network (CAN). The charging controller 154 and the on-board charging device (OBC) 156 are connected to a charging interface 135 of the intelligent battery swapping vehicle 30 by means of a first line 155. The photovoltaic cell layers 134 mounted on the front, rear, left, right and top parts of the compartment of the intelligent battery replacing vehicle 30 are connected with the charging controller 154 through the second circuit 153. The photovoltaic cell layer 134 absorbs solar energy, and charges the first charging and replacing cabinet 72 and the second charging and replacing cabinet 75 through the charging controller 154.

As shown in FIG. 1 to FIG. 7, the cycle of a full-power battery box and a power-deficient battery box is completed in a battery box transport network 44. The intelligent battery replacement vehicle 30 is opened to a parking lot in view with an electric vehicle 41 to be subjected to battery replacement, a battery box 35 with power shortage in the electric vehicle 41 to be subjected to battery replacement is taken out, a battery box 35 fully charged is replaced, and the power shortage battery box 35 is transported back to the first charging base 34, the second charging base 38 and the third charging and replacing cabinet 31 by the intelligent battery replacement vehicle 30 for charging and replacing. After the intelligent battery replacing vehicle 30 returns to the first charging base 34, the driver 40 inserts the charging gun 136 of the self-charging pile 36 onto the charging interface 135 of the intelligent battery replacing vehicle 30, is connected with the charging interface 135 through the charging gun 136, and charges the battery box 35 in the first charging and replacing cabinet 72 and the second charging and replacing cabinet 75 of the intelligent battery replacing vehicle 30. The intelligent battery replacing vehicle 30 reaches the public charging pile 37 of the second charging base 38, the driver 40 inserts the charging gun 137 of the public charging pile 37 into the charging interface 135 of the intelligent battery replacing vehicle 30, the public charging gun 137 is connected with the charging interface 135, and the battery box 35 in the first charging and replacing cabinet 72 and the second charging and replacing cabinet 75 of the intelligent battery replacing vehicle 30 are charged.

As shown in FIGS. 2-5 and FIG. 35, a third threaded lead screw section 295, a fourth support 299, a fifth support 297, a sixth support 301, a first limiting switch 294 and a second limiting switch 296 which are installed on a bottom plate 139 of a first side face 142 of a rear door frame 149 of the intelligent battery replacing vehicle 30 are provided with a third threaded lead screw section 295, a fourth support 299, a fifth support 297, a sixth support 301, a first limiting switch 294 and a second limiting switch 296; the lower end of the first supporting rod 143 is connected with the fifth nut 300, and the lower end of the first air pressure rod 145 is hinged to the upper portion of the inner side face of the rear vehicle door upper section 130; and the upper end of the first air pressure rod 145 is hinged to the upper portion of the inner side face of the rear vehicle door lower section 131. And the lower end of the second air pressure rod 144 is hinged to the upper portion of the inner side face of the rear vehicle door upper section 130; and the upper end of the second air pressure rod 144 is hinged to the upper portion of the inner side face of the rear vehicle door lower section 131. The upper ends of the first hinge 140 and the second hinge 141 are connected with a rear door frame 149 of the intelligent battery replacing vehicle 30; and the lower ends of the first hinge 140 and the second hinge 141 are connected with the rear door upper section 130. The first limit switch 294 and the second limit switch 296 of the rear door control system 303 are connected with the first programmable logic controller 188, the first limit switch 294 and the second limit switch 296 are connected with the first motor 298, and the first motor 298 is connected with the first programmable logic controller 188.

As shown in FIG. 3, FIG. 6 and FIG. 35, a side door system 158 installed on a side 147 of a compartment of an intelligent battery replacing vehicle 30 has a threaded screw 169, a lower rail 179, a first sliding door 132, a second sliding door 133, a first bracket 159, a second bracket 166, and a third bracket 167. A third limiting switch 176 and a fourth limiting switch 180 are mounted on the lower rail 179. The first lead screw section 161 penetrates through the first support 159, the first nut 160 and the second nut 162. The second lead screw section 164 penetrates through the second support 166, the third nut 163 and the fourth nut 165, the first nut 160 is connected with the first connecting block 170, the second nut 162 is connected with the second connecting block 171, the third nut 163 is connected with the third connecting block 172, and the fourth nut 165 is connected with the fourth connecting block 173. The first connecting block 170 and the second connecting block 171 are connected with the first sliding door 132; and the third connecting block 172 and the fourth connecting block 173 are connected with the second sliding door 133. The first programmable logic controller 188 is connected with a third limiting switch 176 and a fourth limiting switch 180 which are arranged on the side door control system 304, the second motor 168 is connected with the third limiting switch 176 and the fourth limiting switch 180, and the second motor 168 is connected with the first programmable logic controller 188.

As shown in FIGS. 9 and 13-17, a robot 78 mounted on a robotic slider system 83 has a base 110, a rotating body 112 supported so as to be rotatable relative to the base 110 about a vertical first axis 111; and a first arm 114 that is supported so as to be rotatable relative to the rotating body 112 about a horizontal second shaft 113; and a second arm 118 supported so as to be rotatable relative to the first arm 114 about a horizontal third axis 115; and a first wrist element 119 supported so as to be rotatable relative to the second arm 118 about a fourth shaft 116 orthogonal to the third shaft 115; a second wrist element 120 supported to be rotatable relative to the first wrist element 119 about a fifth shaft 117 orthogonal to the fourth shaft 116; and a third wrist element 125 supported to be rotatable relative to the second wrist element 120 about a sixth shaft 121 orthogonal to the fifth shaft 117. a servo motor and an encoder are installed on each of the first shaft to the sixth shaft, a motor installed on the first shaft to the sixth shaft is always referred to as a robot driving motor 634, the robot driving motor 634 is used for rotating driving, and the encoder is used for detecting the rotation angle of the robot driving motor 634. A video sensor 631 mounted on the second wrist element 120 is composed of a first camera 122 and a second camera 126 that are separately configured. A manipulator 200 mounted on a second wrist element 120 on a third wrist element 125 captures or releases a battery case 35 by means of an opening and closing finger 124, and the finger 124 is composed of a first holding plate 201 and a second holding plate 209.

A first sliding rail 202, a second sliding rail 207, a first fixing plate 214 and a second fixing plate 221 are mounted on a first side surface 208 of a first mainboard 211 of the manipulator system 200, a first flange 213 is mounted in the middle of the first bearing plate 220, a first hollow groove 199 and a second hollow groove 210 are formed in the first main plate 211, a first grabbing plate 201 is vertically mounted on the first sliding rail 202, and the first grabbing plate 201 slides on the first sliding rail 202. A second holding plate 209 is vertically mounted on the second slide rail 207, and the second holding plate 209 slides on the second slide rail 207. A first pressure sensor 222 is installed on the first grabbing plate 201, a second pressure sensor 247 is installed on the second grabbing plate 209, a seventh limiting switch 219 and an eighth limiting switch 206 are installed on the lower portion of the first bearing plate 220, a third grabbing plate 198 and a fourth grabbing plate 212 are vertically installed on the third side face 217, a first fixing frame 203 is installed outside the first side face 208, and a first output shaft 204 of a fourth motor 205 installed on the first fixing frame 203 penetrates through the first fixing frame 203 through a coupler to be connected with the first rotating rod 220. A first lead screw section 218 is mounted on the first rotating rod 220, a first nut 216 is sleeved on the first lead screw section 218, a first connecting rod 215 is mounted on the first nut 216, and the first connecting rod 215 is connected with the first gripping plate 201 and the second gripping plate 209. The second programmable logic controller 224 of the manipulator control system 225 is connected with the seventh limit switch 219 and the eighth limit switch 206; the fourth motor 205 is connected with the seventh limit switch 219 and the eighth limit switch 206; and the fourth motor 205 is connected with the second programmable logic controller 224. The first pressure sensor 222 and the second pressure sensor 247 are electrically connected to the second programmable logic controller 224.

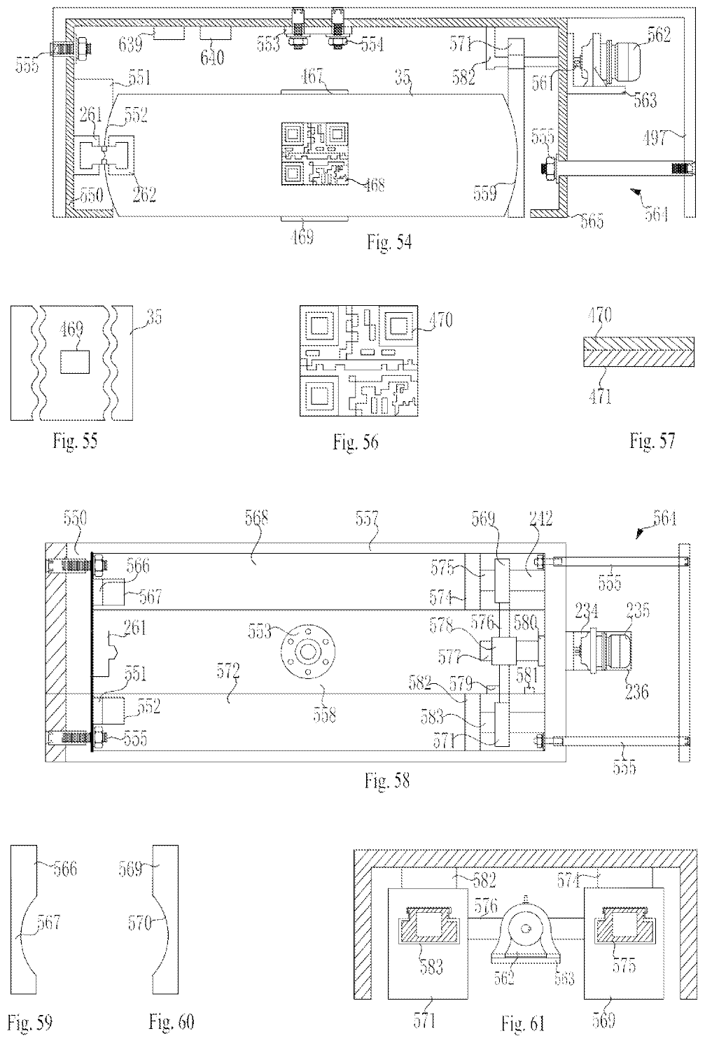

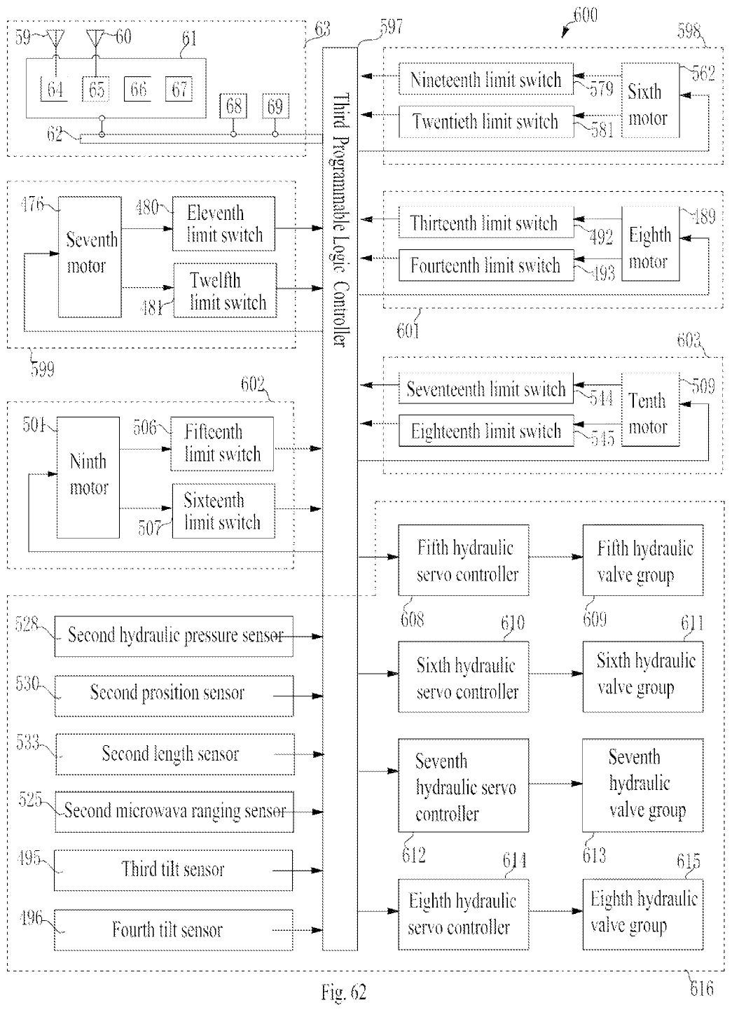

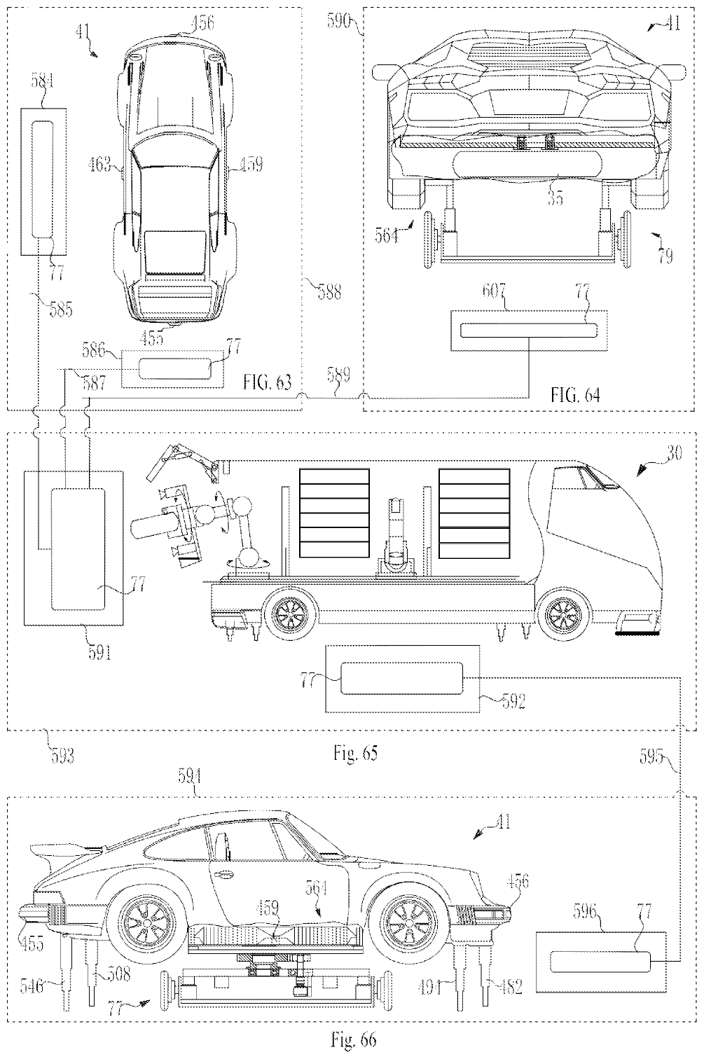

As shown in FIG. 8, FIG. 11 and FIG. 18, a stop block 103, a guide rail 105, a coupler 108, a fifth limit switch 109, a sixth limit switch 107 and a third motor 129 are installed on a robot slider system 83 installed on the intelligent battery replacement vehicle 30; a spiral guide rod 104 is installed on the guide rail 105; a fifth limiting switch 109 installation position and a second operation position 71 of the sliding base 106 are installed on the spiral guide rod 104; and the installation position of the sixth limiting switch 107 and the first operation position 74 are on a vertical line. The spiral guide rod 104 is connected with a coupler 108, and the coupler 108 is connected with a third motor 129. The first programmable logic controller 188 of the robot slider control system 226 is connected with the fifth limit switch 109 and the sixth limit switch 107, the third motor 129 is connected with the fifth limit switch 109 and the sixth limit switch 107, and the third motor 129 is connected with the first programmable logic controller 188. After the first programmable logic controller 188 controls the third motor 129 to drive the robot 78 installed on the sliding base 106, after the robot 78 arrives at the fifth limit switch 109 along the first axis 82 from the first operation position 74, the third motor 129 stops rotating, and the robot 78 reaches the second operation position 71; the robot 78 returns to the sixth limit switch 107 along the first axis 82, the third motor 129 stops rotating, and the robot 78 returns to the first operation position 74.

As shown in FIGS. 8-10 and FIG. 50, the first supporting leg 84, the second supporting leg 85, the third supporting leg 86 and the fourth supporting leg 87 of the intelligent battery replacing vehicle 30 are all composed of a first leveling control system 197 and a second double-acting multi-stage hydraulic cylinder 543. a first position sensor 183, a first length measuring sensor 184, a first microwave distance measuring sensor 185, a first inclination sensor 186, a second inclination sensor 187, a first hydraulic servo controller 189, a second hydraulic servo controller 191, a third hydraulic servo controller 193 and a fourth hydraulic servo controller 195 are all connected with the first programmable logic controller 188 through data lines. The first hydraulic servo controller 189 is connected with the first hydraulic valve group 190 through a data line; the second hydraulic servo controller 191 is connected with the second hydraulic valve group 192 through a data line; the third hydraulic servo controller 193 is connected with the third hydraulic valve group 194 through a data line; and the fourth hydraulic servo controller 195 is connected with the fourth hydraulic valve group 196 through a data line.

A first hydraulic pressure sensor 182 mounted on the lower portion of the second base 535 of the second double-acting multi-stage hydraulic cylinder 543 feeds back the data of its stress condition to the first programmable logic controller 188; the first position sensor 183 installed on the lower portion of the second base 535 detects the complete retraction state of the strut oil cylinder and feeds back data to the first programmable logic controller 188; the first length measuring sensor 184 is installed at the top of the second double-acting multi-stage hydraulic cylinder 543 to detect the telescopic position distance of the supporting column oil cylinder and feed back the telescopic speed and position data of the supporting column oil cylinder to the top of the hydraulic supporting column and used for detecting the distance from the supporting column to the ground and feeding back the data to the first programmable logic controller 188; and the first inclined sensor 186 and the second inclined sensor 187 are installed in the center of the chassis of the intelligent battery replacing vehicle 30 and used for detecting inclination data in the X-axis direction and the Y-axis direction.

The first programmable logic controller 188 sends a control signal to the first hydraulic servo controller 189, the second hydraulic servo controller 191, the third hydraulic servo controller 193 and the fourth hydraulic servo controller 195 according to data fed back by the sensor, and the first hydraulic servo controller 189 controls the first hydraulic valve set 190 to act according to the control signal; so that the second double-acting multi-stage hydraulic cylinder 543 of the first supporting leg 84 is controlled to complete the telescopic action to a designated position. The second hydraulic servo controller 191 controls the second hydraulic valve set 192 to act according to the control signal, so that the second double-acting multi-stage hydraulic cylinder 543 of the second supporting leg 85 is controlled to complete the telescopic action to a designated position. The third hydraulic servo controller 193 controls the third hydraulic valve set 194 to act according to the control signal, so that the second double-acting multi-stage hydraulic cylinder 543 of the third supporting leg 86 is controlled to complete the telescopic action to a designated position. The fourth hydraulic servo controller 195 controls the fourth hydraulic valve set 196 to act according to the control signal, so that the second double-acting multi-stage hydraulic cylinder 543 of the fourth supporting leg 87 is controlled to complete the telescopic action to a designated position. After the first supporting leg 84, the second supporting leg 85, the third supporting leg 86 and the fourth supporting leg 87 all reach a designated position, the leveling process of the first supporting leg 84, the second supporting leg 85, the third supporting leg 86 and the fourth supporting leg 87 of the first leveling control system 197 is as follows: the first leveling control system 197 controls the extending length of the supporting column oil cylinder according to the calculated distance from the supporting column to the ground, and the first length measuring sensor 184 corresponds to the value of the extending length of the detection supporting column oil cylinder until the first hydraulic pressure sensor 182 of the supporting column oil cylinder detects that the bearing pressure of the supporting column oil cylinder reaches a preset value, reading the first inclination sensor 186 and the second inclination sensor 187 to respectively detect the inclination state of the vehicle in the X-axis direction and the Y-axis direction; and the first leveling control system 197 calculates the chassis inclination state of the intelligent battery replacement vehicle 30 according to the feedback information of each sensor according to a preset model, gives a leveling control scheme according to the system setting, and controls each supporting column to complete automatic leveling according to the leveling control scheme.

As shown in FIGS. 19-23 and 26, a third fixing plate 251 and a fourth fixing plate 232 are installed on the lower portion of a second main plate 240 of the first battery box system 243, a third sliding rail 250 is installed on the third fixing plate 251, a fourth sliding rail 258 is installed on the fourth fixing plate 232, a third hollow groove 239 and a fourth hollow groove 248 are formed in the second main plate 240, a fifth grabbing plate 241 is vertically installed on the third sliding rail 250, a first gripper 258 is arranged on the fifth grabbing plate 241, and the fifth grabbing plate 241 slides on the third sliding rail 250. A sixth holding plate 231 is vertically mounted on the fourth slide rail 258, a second gripper 233 is arranged on the sixth holding plate 231, and the sixth holding plate 231 slides on the fourth slide rail 258. A plug 261 is mounted on the seventh side 238; a seventh holding plate 245 is vertically mounted on the seventh side surface 238, and a third gripper 246 is arranged on the seventh holding plate 245; an eighth grasping plate 228 is vertically mounted on the seventh side surface 238, a fourth gripper 229 is arranged on the eighth gripping plate 228, the first gripper 258, the second gripper 233, the third gripper 246 and the fourth gripper 229 are semicircular, a fifth motor 235 is mounted on a second fixing frame 236 which is convenient for fixing the battery box 35 to be mounted on the fifth side surface 244, and a second output shaft 234 of the fifth motor 235 penetrates through the second fixing frame 236 through the coupling and is connected with the second rotating rod 256. A second lead screw section 253 is installed on the second rotating rod 256, and the second nut 254 is sleeved on the second lead screw section 253. A second connecting rod 255 is installed on the second nut 254, and the second connecting rod 255 is connected with the fifth grabbing plate 241 and the sixth grabbing plate 231. a ninth limiting switch 252 and a tenth limiting switch 257 are installed on the lower portion of the second bearing plate 249, the first programmable logic controller 188 is connected with the ninth limiting switch 252 and the tenth limiting switch 257, the ninth limiting switch 252 and the tenth limiting switch 257 are connected with the fifth motor 235, and the fifth motor 235 is connected with the first programmable logic controller 188.

As shown in FIG. 8, FIG. 19 to FIG. 23 and FIG. 35, a plurality of first battery box systems 243 are respectively fixed on a first support 237 by first screws 227 to form a first battery compartment 305, a second battery compartment 313, a third battery compartment 309, a fourth battery compartment 311, a fifth battery compartment 313, a sixth battery compartment 315, and a second charging and swapping cabinet 75 in the first charging and swapping cabinet 72, and the eighth battery compartment 308, the ninth battery compartment 310, the tenth battery compartment 312, the eleventh battery compartment 314, and the twelfth battery compartment 316 control the first battery compartment control system 260 and a first battery compartment control system 641, a second battery compartment control system 643, a third battery compartment control system 645, a fourth battery compartment control system 647, a fifth battery compartment control system 649, a sixth battery compartment control system 651 and a second charging and swapping cabinet control system 633, which are formed by the first battery box system 243, have actions of a seventh battery compartment control system 642, an eighth battery compartment control system 644, a ninth battery compartment controller system 646, a tenth battery compartment control system 648, an eleventh battery compartment control system 650 and a twelfth battery compartment control system 652.

As shown in FIG. 27-34, the magnetic attraction plug-in dual-acting connector system 278 is provided with a plug 261 and a socket 262, the plug 261 is installed on the electric vehicle chassis device, and the socket 262 is installed on the battery box 35. The plug 261 has a plug housing 266, a plug damping rubber ball 267, a first output port 268, a second output port 269, a third output port 270, a floating plug body 263, and a floating plug body front end 265; a first N-pole magnet cone positioner 264, a second N-pole magnet cone positioner 273, a first high-voltage positive electrode plug-in piece 274, a first high-voltage negative electrode plug-in piece 276 and a first grounding plug-in piece 275 which are installed on the front end 265 of the floating plug body, the first pin array 271 is arranged to be two rows of 12 small-current pins, the first cooling air inlet 272 and the first cooling air outlet 277 are installed in the plug shell 266, and the plug shell 266 and the floating plug body 263 are arranged between the plug shell 266 and the floating plug body 263. The plug damping rubber ball 267 is in close contact with the inner wall of the plug shell 266 and the outside of the floating plug body 263, and has elasticity and buffering effects. The first output port 268 is a channel of a connecting pipeline of the first cooling air inlet 272 and the first cooling air outlet 277 entering the chassis of the electric vehicle; the second output port 269 is a channel connecting the first high-voltage positive electrode connector 274, the first high-voltage negative electrode connector 276 and the first grounding plug-in 275 into the electric vehicle chassis 497; and the third output port 270 is a channel of the first pin array 271 connecting line into the electric vehicle chassis 497.

The socket 262 is provided with a floating socket body 279, a socket shell 282, a fourth output port 283, a fifth output port 284, a sixth output port 285 and a socket damping rubber ball 286. The first S-pole magnet inverted cone positioner 280, the second S-pole magnet inverted cone positioner 287, the second high-voltage positive electrode connector 288, the second high-voltage negative electrode connector 291 and the second grounding connector 289 are installed on the floating socket body front end 281 of the floating socket body 279. The fourth output port 283 is a channel for connecting pipelines of the second cooling air inlet 292 and the second cooling air outlet 293 into the battery box 35; the fifth output port 284 is a channel for connecting a wire of the second high-voltage positive electrode connector 288 and the second high-voltage negative electrode connector 291 into the battery box 35; and the sixth output port 285 is a channel for connecting the second pin base 290 to the battery box 35.

As shown in FIG. 31 and FIG. 60, a signal line, a control line protector 640, and a power surge protector 639 first pin array 271 connecting line are connected in series to a signal line and a control line protector 640 at a lower portion of a third mainboard 557 of a vehicle-mounted battery box replacement system (564).

As shown in FIG. 29 and FIG. 31, the first high-voltage positive electrode plug-in piece 274, the first high-voltage negative electrode plug-in piece 276 and the first grounding plug-in piece 275 connecting wire are connected in parallel with the power supply surge protector 639.

The battery box 35 moves towards the plug 261, the socket 262 is gradually close to the plug 261, and the first N-pole magnet cone positioner 264 on the anisotropic phase suction plug 261 is gradually inserted into the first S-pole magnet inverted cone positioner 280 on the socket 262; and the second N-pole magnet cone positioner 273 on the anisotropic phase suction plug 261 is gradually inserted into the second S-pole magnet inverted cone positioner 287 on the socket 262. After the floating plug body 263 is in close contact with the floating socket body 279, the first high-voltage positive electrode plug connector 274 and the second high-voltage positive electrode connector 288 are inserted in place; and the first high-voltage negative electrode connector 276 and the second high-voltage negative electrode connector 291 are inserted in place; the first grounding plug connector 275 and the second grounding connector 289 are inserted in place; the first pin array 271 and the second pin base 290 are meshed in place; the first cooling air inlet 272 and the second cooling air inlet 292 are inserted in place, and after the first cooling air outlet 277 and the second cooling air outlet 293 are inserted in place, gas in the battery box 35 starts to circulate with an air cooling system in the electric vehicle 41. The plug damping rubber ball 267 and the socket damping rubber ball 286 are used for driving the floating socket body 279 to vibrate after vibration generated by movement of the electric vehicle is conducted to the battery box 35.

As shown in FIG. 39, the main control unit 345 of the first wireless programmable logic controller 356 is provided with a first memory 341, a first processor 342 and a wireless communication unit 343. The main control unit 345 is in signal connection with the input and output unit 344, the Ethernet communication unit 349, the RS485 communication unit 350, the RS232 communication unit 351 and the CAN communication unit 352. The main control unit 345 is connected to the power supply unit 353. The wireless communication unit 343 comprises a short message and GPRS communication radio frequency circuit. The wireless communication unit 343 is in signal connection with the SIM card seat interface 346, the cellular wireless network antenna interface 347 and the WiFi antenna interface 348. The cellular wireless network antenna interface 347 is in signal connection with the first antenna 354; the WiFi antenna interface 348 is in signal connection with the second antenna 355. The first wireless programmable logic controller 356 directly constructs a remote control system, has the functions of input acquisition, relay control, timer and serial port communication, GPRS, short message and wireless data transmission radio station communication, has five scanning period processes of reading input, executing a program, processing a communication request, executing CPU self-diagnosis and writing output on software, and also has the functions of channel management, driving management, acquisition management and application management and remote acquisition and management.

As shown in FIGS. 8, 19-23 and 36-40, the third charging and replacing cabinet 31 is provided with a box body 321, a door body 324, a top rainproof plate 317, a second monitor 322, a thirteenth battery box bin (357), a fourteenth battery box bin (358), a fifteenth battery box bin (359) and a sixteenth battery box bin (360), wherein the battery box bin 329 is installed in the box body 321, the thirteenth battery box bin 357, the fourteenth battery box bin 358, the fifteenth battery box bin 359 and the sixteenth battery box bin 360 are installed in the battery box bin 329. A compressor bin 337 is installed on the upper portion of a battery box bin 329, a door body 324 is installed on the front surface of the box body 321, a heat preservation layer 323 is installed in the box body 321, an air inlet 328 and an air outlet 327 are installed in the box body 321, the compressor bin 337 communicates with an external space below the box body 321 through an air inlet 328 and an air outlet 327, heat dissipation is conducted on the compressor bin 337, and a condenser 333 and a mounting compressor 334 are installed in the compressor bin 337; a side face air inlet 330 is formed in the first side face plate 331, and a charging gun 137 of the side face air outlet 336 public charging pile 37 is installed on the second side face plate 335 and is connected with the third charging and replacing cabinet 31 charging interface 318.

A second wireless programmable logic controller 361 is installed inside the third charging and replacing cabinet 31, and the second wireless programmable logic controller 361 is composed of functions of the first wireless programmable logic controller 356. A second wireless programmable logic controller 361 controls actions of a thirteenth battery compartment control system 653, a fourteenth battery compartment control system 654, a fifteenth battery compartment control system 655, and a sixteenth battery compartment control system 656 formed by the first battery box system 243. The second wireless programmable logic controller 361 is connected with the ninth limiting switch 252 and the tenth limiting switch 257, the ninth limiting switch 252 and the tenth limiting switch 257 are connected with the fifth motor 235, and the fifth motor 235 is connected with the second wireless programmable logic controller 361. a thirteenth battery compartment control system 653, a fourteenth battery compartment control system 654, a fifteenth battery compartment control system 655 and a sixteenth battery compartment control system 656 are simultaneously connected to a second wireless programmable logic controller 361.

As shown in FIG. 1 and FIG. 8, FIG. 9 and FIG. 67, the intelligent battery swap control system 45 includes a robot control system 618 and a remote console system 13, the robot control system 618 has a third memory 624 and a third processor 622, the third memory 624 has ROM and RAM to store various data, and the third processor 622 is a CPU or a GPU. The third memory 624 and the third processor 622 are communicatively connected via a fourth communication bus 623. a robot control system 618, a carrying robot control system 442, a third charging and replacing cabinet control system 362, a robot driving system 630, a light supplementing lamp 127, a manipulator control system 225, a robot slider control system 226, a second charging and replacing cabinet control system 633, a first programmable logic controller 188, a second programmable logic controller 224, a third programmable logic controller 752, a first leveling control system 197, a second leveling control system 432, a third leveling control system 616 and a fourth leveling control system 696.

The remote console system 13 has a remote console 5, a remote operator 7 and a remote client attendant 6 remote console 5 having an input device 9, a display device 10, a second memory 11 (RAM, ROM), and a second processor 12 (CPU, GPU) communicatively connected by a third communication bus 8. The input device 9 has a keyboard of a plurality of operating keys for receiving an input operation of a remote operator 7. The display device 10 displays data as an image for an LCD display. The remote console system 13 is communicatively connected to the robot control system 618 via a remote control system 2. A second processor 12 of the remote console 5 receives an input of an action program pre-generated by a remote operator 7 via an input device 9, and sends input information of the action command to an action program storage system 625 of a third memory 624 of the robot control system 618.

An operation control system 629 sends an operation instruction of a drive-side door system 158 to a first programmable logic controller 188 of a side door control system 304 according to a pre-generated action program of a remote operator 7 as hereinafter referred to as a pre-generated action program, and the first programmable logic controller 188 supplies power to the second motor 168 according to the action instruction. The action control system 629 sends an action instruction of the driven vehicle door system 146 to a first programmable logic controller 188 of the rear door control system 303 according to a pre-generated action program, and the first programmable logic controller 188 supplies power to the first motor 298 according to the action instruction. The action control system 629 sends an action program instruction for driving the robot 78 to the robot driving system 630 according to a pre-generated action program, and the robot driving system 630 is provided with a circuit for driving the robot to drive the motor 634, and the robot driving system 630 supplies power to the robot driving motor 634 according to the action instruction. The action control system 629 sends an action instruction of the driving manipulator 200 to a second programmable logic controller 224 of the manipulator control system 225 according to a pre-generated action program, and the second programmable logic controller 224 supplies power to the fourth motor 205 according to the action instruction. The action control system 629 sends an action instruction of the driver robot slider system 83 to a first programmable logic controller 188 of the robot slider control system 226 according to a pre-generated action program, and the first programmable logic controller 188 supplies power to the third motor 129 according to the action instruction. The robot slider system 83 configures the robot 78, the first operation position 74 or the second operation position 71, inputs a pre-generated action program to the robot control system 618 to perform the action of the robot 78, the pre-generated action program is stored in the action program storage system 625 of the third memory 624, and the robot control system 618 conveys the battery box 35 robot 78 to a predetermined position according to a pre-generated action program. The action control system 629 sends the action instruction of the driving video sensor 631 to the video sensor 631 according to a pre-generated action program, and the action control system 629 sends the action instruction for driving the light supplementing lamp 127 to the light supplementing lamp 127 according to the image pre-generated by the remote operator 7 according to the definition automatic light supplementing program, and performs light supplementing on the area collected by the video sensor 631.

The robot control system 618 has an acquisition system 628 that processes images captured by the first camera 122 and the second camera 126. The acquisition system 628 can generate three-dimensional information of the battery box 35 by means of a three-dimensional method. The three-dimensional information has a position corresponding to a twelfth two-dimensional code 468 set on a first side surface of the battery box 35 as a first measurement point, and information related to a distance from the video sensor 631 to the first measurement point. The acquisition system 628 calculates a distance to the first measurement point set to the battery box 35 according to the parallax of the two images captured by the first camera 122 and the second camera 126.

The monitoring device 626 has a selection system 627 that selects a target battery box 35 selection system 627 to detect the position and posture of the battery box 35 according to the three-dimensional information obtained from the image of the video sensor 631, selects a battery box 35 in descending order of the position of the battery box 35, and selects a target position and a target posture of the motion control system 629 and the sending robot 78. The robot 78 faces the target position and the target posture and changes position and posture. At this time, the robot 200 causes the finger 124 to be in an open state so as to configure the battery box 35 between the fingers 124 to close the finger 124 of the robot 200 to hold the battery box 35 after the robot 78 reaches the target position and the target posture, and the motion control system 629 changes the position and posture of the robot 78 to convey the battery box 35 to a desired position.

The remote operator 7 sets the robot slider coordinate system CT on the keyboard of the input device 9, the origin of which is arranged at the left end of the guide rail 105, the X-axis direction of which is consistent with the direction of the first axis 82, the Y-axis direction of which is consistent with the direction in which the battery box 35 is taken out and placed in the first charging and replacing cabinet 72, and the Z-axis direction is parallel to the vertical direction. The remote operator 7 sets the robot coordinate system C/R on the keyboard of the input device 9, the origin of which is arranged at the center of the base 110, the X-axis direction of which is consistent with the direction of the first axis 82, the Y-axis direction of which is consistent with the direction in which the battery box 35 is taken out and placed in the first charging and replacing cabinet 72, and the Z-axis direction of which is parallel to the vertical direction. The robot slider coordinate system CT is set to be arranged at the left end of the guide rail 105, the X-axis direction of the robot slider coordinate system is consistent with the direction of the first axis 82, the Y-axis direction of the robot slider coordinate system is consistent with the Y-axis direction of the robot coordinate system C/R, and the Z-axis direction is parallel to the vertical direction. The first charging and replacing cabinet coordinate system C/E is set as the center of the top of the first charging and replacing cabinet 72, the X-axis direction of the first charging and replacing cabinet coordinate system C/E is consistent with the direction of the first axis 82, the Y-axis direction is consistent with the Y-axis direction of the robot coordinate system C/R, and the Z-axis direction is parallel to the vertical direction. The second charging and replacing cabinet coordinate system C/F is set as the center of the top of the second charging and replacing cabinet 75, the X-axis direction is consistent with the direction of the first axis 82, the Y-axis direction is consistent with the Y-axis direction of the robot coordinate system C/R, and the Z-axis direction is parallel to the vertical direction. The coordinate system CK of the first carrying robot 77 is set as the center of the top of the first carrying robot 77, the X-axis direction of the first carrying robot 77 is consistent with the direction of the first axis 82, the Y-axis direction of the first carrying robot 77 is consistent with the Y-axis direction of the robot coordinate system C/R, and the Z-axis direction is parallel to the vertical direction. The coordinate system CN of the second carrying robot 79 is set as the center of the top of the second carrying robot 79, the X-axis direction of the second carrying robot 79 is consistent with the direction of the first axis 82, the Y-axis direction of the second carrying robot 79 is consistent with the Y-axis direction of the robot coordinate system C/R, and the Z-axis direction of the second carrying robot 79 is parallel to the vertical direction. The third charging and replacing cabinet coordinate system C/H is set as the center of the top of the third charging and replacing cabinet 31, the X-axis direction of the third charging and replacing cabinet 31 is consistent with the direction of the first axis 82, the Y-axis direction and the direction in the third charging and replacing cabinet 31 form an included angle of 90 degrees with the direction of the battery box 35, and the Z-axis direction is parallel to the vertical direction.

When the robot 78 operates on the first charging cabinet 72, the robot slider system 83 conveys the robot 78 to a pre-selected first working position 74 in the direction of the first axis 82. A robot 78 is controlled based on a robot coordinate system C/R at a first operation position 74. a robot 78, a first battery compartment control system 641, a second battery compartment control system 643, a third battery compartment control system 645, a fourth battery compartment control system 647, a fifth battery compartment control system 649 and a sixth battery compartment control system 651, the action of taking out and placing in the Y-axis direction of the first charging and swapping cabinet coordinate system CE is coordinated, and the operation of taking out and placing the battery box 35 in the first charging cabinet 72 is completed in sequence. When the robot 78 operates on the second charging battery cabinet 75, the robot slider system 83 conveys the robot 78 to a pre-selected first operation position 74, and the first operation position 74 is in the direction of the first axis 82. a robot 78, a seventh battery compartment control system 642, an eighth battery compartment control system 644, a ninth battery compartment controller system 646, a tenth battery compartment control system 648, an eleventh battery compartment control system 650, and a battery box 35 in the twelfth battery compartment control system 652, the operation of taking out and placing the battery box 35 in the second charging and swapping cabinet 75 in sequence. When the robot 78 operates the third charging and replacing cabinet 31, the robot slider system 83 conveys the robot 78 to a pre-selected second operation position 71, and the second operation position 71 is in the direction of the first axis 82.

The robot 78 is controlled by taking the robot coordinate system C/R as a reference in the second operation position 71, the robot 78 is coordinated with the thirteenth battery compartment control system 653, the fourteenth battery compartment control system 654, the fifteenth battery compartment control system 655 and the sixteenth battery compartment control system 656, and the operation of taking out and placing the battery box 35 in the third charging and swapping cabinet 31 is completed in sequence.

As shown in FIG. 41 to FIG. 47, the transfer robot control system 442 has a second leveling control system 432, an obstacle avoidance system 434, a magnetic navigation system 435, a walking mechanism control system 436, a visual navigation system 437, a terminal platform rotation control system 438, and an angle deviation correction mechanism control system 439. The third wireless programmable logic controller 433 is configured by the function of the first wireless programmable logic controller 356. A first cellular chipset 47 included in a first telematics unit 55 of a smart battery swapping communication system 57 performs cellular communication via a first main antenna 54 via a cellular protocol, and a first communication bus 56 of the smart battery swapping communication system 57 is connected to a data acquisition device 621 of a robot control system 618. The first short-range wireless communication circuit 46 is connected to the wireless communication unit 343 via a second antenna 355 of the first transfer robot 77 via a first short-range wireless communication antenna 53.

The intelligent battery swapping communication system 57 outputs a received sensor signal to a data acquisition device 621, and the data acquisition device 621 stores the acquired sensor signal in a third memory 624. The motion control system 629 performs feedback control according to a signal from a position detector of a rotary encoder included in each of the transfer robot control systems 442, so that the rotation of each robot drive motor 634 of the robot 78 is consistent with the instruction of the action program and cooperates with the operation of the transfer robot control system 442. The remote operator 7 issues a driving instruction to the third wireless programmable logic controller 433 according to a pre-generated action program and controls the first carrying robot 77 to execute each program according to a pre-generated action program by controlling the action instruction of the carrying robot control system 442 to be uploaded to the action control system 629 of the robot control system 618 through the remote control system 2.

A third wireless programmable logic controller 433, an obstacle avoidance system 434, a visual navigation system 437, a signal pre-processor 449, an electronic differential controller 450, a first motor controller 390, a first driving motor 389, a first rotating speed sensor 451, a second motor controller 391, a second driving motor 392, a second rotating speed sensor 452, a third motor controller 391, a third driving motor 403, a third rotating speed sensor 453, a fourth motor controller 402, a fourth driving motor 407, a fourth rotating speed sensor 453, a battery charging port 406, a battery 401 and a starting switch 405, wherein the third wireless programmable logic controller 433 is connected with the signal pre-processor 449, the signal pre-processor 449 is connected with the electronic differential controller 450, and the electronic differential controller 450 is connected with the first motor controller 390, the second motor controller 391, the third motor controller 404 and the fourth motor controller 402. The first driving motor 389 is connected with and controlled by the first motor controller 390; the second driving motor 392 is connected with and controlled by the second motor controller 391; the third driving motor 403 is connected with and controlled by the third motor controller 404; and the fourth driving motor 407 is connected with and controlled by the fourth motor controller 402. The first driving motor 389 is connected with the first wheel 382 and directly driven, the second driving motor 392 is connected with the second wheel 386 and directly driven, the third driving motor 403 is connected with the third wheel 385 and directly driven, the fourth driving motor 407 is connected with the fourth wheel 388 and directly driven, the battery 401 is connected with the third wireless programmable logic controller 433 through the starting switch 405, and the starting switch 405 controls the battery 401 to be switched on and off. The battery charging port 406 is connected to the battery 401.

The obstacle avoidance system 434 is provided with an ultrasonic ranging sensor 395 and a laser ranging sensor 396. The ultrasonic ranging sensor 395 is divided into eight ultrasonic probes in two paths, and is connected with a third wireless programmable logic controller 433 through an RS485 communication unit 350. A laser ranging sensor 396 is connected in series to a CAN communication unit 352 of a third wireless programmable logic controller 433 through four sensors, a third camera 394 and a fourth camera 398 of the visual navigation system 437 are electrically connected with an image sensor 393, and the image sensor 393 is electrically connected with a third wireless programmable logic controller 433. A magnetic navigation sensor 397 of the magnetic navigation system 435 is electrically connected to the third wireless programmable logic controller 433.

The carrying robot lifting system 636 controlled by the second leveling control system 432 is composed of a plurality of first double-acting multi-stage hydraulic cylinders 431 installed at four corners of a second bottom plate 377. In the embodiment, four first double-acting multi-stage hydraulic cylinders 431, namely a first jacking column 383, a second jacking column 376, a third jacking column 387 and a fourth jacking column 373 are all composed of a second leveling control system 432 and a first double-acting multi-stage hydraulic cylinder 431. A second hydraulic pressure sensor 429, a second position sensor 408, a second length measuring sensor 419, a second microwave distance measuring sensor 420, a third inclined sensor 399, a fourth inclined sensor 400, a fifth hydraulic servo controller 440, a sixth hydraulic servo controller 443, a seventh hydraulic servo controller 445 and an eighth hydraulic servo controller 447 of a second leveling control system 432 of the first jacking column 383, the second jacking column 376, the third jacking column 387 and the fourth jacking column 373 are respectively connected with the third wireless programmable logic controller 433. The fifth hydraulic servo controller 440 is connected with the fifth hydraulic valve group 441 through a data line; the sixth hydraulic servo controller 443 is connected with the sixth hydraulic valve group 444 through a data line; the seventh hydraulic servo controller 445 is connected with the seventh hydraulic valve group 446 through a data line; and the eighth hydraulic servo controller 447 is connected with the eighth hydraulic valve group 448 through a data line.

A second eleven limiting switch 364, a twenty-second limiting switch 368, a connecting circular ring 367, an outer ring of the bearing 370, a seventh bracket 378, a third inclined sensor 399 and a fourth inclined sensor 400 are mounted on a supporting plate 363 of the angle deviation rectifying system 635. A servo motor 374 is mounted on the seventh bracket 378, and a shaft of the encoder 375 small gear 369 is mounted on a shaft of the servo motor 374 through an inner ring of the bearing 370 and is connected with an output shaft of the servo motor 374 through a coupling 302. A positioning gear 365 is installed on the ball bearing, a rotating positioning block 366 and a battery tray 380 are installed on the positioning gear 365, a fifteenth two-dimensional code 663 and a positioning block 604 are installed on the battery tray 380, the four positioning blocks 604 are used for fixing the battery box 35 to be meshed with the positioning gear 365, and when the servo motor 374 drives the small gear 369 to rotate, the positioning gear 365 drives the battery tray 380 to rotate. A servo motor controller 372 is installed on the second bottom plate 377, and the second bottom plate 377 is fixed on the carrying robot chassis 384 through a mounting opening 371 through screws.

The twenty-first limit switch 364, the twenty-second limit switch 368 and the center point of the support plate 363 are on a straight line. The angle correction control system 439 is provided with a third wireless programmable logic controller 433 connected with the servo motor controller 372, the servo motor controller 372 is connected with the servo motor 374, the servo motor 374 is connected with the encoder 375, and the encoder 375 is connected with the third wireless programmable logic controller 433. The twenty-first limit switch 364 and the twenty-second limit switch 368 are connected with the third wireless programmable logic controller 433. Each rotation of the servo motor 374 emits a corresponding number of pulses and pulses received by the servo motor 374 form a call. The angle correction control system 439 knows how many pulses are sent to the servo motor 374, and meanwhile, how many pulses are recovered to position the rotation of the servo motor 374. The encoder 375 is used for detecting the rotation angle of the shaft of the servo motor 374, the encoder 375 transmits the detected angle value to the third wireless programmable logic controller 433, and the third wireless programmable logic controller 433 calculates the rotation speed based on the angle value and the rotation time detected by the encoder 375. The servo motor 374 drives the positioning gear 365 to rotate anticlockwise by 90 degrees to the position of the twenty-first limiting switch 364, and the rotating positioning block 366 triggers the twenty-first limiting switch 364 to stop rotating the servo motor 374. The servo motor 374 drives the positioning gear 365 to rotate clockwise by 90 degrees to the position of the twenty-second limiting switch 368, and the rotating positioning block 366 triggers the twenty-second limiting switch 368 to stop rotating the servo motor 374.

An eleventh motor 549 and a rotating shaft 605 are installed on the supporting plate 363, a terminal platform 381 is installed on the rotating shaft 605, a third camera 394, a fourth camera 398, an ultrasonic distance measuring sensor 395, a laser distance measuring sensor 396, a magnetic navigation sensor 397, a wire inlet and outlet 606 and a fourteenth two-dimensional code 338 are installed on the terminal platform 381, and a nineteenth limiting switch 547 and a twenty-limiting switch 548 are installed on the supporting plate 363.

The robot control system 618 sends a control signal to the servo motor controller 372 through the third wireless programmable logic controller 433, the servo motor controller 372 controls the servo motor 374 to generate specific torque, the rotation angle of the battery tray 380 is controlled, and the battery tray 380 returns to the correct corresponding angle with the battery replacement box. After the adjustment is completed, the rotation angle of the encoder 375 is read, the rotation angle detected by the encoder 375 is compared with the set rotation angle, and the accuracy of the rotation angle of the battery tray 380 is ensured.

As shown in FIG. 43, the first double-acting multi-stage hydraulic cylinder 431 is an N-stage hydraulic cylinder N≥2. The present application relates to a three-stage cylinder. When the third-stage hydraulic cylinder is jacked, hydraulic oil enters a first-stage cylinder jacking oil cavity 426 from a second oil port 427, first, the first-stage cylinder piston 410 is jacked upwards, then hydraulic oil enters a second-stage cylinder jacking oil cavity 424 through a second-stage cylinder jacking oil cavity oil duct 425 to jack up the second-stage cylinder piston 414, and then enters a third-stage cylinder jacking oil cavity 422 through a third-stage cylinder jacking oil cavity oil duct 423 to jack up the third-stage cylinder piston 421 upwards, hydraulic oil enters a first-stage cylinder contraction oil cavity 412 through a first-stage cylinder contraction oil cavity oil channel 411 to compress a first-stage cylinder piston 410 downwards, then enters a second-stage cylinder contraction oil cavity 416 through a second-stage cylinder contraction oil cavity oil channel 415 to compress a second-stage cylinder piston 414 downwards, and then enters a third-stage cylinder contraction oil cavity 418 through a third-stage cylinder contraction oil cavity oil channel 417 to compress a third-stage cylinder piston 421 downwards, and residual oil in each stage of jacking oil cavity flows out of a second oil port 427 through a jacking oil cavity oil channel.

A second hydraulic pressure sensor 429 is installed on a first base 430 at the bottom end of a pillar. A second position sensor 408 of the pillar oil cylinder is fed back to a first base 430 at the bottom end of the pillar. A second length sensor 419 of the pillar cylinder is installed at the top of the pillar cylinder and used for detecting the distance between the pillar and the bottom end of the pillar and feeding back the data to the third wireless programmable logic controller 433.

As shown in FIGS. 1 and 48-62, the electric vehicle battery replacement control system 600 is composed of an electric vehicle communication system 63, a third programmable logic controller 597, a battery box replacement control system 598, a vehicle-mounted battery box replacement system 564, a first rotation control system 599, a second rotation control system 601, a third rotation control system 602, a fourth rotation control system 603 and a third leveling control system 616. The electric vehicle communication system 63 has a second telematics unit 61, a second global navigation satellite system receiver 68, and a second vehicle-mounted computer 69 communicatively connected by a second communication bus 62. The second communication bus 62 provides a network connection to the electric vehicle communication system 63 using a network protocol. A second global navigation satellite system receiver 68 receives radio signals from the global navigation satellite system 24. A second global navigation satellite system receiver 68 may be configured for various GNSS systems.

The second telematics unit 61 has a second cellular chipset 64, a second short-range wireless communication circuit 65, a second processor 66, a second memory 67, a second primary antenna 59, and a second SRWC antenna 60 that are connected to the second primary antenna 59 and the second cellular chipset 64. The second short-range wireless communication antenna 60 is connected to the second short-range wireless communication circuit 65. The second telematics unit 61 is configured to be capable of wireless communication according to a second short-range wireless communication circuit 65, and any one of a Wi-Fi™, a Mock Itao™, a Wi-Fi™ Direct, another IEEE 802.11 protocol, a Geiger EE™, a Bluetooth™, and a Bluetooth™. The second processor 66 is a device for processing electronic instructions having a microprocessor, a microcontroller, a main processor, a controller, a vehicle communication processor, and an application specific integrated circuit (ASIC).

The second communication bus 62 is communicatively connected to a third programmable logic controller 597 mounted on the electric vehicle 41. A second cellular chipset 64 included in a second telematics unit 61 of the wireless carrier system 28 and the electric vehicle communication system 63 performs cellular communication via a second main antenna 59 via a cellular protocol.

As shown in FIG. 48-53, the electric vehicle landing leg lifting system 573 has a first lifter 472, a second lifter 491, a third lifter 505 and a fourth lifter 516, and the first lifter 472 is composed of the following components: an eighth bracket 477 is mounted on the electric vehicle chassis 497, a seventh motor 476, a first universal gear 478 and a second universal gear 479 are mounted on the eighth bracket 477, the first universal gear 478 is meshed with the second universal gear 479, a first supporting leg 475 is mounted on a first rotating rod 473 of the second universal gear 479, a first dustproof cover 474 and an output shaft of the seventh motor 476 are mounted on the first supporting leg 475, and the first supporting leg 475 is connected with the first universal gear 478 through an eighth bracket 477 through a coupler. An eleventh limiting switch 480 and a twelfth limiting switch 481 are installed on the electric vehicle chassis 497, the third programmable logic controller 597 is connected with the eleventh limiting switch 480 and the twelfth limiting switch 481, the seventh motor 476 is connected with the eleventh limiting switch 480 and the twelfth limiting switch 481, and the seventh motor 476 is connected with the third programmable logic controller 597. When in use, the third programmable logic controller 597 controls the seventh motor 476 to start, the seventh motor 476 drives the first universal gear 478 to rotate, the first universal gear 478 drives the second universal gear 479 to rotate, the second universal gear 479 drives the first rotating rod 473 to rotate, and the first rotating rod 473 drives the first supporting leg 475 to rotate.

The second lifter 491 is composed of the following components: the third universal gear 485 and the fourth universal gear 487 are meshed with each other; a second supporting leg 490 is installed on a second rotating rod 484 of the third universal gear 485; a second dustproof cover 483 is installed on the second supporting leg 490; a thirteenth limiting switch 492 and a fourteenth limiting switch 493 are installed on the electric vehicle chassis 497; the third programmable logic controller 597 is connected with the thirteenth limiting switch 492 and the fourteenth limiting switch 493; the thirteenth limiting switch 492 and the fourteenth limiting switch 493 are connected with the eighth motor 489; and the eighth motor 489 is connected with the third programmable logic controller 597. When in use, the third programmable logic controller 597 controls the eighth motor 489 to start, the eighth motor 489 drives the fourth universal gear 487 to rotate, the fourth universal gear 487 drives the third universal gear 485 to rotate, the third universal gear 485 drives the second rotating rod 484 to rotate, and the second rotating rod 484 drives the second supporting leg 490 to rotate.

The third lifter 505 is composed of the following components: a tenth bracket 500 is mounted on an electric vehicle chassis 497, a ninth motor 501 is mounted on a tenth bracket 500, a fifth universal gear 498 and a sixth universal gear 499 are meshed with a fifth universal gear 498 and a sixth universal gear 499, a third supporting leg 502 is mounted on a third rotating rod 504 of the fifth universal gear 498, a third dustproof cover 503 is mounted on the third supporting leg 502, an output shaft of the ninth motor 501 is connected with a sixth universal gear 499 through a tenth bracket 500 through a coupler. a fifteenth limit switch 506 and a sixteenth limit switch 507 are installed on the electric car chassis 497, the third programmable logic controller 597 is connected with the fifteenth limit switch 506 and the sixteenth limit switch 507, the fifteenth limit switch 506 and the sixteenth limit switch 507 are connected with the ninth motor 501, and the ninth motor 501 is connected with the third programmable logic controller 597. During use, a third programmable logic controller 597 controls a ninth motor 501 to start, a ninth motor 501 drives a sixth universal gear 499 to rotate, a sixth universal gear 499 drives a fifth universal gear 498 to rotate, a fifth universal gear 498 drives a third rotating rod 504 to rotate, and a third rotating rod 504 drives a third supporting leg 502 to rotate.

The fourth lifter 516 is composed of an eleventh bracket 510 mounted on an electric vehicle chassis 497, a tenth electric motor 509 mounted on the eleventh bracket 510, a seventh universal gear 511 and an eighth universal gear 512, and a seventh universal gear 511 engaged with the eighth universal gear 512. A fourth supporting leg 515 is installed on a fourth rotating rod 513 of the eighth universal gear 512, a fourth dustproof cover 514 is installed on the fourth supporting leg 515, an output shaft of the tenth motor 509 is connected with a seventh universal gear 511 through an eleventh support 510 through a coupler, a seventeenth limiting switch 544 and an eighteen limiting switch 545 are installed on the electric vehicle chassis 497, the third programmable logic controller 597 is connected with the seventeenth limiting switch 544 and the eighteen limiting switch 545, the seventeenth limiting switch 544 and the eighteen limiting switch 545 are connected with the tenth motor 509, and the tenth motor 509 is connected with the third programmable logic controller 597. When in use, the third programmable logic controller 597 controls the tenth motor 509 to start, the tenth motor 509 drives the seventh universal gear 511 to rotate, the seventh universal gear 511 drives the eighth universal gear 512 to rotate, the eighth universal gear 512 drives the fourth rotating rod 513 to rotate, and the fourth rotating rod 513 drives the fourth supporting leg 515 to rotate. The third programmable logic controller 597 controls the seventh motor 476, the eighth motor 489, the ninth motor 501 and the tenth motor 509 to be started at the same time, and when the third programmable logic controller 597 runs to the upper limit switch and the lower limit switch of each motor, the third programmable logic controller 597 firstly stops and then stops.

A first telescopic leg 482 is installed in a first supporting leg 475 of an electric vehicle supporting leg lifting system 573, a second telescopic leg 494 is installed in the second supporting leg 490, a third telescopic leg 508 is installed in the third supporting leg 502, a fourth telescopic leg 546 is installed in the fourth supporting leg 515, a first telescopic leg 482, a second telescopic leg 494, a third telescopic leg 508 and a fourth telescopic leg 546 are all composed of a third leveling control system 616 and a second double-acting multi-stage hydraulic cylinder 543. a second hydraulic pressure sensor 528 of a third leveling control system 616, a second position sensor 530, a third length measuring sensor 533, a second microwave distance measuring sensor 525, a third inclination sensor 495, a fourth inclination sensor 496, a fifth hydraulic servo controller 608, a sixth hydraulic servo controller 610, a seventh hydraulic servo controller 612 and an eighth hydraulic servo controller 614 are all connected with a third programmable logic controller 597 through data lines. a fifth hydraulic servo controller 608 is connected with a fifth hydraulic valve group 609 through a data line; a sixth hydraulic servo controller 610 is connected with a sixth hydraulic valve group 611 through a data line; a seventh hydraulic servo controller 612 is connected with a seventh hydraulic valve group 613 through a data line; and an eighth hydraulic servo controller 614 is connected with an eighth hydraulic valve group 615 through a data line.

As shown in FIG. 50, the second double-acting multi-stage hydraulic cylinder 543 is an N-stage hydraulic cylinder N≥2. The present application relates to a three-stage cylinder. When a third-stage hydraulic cylinder is jacked, hydraulic oil enters a second-stage cylinder jacking oil cavity 524 from a third oil port 526 and then jacks up a second-stage cylinder piston 534, then hydraulic oil enters a second-stage cylinder jacking oil cavity 522 through a second-stage cylinder jacking oil cavity 522 to jack up a second-stage cylinder piston 538 downwards, and then enters a second three-stage cylinder jacking oil cavity 520 through a second three-stage cylinder jacking oil cavity oil duct 521 to jack up a second three-stage cylinder piston 519 downwards, when the third-stage hydraulic cylinder contracts, the hydraulic oil enters a second-stage cylinder contraction oil cavity 536 through a second-stage cylinder contraction oil cavity oil duct 535 to compress a second-stage cylinder piston 534 upwards, then enters a second three-stage cylinder contraction oil cavity 518 through a second three-stage cylinder contraction oil cavity oil duct 541 to compress a second three-stage cylinder piston 519 upwards, and residual oil in each stage of jacking oil cavity flows out of a third oil port 526 through a jacking oil cavity oil duct.

A second hydraulic pressure sensor 528 installed at the lower part of the second base 535 of the second double-acting multi-stage hydraulic cylinder 543 feeds back the data of the stress condition to the third programmable logic controller 597; a second position sensor 530 installed on the lower portion of the second base 535 detects the complete retraction state of the support column oil cylinder and feeds back data to the third programmable logic controller 597; the third length measurement sensor 533 is installed at the top of the support column oil cylinder to detect the telescopic position distance of the support column oil cylinder and feed back the telescopic speed and position data of the support column oil cylinder to the top of the hydraulic support column and used for detecting the distance from the support column to the ground and feeding back the data to the third programmable logic controller 597; and the third inclination sensor 495 and the fourth inclination sensor 496 are installed in the center of the electric vehicle chassis 497 and used for detecting inclination data of the electric vehicle chassis 497 in the X-axis direction and the Y-axis direction. A concave base 542 is mounted on the spherical end 517 of the telescopic leg.

As shown in FIG. 52 and FIG. 54-57, the first two-dimensional code 456, the second two-dimensional code 455, the third two-dimensional code 463 and the fourth two-dimensional code 459 are installed in front, back, left and right of the bottom of the electric vehicle chassis 497, and the fifth two-dimensional code 465, the sixth two-dimensional code 461, the seventh two-dimensional code 462, the eighth two-dimensional code 466 and the ninth two-dimensional code 464 are installed in the middle of the bottom of the electric vehicle chassis 497; an eleventh two-dimensional code 467 is installed at the top of the battery box 35, a twelfth two-dimensional code 468 is installed on the first side face, and a thirteenth two-dimensional code 469 is installed at the bottom of the battery box 35; and the two-dimensional code is composed of an upper two-dimensional code 470 and a lower navigation magnetic nail 471. Each two-dimensional code comprises an independent information, and when the first carrying robot 77 passes through the two-dimensional code at different positions, the visual navigation system 437 dynamically reads the information contained in the two-dimensional code to obtain the position information of the first carrying robot 77 at the moment, and determines whether the first carrying robot 77 advances or stops. a twelfth two-dimensional code 468 installed on the first side face of the battery box 35 is set as a first measuring point, an eleventh two-dimensional code 467 installed at the top of the battery box 35 is a second measuring point, and a thirteenth two-dimensional code 469 installed at the bottom of the battery box 35 is a third measuring point.

As shown in FIG. 54-62, a fifth sliding rail front end fixing plate 574, a sixth sliding rail front end fixing plate 582, a fifth sliding rail 575 and a sixth sliding rail 583 are installed on the lower portion of a third main plate 557 of the battery box replacement system 564, a second flange 553 is installed on the third bearing plate 558, and a second flange 553 is fixed to the electric vehicle chassis 497 through a second screw 554. Other parts of the vehicle-mounted battery box replacement system 564 are fixed on the electric vehicle chassis 497 by a third screw 555. A fifth hollow groove 568 and a sixth hollow groove 572 are formed in the third main plate 557, a ninth grabbing plate 569 is vertically installed on the fifth sliding rail 575, a fifth gripper 570 is arranged on the ninth grabbing plate 569, and the ninth grabbing plate 569 slides on the fifth sliding rail 575. A tenth holding plate 571 is vertically mounted on the sixth slide rail 583, a sixth gripper 559 is arranged on the tenth holding plate 571, and the tenth holding plate 571 slides on the sixth slide rail 583. On the lower portion of the third bearing plate 558, a nineteenth limit switch 579 and a twenty-limit switch 581 are installed to install the plug 261 on the eleventh side surface 550; an eleventh holding plate 566 is vertically mounted on the eleventh side surface 550, and a seventh gripper 567 is arranged on the eleventh holding plate 566; a twelfth grabbing plate 551 is vertically installed on the eleventh side face 550, an eighth gripper 552 is arranged on the twelfth grabbing plate 551, the sixth gripper 559, the seventh gripper 567 and the eighth gripper 552 are semicircular, a second fixing frame 563 is installed outside the ninth side face 565 of the battery box 35 conveniently fixed and grabbed, a sixth motor 562 and a third output shaft 561 of the sixth motor 562 are installed on the second fixing frame 563, and the second fixing frame 563 is connected with the third rotating rod 580 through a coupler. A third lead screw section 577 is installed on the third rotating rod 580, and a third nut 578 is sleeved on the third lead screw section 577. A third connecting rod 576 is installed on the third nut 578, and the third connecting rod 576 is connected with the ninth grabbing plate 569 and the tenth grabbing plate 571. The third programmable logic controller 597 is connected with the nineteenth limit switch 579 and the second ten limit switch 581, the sixth motor 562 is connected with the nineteenth limit switch 579 and the second ten limit switch 581, and the sixth motor 562 is connected with the third programmable logic controller 597.

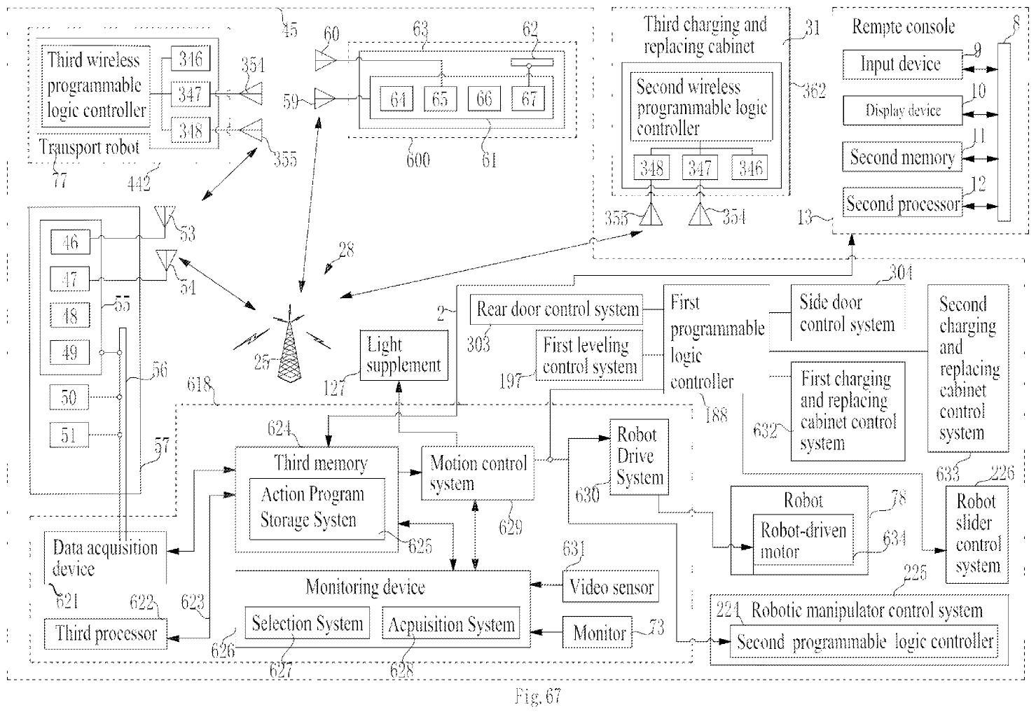

As shown in FIG. 63 to FIG. 66, the visual sensor 631 sends a first working point 591 of a photographed first operation region 593 to a third working point 586 and a fourth working point 584 of a second operation region 588, a second working point 592 of the first operation region 593 to a fifth working point 607 of the third operation region 590, and an optical image around a sixth working point 596 of the first operation region 593 to a sixth working point 596 of the fourth operation region 594 is sent to the third processor 622 of the monitoring device 626 by means of the third memory 624 and the video image information received by the monitoring device 626, generating digital panoramic image navigation information in a preset area based on a video image splicing algorithm, setting a first path 585, a second path 587, a third path 589 and a fourth path 595 as navigation routes, and the remote operator 7 stores the path in an action program storage system 625 and sends the path to a third wireless programmable logic controller 433; and the signal pre-processor 449 generates digital panoramic image navigation information in a preset area and a set navigation route, and calculates an expected driving torque and a critical vehicle speed. The electronic differential controller 450 receives the expected driving torque and the critical vehicle speed of the signal pre-processor 449 and the wheel speed signals of the first rotating speed sensor 451, the second rotating speed sensor 452, the third rotating speed sensor 453 and the fourth rotating speed sensor 454, and calculates the driving torque of each wheel according to the steering driving condition. The electronic differential controller 450 sends a torque control target signal to the first motor controller 390, the second motor controller 391, the third motor controller 404 and the fourth motor controller 402.

As shown in FIG. 1 and FIG. 68-77, the second electric vehicle battery replacement control system 803 in the second embodiment is composed of a second electric vehicle communication system 814, referred to as a second communication system 814, a fourth programmable logic controller 695, a second battery box replacement control system 697, a second vehicle-mounted battery box replacement system 617 and a fourth leveling control system 696.

As shown in FIG. 75, a third remote information processing unit 813, a third global navigation satellite system receiver 805, and a third vehicle-mounted computer 806 having a second communication system 814 are communicatively connected by a fourth communication bus 804. The fourth communication bus 804 provides a network connection to the second communication system 814 using a network protocol. A third global navigation satellite system receiver 805 receives radio signals from a global navigation satellite system 24 that can be configured for various GNSS systems. The third remote information processing unit 813 has a third cellular chipset 807, a third short-range wireless communication circuit 808, a third processor 809, a third memory 810, a third primary antenna 811, and a third short-range wireless communication antenna 812 that are connected to the third primary antenna 811 and the third cellular chipset 807. The third short-range wireless communication antenna 812 and the third short-range wireless communication circuit 808 are connected. The third telematics unit 813 is configured to be capable of wireless communication according to a third short-range wireless communication circuit 808, and any one of a Wi-Fi™, a Mock Itao™, a Wi-Fi™ Direct, another IEEE 802.11 protocol, a Geiger EE™, a Bluetooth™, and a Bluetooth™. A third processor 809 is a device for processing electronic instructions having a microprocessor, a microcontroller, a main processor, a controller, a vehicle communication processor, and an application specific integrated circuit (ASIC). The fourth communication bus 804 is communicatively connected to a fourth programmable logic controller 695 mounted on the electric vehicle 41. A third cellular chipset 807 included in a third telematics unit 813 of the wireless carrier system 28 and the second communication system 814 performs cellular communication via a third primary antenna 811 via a cellular protocol.

As shown in FIGS. 70-76, a third flange 691 is mounted on a fourth main plate 692 of a second vehicle-mounted battery box replacement system 617 provided with a second battery box replacement control system 697; a seventh sliding rail front-end fixing plate 672, an eighth sliding rail front-end fixing plate 679, a seventh sliding rail 668 and an eighth sliding rail 684 are mounted on the fourth bearing plate 683; a third flange 691 is mounted on the fourth bearing plate 683; a fourth screw 701 is mounted on the second support plate 699; a seventh hollow groove 665 and an eighth hollow groove 674 are vertically mounted on the seventh sliding rail 668; a ninth gripper 693 is arranged on the thirteenth gripping plate 667; and the thirteenth gripping plate 667 slides on the seventh sliding rail 668. A fourteenth grabbing plate 685 is vertically installed on the eighth sliding rail 684, a tenth gripper 663 is arranged on the fourteenth grabbing plate 685, and the fourteenth grabbing plate 685 slides on the eighth sliding rail 684. A second eleven limiting switch 680 and a twenty-second limiting switch 681 are installed on the lower portion of the fourth bearing plate 683 to install the plug 261 on the fifteenth side surface 664; a fifteenth holding plate 669 is vertically mounted on the fifteenth side surface 664, and an eleventh gripper 670 is arranged on the fifteenth holding plate 669; a twelfth gripper 682, a ninth gripper 693, a tenth gripper 663, an eleventh gripper 670 and a twelfth gripper 682 are vertically mounted on the fifteenth side surface 664; a twelfth gripper 682, a ninth gripper 693, a tenth gripper 663, an eleventh gripper 670 and a twelfth gripper 682 are arranged on the sixteenth gripping plate 673; a third fixing frame 690 is mounted outside the twelfth side surface 689; a seventh motor 688 and a fourth output shaft 687 of the seventh motor 688 are mounted on the third fixing frame 690; and the third fixing frame 690 is connected with the fourth rotating rod 678 through a coupler. A fourth screw section 675 is installed on the fourth rotating rod 678, a sixth nut 676 is sleeved on the fourth screw section 675, a fourth connecting rod 677 is installed on the sixth nut 676, and the fourth connecting rod 677 is connected with the thirteenth grabbing plate 667 and the fourteenth grabbing plate 685. A third bottom plate 707 is fixed to a front bin chassis 702 of a second to-be-replaced electric vehicle 780 through a fifth screw 716, a driving motor 607 is installed in a rear bin of the second to-be-replaced electric vehicle 780, and the driving motor 607 is connected with the plug 261.

As shown in FIG. 75, a fourth programmable logic controller 695 of the second battery box replacement control system 697 is connected with the twenty-first limit switch 680 and the twenty-second limit switch 681, the twenty-first limit switch 680 and the twenty-second limit switch 681 are connected with the seventh motor 688, and the seventh motor 688 is connected with the fourth programmable logic controller 695.

As shown in FIG. 75, FIG. 77 and FIG. 43, a second battery box lifting system 700 controlled by a fourth leveling control system 696 is composed of a plurality of first double-acting multi-stage hydraulic cylinders 431 installed at four corners of a third bottom plate 707. In the embodiment, four first double-acting multi-stage hydraulic cylinders 431, namely a fifth jacking column 706, a sixth jacking column 713, a seventh jacking column 705 and an eighth jacking column 712 are all composed of a fourth leveling control system 696, and the fourth leveling control system 696 is composed of a second leveling control system 432 and a first double-acting multi-stage hydraulic cylinder 431. The tops of the fifth jacking column 706, the sixth jacking column 713, the seventh jacking column 705 and the eighth jacking column 712 are provided with a second hydraulic pressure sensor 429, a second position sensor 408, a second length measuring sensor 419, a second microwave distance measuring sensor 420, a third inclination sensor 399, a fourth inclination sensor 400, a fifth hydraulic servo controller 440, a sixth hydraulic servo controller 443, a seventh hydraulic servo controller 445 and an eighth hydraulic servo controller 447 which are connected with a third wireless programmable logic controller 433 through data lines. The fifth hydraulic servo controller 440 is connected with the fifth hydraulic valve group 441 through a data line; the sixth hydraulic servo controller 443 is connected with the sixth hydraulic valve group 444 through a data line; the seventh hydraulic servo controller 445 is connected with the seventh hydraulic valve group 446 through a data line; and the eighth hydraulic servo controller 447 is connected with the eighth hydraulic valve group 448 through a data line.

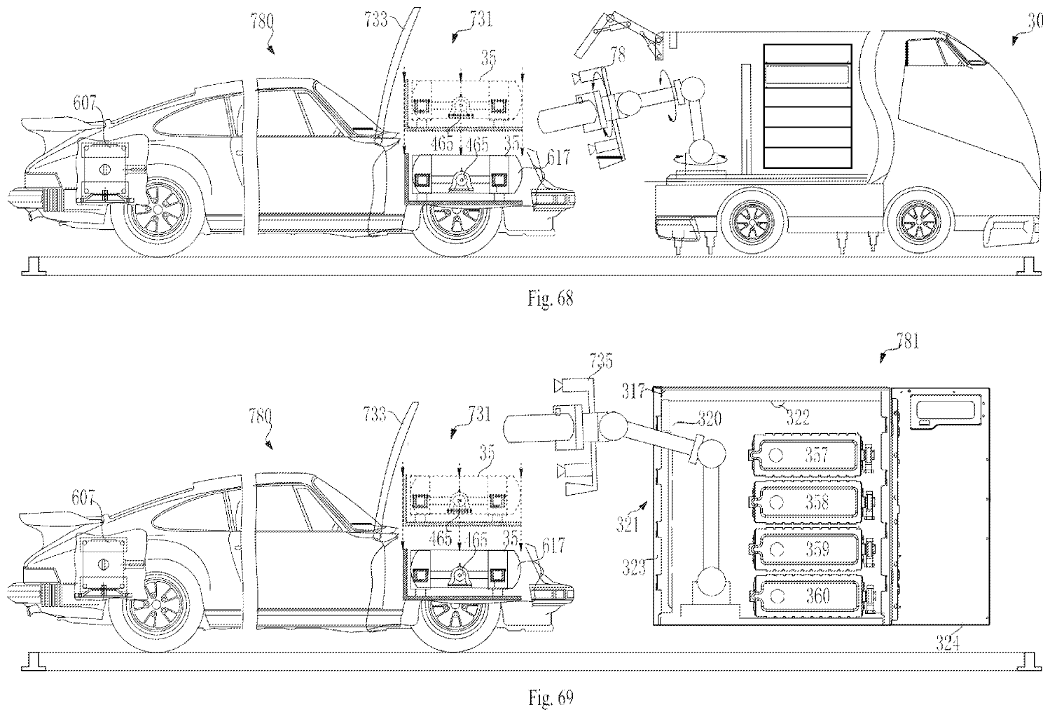

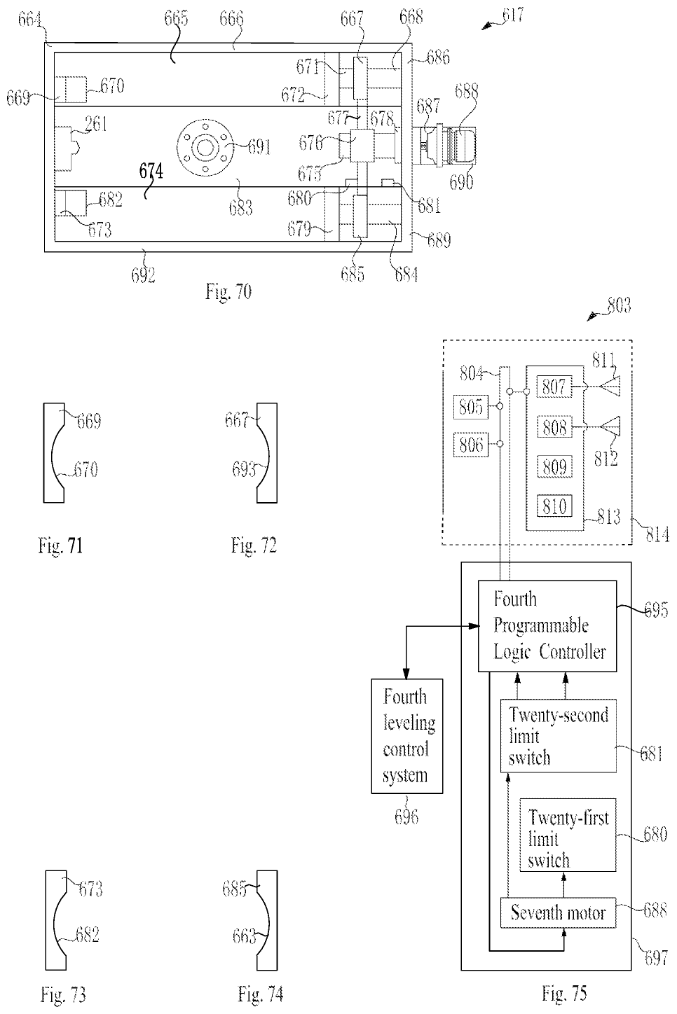

As shown in FIG. 69, according to the third embodiment of the invention, the second robot 735 is installed in the third charging and replacing cabinet 31 to form the fourth charging and replacing cabinet 781, and the second robot 735 is composed of the robot 78. The control system of the second robot 735 is composed of a robot control system 618.

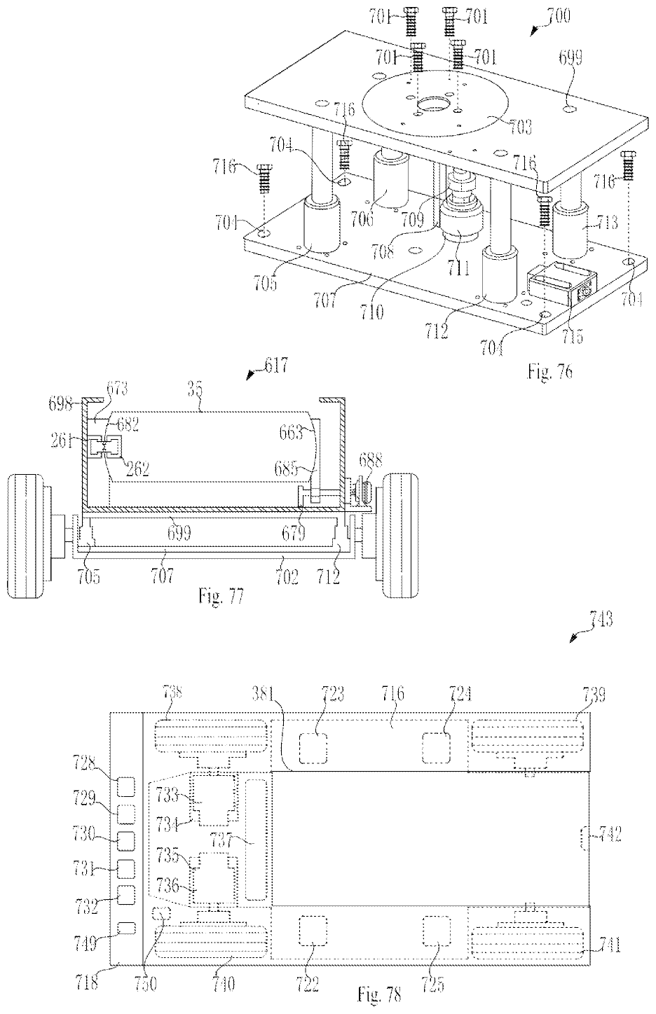

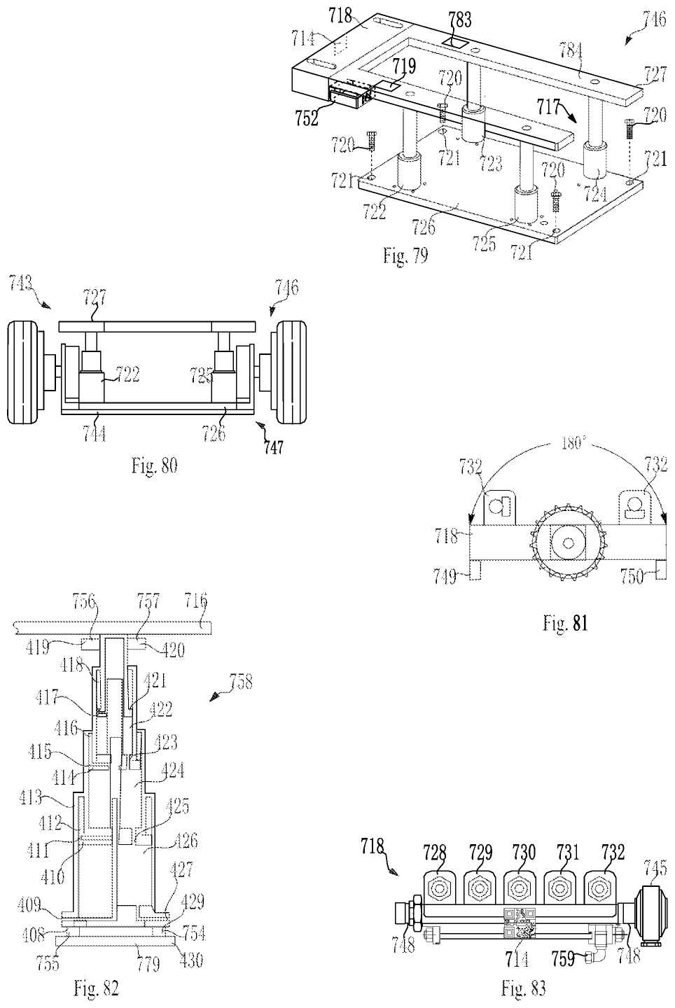

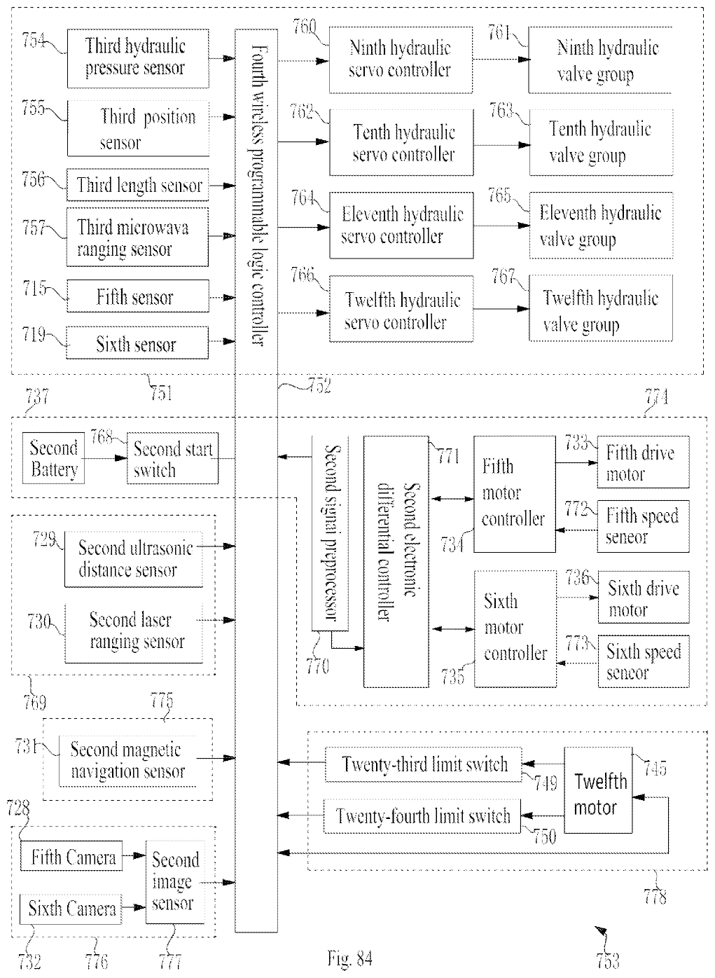

As shown in FIG. 78-84, the second carrying robot control system 753 has a second carrying robot leveling control system 751, a second obstacle avoidance system 769, a second magnetic navigation system 775, a second walking mechanism control system 774, a second visual navigation system 776 and a second terminal platform rotation control system 778 which are connected with the fourth wireless programmable logic controller 752. The fourth wireless programmable logic controller 752 is configured by the function of the first wireless programmable logic controller 356. A second handling robot system 743 is provided with a second handling robot walking system 747 and a second handling robot lifting system 746. A second handling robot walking system 747 and a second handling robot lifting system 746 are installed on a second handling robot chassis 744. A first cellular chipset 47 provided by a first telematics unit 55 of the intelligent tram communication system 57 performs cellular communication through a first main antenna 54 through a cellular protocol, and a first communication bus 56 provided by the intelligent tram communication system 57 is connected with a data acquisition device 621 of the robot control system 618. The first short-range wireless communication circuit 46 is connected to the wireless communication unit 343 via a second antenna 355 of the second transfer robot 79 via a first short-range wireless communication antenna 53. The intelligent battery swapping communication system 57 outputs a received sensor signal to a data acquisition device 621, and the data acquisition device 621 stores the acquired sensor signal in a third memory 624. The motion control system 629 performs feedback control based on a signal from a position detector of a rotary encoder included in each of the second transfer robot control systems 753 such that rotation of each robot drive motor 634 of the robot 78 coincides with an instruction of the action program and cooperates with operation of the second transfer robot control system 753. The remote operator 7 issues a driving instruction to the fourth wireless programmable logic controller 752 through the remote control system 2 according to a pre-generated action program and controls the second carrying robot 79 to execute each program according to a pre-generated action program output driving instruction to the fourth wireless programmable logic controller 752 through the action control system 629 uploaded to the robot control system 618 by the remote control system 2.

A fourth bottom plate 726 is fixed to a second carrying robot chassis 744 through a sixth screw 720 through a mounting hole 721. A fourth wireless programmable logic controller 752, a second signal pre-processor 770, a second electronic differential controller 771, a fifth motor controller 734, a fifth driving motor 733, a fifth rotating speed sensor 774, a sixth motor controller 735, a sixth driving motor 736, a sixth rotating speed sensor 773, a second battery charging port 742, a second battery 737 and a second starting switch 768 are mounted on the second supporting plate 784, a sixth camera 732, a second ultrasonic distance measuring sensor 729, a second laser distance measuring sensor 730, a second magnetic navigation sensor 731, a second wire inlet and outlet 759 and a sixteenth two-dimensional code 714 are installed on the second supporting plate 784; the fourth wireless programmable logic controller 752 is connected with the second signal pre-processor 770, the second signal pre-processor 770 is connected with the second electronic differential controller 771, and the second electronic differential controller 771 is connected with the fifth motor controller 734 and the sixth motor controller 735. The fifth driving motor 733 is connected with and controlled by the fifth motor controller 734; and the sixth driving motor 736 is connected with and controlled by the sixth motor controller 735. The fifth driving motor 733 is connected to and directly driven by the fifth wheel 738, the sixth driving motor 736 is connected to and directly driven by the sixth wheel 740, and the seventh wheel 739 and the eighth wheel 741 are driven wheels. The second battery 737 is connected with a fourth wireless programmable logic controller 752 through a second starting switch 768, and the second starting switch 768 controls the on-off of the second battery 737. The second battery charging port 742 is connected to the second battery 737.

The second obstacle avoidance system 769 is provided with a second ultrasonic distance measuring sensor 729 and a second laser distance measuring sensor 730, wherein the second ultrasonic distance measuring sensor 729 is divided into eight ultrasonic probes, and is connected with a fourth wireless programmable logic controller 752 through an RS485 communication unit 350. a second laser ranging sensor 730 is connected in series to a CAN communication unit 352 of a fourth wireless programmable logic controller 752 through four sensors, and a fifth camera 728 and a sixth camera 732 of the second visual navigation system 776 are electrically connected with a second image sensor 777; and a second image sensor 777 is electrically connected with a fourth wireless programmable logic controller 752. A second magnetic navigation sensor 731 of the second magnetic navigation system 775 is electrically connected to the fourth wireless programmable logic controller 752. The fourth wireless programmable logic controller 752 is connected with the twenty-third limiting switch 749 and the twenty-fourth limiting switch 750, the twenty-third limiting switch 749 is connected with the twenty-fourth limiting switch 750, and the twelfth motor 745 is connected with the fourth wireless programmable logic controller 752.

The second carrying robot lifting system 746 controlled by the second carrying robot leveling control system 751 is composed of a plurality of second double-acting multi-stage hydraulic cylinder systems 758 installed at four corners of a fourth bottom plate 726. In the embodiment, four second double-acting multi-stage hydraulic cylinder systems 758, namely a fifth jacking column 721, a sixth jacking column 722, a seventh jacking column 724 and an eighth jacking column 725 are all composed of a second carrying robot leveling control system 751 and a second double-acting multi-stage hydraulic cylinder system 758, and the structure of the second double-acting multi-stage hydraulic cylinder system 758 is the same as that of the first double-acting multi-stage hydraulic cylinder 431. A second supporting plate 784 is installed at the tops of the fifth jacking column 721, the sixth jacking column 722, the seventh jacking column 724 and the eighth jacking column 725. The second supporting plate 784 is of a concave structure, so that the first carrying robot 77 can conveniently enter the second supporting plate 784 from the inlet and outlet 717 to the second supporting plate 784. The second carrying robot leveling control system 751 comprises a third hydraulic pressure sensor 754, a third position sensor 755, a fourth length measuring sensor 756, a third microwave distance measuring sensor 757, a fifth inclination sensor 783, a sixth inclination sensor 719, a ninth hydraulic servo controller 760, a tenth hydraulic servo controller 762, an eleventh hydraulic servo controller 764 and a twelfth hydraulic servo controller 766 which are respectively connected with the fourth wireless programmable logic controller 752 through data lines. a ninth hydraulic servo controller 760 is connected with a ninth hydraulic valve group 761 through a data line; a tenth hydraulic servo controller 762 is connected with a tenth hydraulic valve group 763 through a data line; an eleventh hydraulic servo controller 764 is connected with an eleventh hydraulic valve group 765 through a data line; and a twelfth hydraulic servo controller 766 is connected with a twelfth hydraulic valve group 767 through a data line. A third hydraulic pressure sensor 754 is installed on a second base 779 at the bottom end of the supporting column. Data of stress conditions of the supporting column oil cylinder is fed back to a fourth wireless programmable logic controller 752. A third position sensor 755 is installed on a second base 779 at the bottom end of the supporting column. A fourth length measuring sensor 757 of the supporting column oil cylinder is detected and fed back to a fourth wireless programmable logic controller 752. A third microwave distance measuring sensor 757 is installed at the top of the hydraulic supporting column and used for detecting the distance from the supporting column to the bottom end of the supporting column.

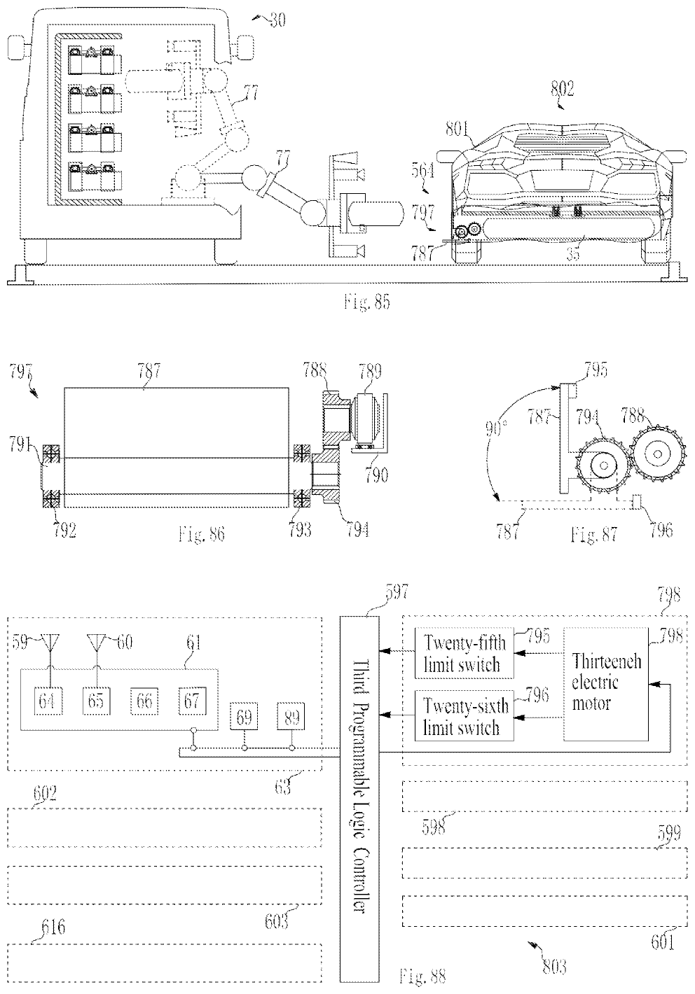

As shown in FIG. 85-88, a protection plate rotation system 797 is added to a side surface body 801 of an electric vehicle 41 to be subjected to battery replacement to form a third embodiment of the electric vehicle 802 to be subjected to battery replacement According to the third embodiment of the present application, a rotating shaft 791 of a protection plate rotation system 797 of an electric vehicle control system 803 to be replaced passes through a first fixing block 792 and a second fixing block 793 fixed on the side vehicle body 801 to mount a protection plate 787 and a first gear 794 on the side vehicle body 801. A second fifteen limit switch 795 of the guard plate rotation control system 798 and a third programmable logic controller 597 of the twenty-sixth limit switch 796 guard plate rotation control system 798 are connected with the side car body 801, the third programmable logic controller 597 of the guard plate rotation control system 798 is connected with the twenty-fifth limit switch 795 and the twenty-sixth limit switch 796, the twenty-fifth limit switch 795 and the twenty-sixth limit switch 796 are connected with the thirteenth motor 789, and the thirteenth motor 789 is connected with the third programmable logic controller 597. When in use, the third programmable logic controller 597 of the protection plate rotation control system 798 controls the thirteenth motor 789 to start, the thirteenth motor 789 drives the second gear 788 to rotate, the second gear 788 drives the first gear 794 to rotate, the first gear 794 drives the rotating shaft 791 to rotate, and the rotating shaft 791 drives the protection plate 787 to rotate by 90 degrees to expose the battery box replacement control system 598.

As shown in FIG. 1-88, step 1, the remote operator 7 activates the intelligent battery replacement control system 45, the intelligent battery replacement vehicle 30 reaches the optimal battery replacement parking position of the electric vehicle 41 to be subjected to battery replacement, the remote operator 7 controls the intelligent battery replacement vehicle 30 and the electric vehicle 41 to be subjected to battery replacement through the remote operation table system 13, the remote operator 7 starts a pre-generated action program, and the battery replacement box 35 of the electric vehicle 41 to be subjected to battery replacement is unfolded.

Step 2: the second rotation control system 601 starts the eighth motor 489 to drive the second support leg 490 to rotate, the third rotation control system 602 starts the ninth motor 501 to drive the third support leg 502 to rotate, and the fourth rotation control system 603 starts the tenth motor 509 to drive the fourth support leg 515 to rotate, so that the first support leg 475, the second support leg 490, the third support leg 502 and the fourth support leg 515 rotate to the ground at the same time to a preset position.

Step 3: a remote operator 7 issues an action instruction for controlling a third leveling control system 616 through a remote console system 13, and sends a control signal to a fifth hydraulic servo controller 608, a sixth hydraulic servo controller 610, a seventh hydraulic servo controller 612 and an eighth hydraulic servo controller 614 through a remote control system 2 according to data fed back by the sensor and a preset action instruction, and the fifth hydraulic servo controller 608 controls the fifth hydraulic valve set 609 to act according to the control signal, so that the second double-acting multi-stage hydraulic cylinder 543 of the first telescopic leg 482 is controlled to complete the telescopic action to a specified position. The sixth hydraulic servo controller 610 controls the sixth hydraulic valve set 611 to act according to the control signal, so that the second double-acting multi-stage hydraulic cylinder 543 of the second telescopic leg 494 is controlled to complete the telescopic action to a specified position. The seventh hydraulic servo controller 612 controls the seventh hydraulic valve set 613 to act according to the control signal, so that the second double-acting multi-stage hydraulic cylinder 543 of the third telescopic leg 508 is controlled to complete the telescopic action to a specified position. The eighth hydraulic servo controller 614 controls the eighth hydraulic valve set 615 to act according to the control signal, so that the second double-acting multi-stage hydraulic cylinder 543 of the fourth telescopic leg 546 is controlled to complete the telescopic action to a specified position. After the first telescopic leg 482, the second telescopic leg 494, the third telescopic leg 508 and the fourth telescopic leg 546 all reach a specified position, the leveling process of the first telescopic leg 482, the second telescopic leg 494, the third telescopic leg 508 and the fourth telescopic leg 546 controlled by the third leveling control system 616 is as follows: the third leveling control system 616 controls the extending length of the supporting column oil cylinder according to the calculated distance from the supporting column to the ground, and the third length measuring sensor 533 correspondingly detects and detects the extending length value of the supporting column oil cylinder until the second hydraulic pressure sensor 528 of the supporting column oil cylinder detects that the bearing pressure of the supporting column oil cylinder reaches a preset value, the third inclination sensor 495 and the fourth inclination sensor 496 respectively detect the inclination state of the electric vehicle chassis 497 in the X-axis direction and the Y-axis direction; and the third leveling control system 616 calculates the inclination state of the electric vehicle chassis 497 according to the feedback information of each sensor according to a preset model, gives a leveling control scheme according to the system setting, and controls each supporting column to complete automatic leveling according to the leveling control scheme.

Step 4: A selection system 627 sets a target position of the robot 78 according to the position coordinates of the target first transfer robot 77. The motion control system 629 supplies power to the third motor 129 according to a pre-generated action program. The first programmable logic controller 188 supplies an action program instruction for driving the robot 78 to the robot drive system 630 according to a pre-generated action program. The robot drive system 630 has a circuit for driving the robot drive motor 634.

And step 5, the action control system 629 sends the action instruction of the driven vehicle door system 146 to the first programmable logic controller 188 of the rear door control system 303 according to a pre-generated action program, and the first programmable logic controller 188 supplies power to the first motor 298 according to the action instruction. The first programmable logic controller 188 controls the first motor 298 to drive the third threaded screw section 295 to rotate forward. The fifth nut 300 drives the first supporting rod 143 to move towards the first limiting switch 294, the upper section 130 of the rear vehicle door starts to be opened, the fifth nut 300 moves to the position of the first limiting switch 294, the first limiting switch 294 is triggered, the first motor 298 stops working, and the upper section 130 of the rear vehicle door is opened to a preset position.

Step 6, the action control system 629 sends the action instruction of the driving video sensor 631 to the video sensor 631 according to a pre-generated action program, and the action control system 629 generates an image definition automatic light supplementing program in advance according to the remote operator 7, sends an action instruction for driving the light supplementing lamp 127 to supplement light to the light supplementing lamp 127, and performs light supplementing on the image acquisition area of the video sensor 631.

Step 7: the acquisition system 628 acquires three-dimensional information of the first carrying robot 77 according to the distance from the visual sensor 631 to a fourteenth two-dimensional code 338 at the front part of the first carrying robot 77, and the acquisition system 628 calculates the distance from the visual sensor 631 to the fourteenth two-dimensional code 338 according to the parallax of the two images photographed by the first camera 122 and the second camera 126.

Step 8: the selection system 627 selects a selection process of the first transfer robot 77 taken out by the robot 78 according to the three-dimensional information of the first transfer robot 77, and the selection system 627 selects the first transfer robot 77 according to the position and posture of the first transfer robot 77.

Step 9: The action control system 629 sends an action instruction for driving the first pressure sensor 222 and the second pressure sensor 247 to a second programmable logic controller 224 of the manipulator control system 225 according to a pre-generated action program, and the second programmable logic controller 224 supplies power to the first pressure sensor 222 and the second pressure sensor 247.

Step 10: after the robot 78 adjusts the posture, a finger portion 124 of the manipulator 200 closes and holds the first carrying robot 77, the first pressure sensor 222 and the second pressure sensor 247, and transmits the pressure information to the second programmable logic controller 224; the second programmable logic controller 224 compares the received pressure information with a preset information and then determines that the first carrying robot 77 and the second programmable logic controller 224 close the fourth motor 205; the first carrying robot 77 is taken out on the first bracket 80; and the manipulator 200 holds the first carrying robot 77 and conveys the first carrying robot 77 to the first working point 591 of the first operation region 593.

Step 11: The monitoring device 626 ends the control after determining that the first carrying robot 77 predetermined by the remote operator 7 is taken out.

Step 12: the action control system 629 issues a control instruction according to a pre-generated action program, so that the visual navigation system 437 of the first carrying robot 77 starts navigation, and the magnetic navigation system 435 is in a closed state; and when the visual navigation system 437 breaks down, the third processor 622 acquires a second two-dimensional code 455 of the electric vehicle 41 to be subjected to battery replacement as a starting position, the thirteenth two-dimensional code 469 of the battery box 35 is set to be a second position, and the first carrying robot 77 is controlled to travel forwards from the starting position to the position right below the second position.

Step 13: the action control system 629 sends the action instruction of the driving terminal platform rotation control system 438 to the third wireless programmable logic controller 433 of the terminal platform rotation control system 438 according to a pre-generated action program, the third wireless programmable logic controller 433 supplies power to the eleventh motor 549, the eleventh motor 549 drives the terminal platform 381 to rotate towards the twenty-limit switch 548 and rotates to the position of the second ten-limit switch 548, the twenty-limit switch 548 is triggered, and the eleventh motor 549 stops rotating. A third camera 394 and a fourth camera 398 on the terminal platform 381 are aligned with a thirteenth two-dimensional code 469 at the bottom of the power-deficient battery box 35 of the vehicle-mounted battery box replacement system 564. The acquisition system 628 calculates the distance from the third camera 394 and the fourth camera 398 to the thirteenth two-dimensional code 469 according to the parallax of the two images photographed by the third camera 394 and the fourth camera 398 to generate the three-dimensional information of the power-deficient battery box 35. The acquisition system 628 calculates the distance from the third camera 394 and the fourth camera 398 to a thirteenth QR code 469 at the bottom of the battery box 35 according to the parallax of the two images captured by the third camera 394 and the fourth camera 398, and ejects the battery tray 380 at a preset position below the battery box 35.

Step 14: the third wireless programmable logic controller 433 sends a control signal to the fifth hydraulic servo controller 440, the sixth hydraulic servo controller 443, the seventh hydraulic servo controller 445 and the eighth hydraulic servo controller 447 according to the data fed back by the sensor, and the fifth hydraulic servo controller 440 controls the fifth hydraulic valve set 441 to act according to the control signal, so that the first double-acting multi-stage hydraulic cylinder 431 of the first supporting column is controlled to complete the telescopic action to a specified position; and the sixth hydraulic servo controller 443 controls the sixth hydraulic valve group 444 to act according to the control signal, so that the first double-acting multi-stage hydraulic cylinder 431 of the second supporting column is controlled to complete the telescopic action to a specified position; the seventh hydraulic servo controller 445 controls the seventh hydraulic valve 446 to act according to the control signal, so that the first double-acting multi-stage hydraulic cylinder 431 of the third supporting column is controlled to complete the telescopic action to a specified position; the eighth hydraulic servo controller 447 controls the eighth hydraulic valve set 448 to act according to the control signal, so that the first double-acting multi-stage hydraulic cylinder 431 of the fourth supporting column is controlled to complete the telescopic action to a designated position, and after the first supporting column 383, the second supporting column 376, the third supporting column 387 and the fourth supporting column 373 all reach the designated position, the control action instruction of the second leveling control system 432 is issued by the remote operator 7 through the remote operation table system 13, and is uploaded to the third wireless programmable logic controller 433 through the remote control system 2 to start leveling operation. The second length measuring sensor 419 correspondingly detects the extending length value of the supporting column oil cylinder until the supporting column oil cylinder second hydraulic pressure sensor 429 detects that the supporting column oil cylinder pressure bearing reaches a preset value. Meanwhile, the third inclination sensor 399 and the fourth inclination sensor 400 are read to detect the inclination state of the carrying robot chassis 384 in the X-axis direction and the Y-axis direction respectively, the system calculates the inclination state of the carrying robot chassis 384 according to the information fed back by each sensor, the leveling control scheme is given according to the system setting, all the supporting columns are controlled to complete automatic leveling according to the leveling control scheme, and the battery tray 380 is jacked at a preset preparation position for replacing the battery box 35.

Step 15: the third output shaft 561 of the sixth motor 562 drives the third screw rod section 577 to move reversely, the third nut 578 drives the third connecting rod 576 to move, the third connecting rod 576 drives the ninth grabbing plate 569 and the tenth grabbing plate 571 to move towards the twenty-limiting switch 581, the third connecting rod 576 triggers the second ten-limiting switch 581, the sixth motor 562 stops rotating, the ninth grabbing plate 569 and the tenth grabbing plate 571 are separated from the battery box 35, and the battery box 35 falls to the top of the first carrying robot 77.

And step 16, ending the operation of the robot 78 in the second operation area 588, enabling the action control system 629 to issue a control instruction according to a pre-generated action program, enabling the visual navigation system 437 of the first carrying robot 77 to start navigation, enabling the visual navigation system 437 to collect a ninth two-dimensional code 464 of the electric vehicle 41 as a starting position, enabling the sixth two-dimensional code 461 to be a second position, and controlling the first carrying robot 77 to start from the starting position to the second position.

Step 17: the eleventh motor 549 drives the terminal platform 381 to rotate towards the nineteenth limiting switch 547; the eleventh motor 549 drives the terminal platform 381 to rotate towards the nineteenth limiting switch 547; the eleventh motor 549 drives the terminal platform 381 to rotate towards the nineteenth limiting switch 547; the eleventh motor 549 drives the terminal platform 381 to rotate towards the nineteenth limiting switch 547; the action control system 629 issues a control instruction according to a pre-generated action program to enable the first carrying robot 77 visual navigation system 437 to start navigation; and the first carrying robot 77 travels to the first working point 591 of the first operation area 593 according to a predetermined second path 585.

Step 18: the visual sensor 631 starts to photograph the battery box 35 at the top of the first transfer robot 77, and the acquisition system 628 implements an acquisition process of acquiring three-dimensional information of the battery box 35 at the top of the first transfer robot 77 according to the output of the visual sensor 631. The acquisition system 628 generates three-dimensional information of the battery box 35 on the top of the first carrying robot 77 according to the distance from the visual sensor 631 to the eleventh two-dimensional code 467 mounted at the top of the battery box 35, and the acquisition system 628 calculates the distance from the visual sensor 631 to the second measuring point according to the parallax of the two images photographed by the first camera 122 and the second camera 126.

Step 19: after the robot 78 adjusts the posture, the action control system 629 sends an action instruction of the driving manipulator 200 to a second programmable logic controller 224 of the manipulator control system 225 according to a pre-generated action program, and the second programmable logic controller 224 supplies power to the fourth motor 205 according to the action instruction. The first output shaft 204 of the fourth motor 205 drives the first lead screw section 218 to rotate in the forward direction. The first lead screw section 218 pushes the first connecting rod 215 to drive the first gripping plate 201 and the second gripping plate 209 to move towards the battery box 35. During the delivery of the battery box 35, the battery box 35 does not fall off from the robot 200.

And step 20, the visual sensor 631 starts to shoot the battery box 35 in the first charging and replacing cabinet 72, and the obtaining system 628 implements the obtaining process of obtaining the three-dimensional information of the vacant first battery box bin 305 in the first charging and replacing cabinet 72 according to the output of the visual sensor 631. The acquisition system 628 generates three-dimensional information of the first charging and swapping cabinet 72 according to the distance from the vision sensor 631 to the vacant first battery compartment 305. The acquisition system 628 calculates the distance from the vision sensor 631 to the vacant first battery compartment 305 according to the parallax of the two images captured by the first camera 122 and the second camera 126.

Step 21: the selection system 627 selects a selection process for placing the battery box 35 into the target first battery compartment 305 by the robot 78 according to the three-dimensional information of the first charging and swapping cabinet 72. The selection system 627 selects a vacant battery compartment from high to low according to the position and posture of the first charging and swapping cabinet 72.

Step 22: after the robot 78 adjusts the posture, the finger portion 124 of the manipulator 200 closes and holds the battery box 35, and the manipulator 200 holds the battery box 35 and conveys the battery box 35 to the vacant first battery compartment 305 of the first charging and swapping cabinet 72.

Step 23: the first programmable logic controller 188 supplies power to the fifth motor 235 according to the action instruction; the first programmable logic controller 188 starts a fifth motor 235; the second output shaft 234 of the fifth motor 235 drives the second screw rod section 253 to rotate in the forward direction; the second nut 254 drives the second connecting rod 255 to move towards the battery box 35; the second connecting rod 255 drives the fifth clamping plate 241 and the sixth grabbing plate 231 to move towards the battery box 35; the second connecting rod 255 runs to the ninth limiting switch 252 to enable the fifth motor 235 to stop rotating; and the fifth grabbing plate 241 and the sixth grabbing plate 231 close to the seventh grabbing plate 245 and the eighth grabbing plate 228 and clamp the battery box 35.

Step 24, the action control system 629 sends the action instruction of the driving manipulator 200 to the second programmable logic controller 224 of the manipulator control system 225 according to a pre-generated action program, and the second programmable logic controller 224 supplies power to the fourth motor 205 according to the action instruction. The first output shaft 204 of the fourth motor 205 drives the first lead screw section 218 to rotate reversely, the first lead screw section 218 drives the first connecting rod 215 to move, the first connecting rod 215 drives the first gripping plate 201 and the second gripping plate 209 to move towards the eighth limiting switch 206, the first connecting rod 215 triggers the eighth limiting switch 206, the fourth motor 205 stops rotating, and the first gripping plate 201 and the second gripping plate 209 are separated from the battery box 35.

Step 25: The monitoring device 626 ends the control after determining that the battery box 35 predetermined by the remote operator 7 is placed in the first battery compartment 305 of the first battery charging and swapping cabinet 72.

Step 26: the selection system 627 sets the target position of the robot 78 according to the position and posture of the target battery box 35, and the motion control system 629 enables the robot slider system 83 to drive the robot 78 to travel to the second operation position 71, and at this time, the manipulator 200 refers to the part 124 to be opened.

And step 27, the visual sensor 631 starts to shoot the battery box 35 fully charged in the first charging and replacing cabinet 72, and the obtaining system 628 implements the obtaining process of obtaining the three-dimensional information of the fully charged battery box 35 in the first charging and replacing cabinet 72 according to the output of the visual sensor 631. The acquisition system 628 generates three-dimensional information of the first battery charging and replacing cabinet 72 according to the distance from the visual sensor 631 to the first charging and replacing cabinet 72 and the first measuring point of the battery box 35 fully charged. The acquisition system 628 calculates the distance from the vision sensor 631 to the first measurement point according to the parallax of the two images captured by the first camera 122 and the second camera 126.

Step 28: the selection system 627 implements a selection step of selecting the battery box 35 in the target second battery compartment 307 taken out by the robot 78 according to the three-dimensional information of the first charging and swapping cabinet 72. The selection system 627 selects a fully charged battery box 35 from the second battery compartment 307 to the sixth battery compartment 315 according to the position and posture of the first charging and swapping cabinet 72, the order from high to low, and the QR code of each battery compartment.

Step 29: After the robot 78 is aligned with the fully charged battery box 35 in the second battery compartment 307, the finger 124 of the robot 200 closes and holds the battery box 35

Step 30: the first programmable logic controller 188 starts the second output shaft 234 of the fifth motor 235 of the fifth motor 235 to drive the second screw rod section 253 to rotate reversely, the second nut 254 drives the second connecting rod 255 to move, the second connecting rod 255 drives the fifth grabbing plate 241 and the sixth grabbing plate 231 to move towards the tenth limiting switch 257, the second connecting rod 255 triggers the tenth limiting switch 257, the fifth motor 235 stops rotating, and the fifth grabbing plate 241 and the sixth grabbing plate 231 are separated from the battery box 35.

Step 31, the manipulator 200 takes out the battery box 35 in the second battery compartment 307, and the manipulator 200 holds the battery box 35.

Step 32: a visual sensor 631 starts to photograph a fifteenth two-dimensional code 663 on a battery tray 380 of a first transfer robot 77, and an acquisition system 628 implements an acquisition step of acquiring three-dimensional information of a battery tray 380 of the first transfer robot 77 according to the output of the visual sensor 631. The acquisition system 628 generates three-dimensional information of the battery box 35 on the top of the first transfer robot 77 according to the distance from the vision sensor 631 to the fifteenth QR code 663 mounted on the battery tray 380 as a fourth measurement point, and the acquisition system 628 calculates the distance from the vision sensor 631 to the fourth measurement point according to the parallax of the two images captured by the first camera 122 and the second camera 126.

Step 33: after the robot 78 adjusts the posture, the finger part 124 of the manipulator 200 closes and holds the battery box 35, the battery box 35 is put down on the top battery tray 380 of the first carrying robot 77, and the finger part 124 of the manipulator 200 is opened.

Step 34: The monitoring device 626 ends the control after determining that the battery box 35 predetermined by the remote operator 7 is put down at the top of the first carrying robot 77.

And step 35, when the battery box 35 in the second charging and replacing cabinet 75 is taken out and put into the second charging and replacing cabinet 75, the action control system 629 enables the robot slider system 83 to drive the robot 78 to drive to the first operation position 74.

Step 36: repeating the actions from step 4 to step 34.

And step 37, ending the operation of the robot 78 in the first operation area 593, and issuing a control instruction by the action control system 629 according to a pre-generated action program, so that the visual navigation system 437 of the first carrying robot 77 starts navigation. After the first carrying robot 77 travels to a third working point 586 of the second operation area 588 according to a predetermined second path (587), the visual navigation system 437 acquires a second two-dimensional code 455 of the electric vehicle 41 to be subjected to battery replacement as a starting position, and sets a ninth two-dimensional code 464 in the middle of the bottom of the chassis 497 of the electric vehicle as a second position to control the first carrying robot 77 to travel forwards to a position directly below the second position from the starting position.

Step 38, the action control system 629 sends the action instruction of the driving terminal platform rotation control system 438 to the third wireless programmable logic controller 433 of the terminal platform rotation control system 438 according to a pre-generated action program, the third wireless programmable logic controller 433 supplies power to the eleventh motor 549, the eleventh motor 549 drives the terminal platform rotation control system 438 to rotate towards the twenty-limit switch 548, the twenty-limit switch 548 is triggered, and the eleventh motor 549 stops rotating. a third camera 394 and a fourth camera 398 on the terminal platform 381 are aligned with a ninth two-dimensional code 464 in the middle of the bottom of the vehicle-mounted battery box replacement system 564 for shooting, the acquisition system 628 calculates the distance from the third camera 394 and the fourth camera 398 to the ninth two-dimensional code 464 according to the parallax of the two images shot by the third camera 394 and the fourth camera 398, and three-dimensional information of the vehicle-mounted battery box replacement system 564 is generated. The acquisition system 628 calculates the distance from the third camera 394 and the fourth camera 398 to the ninth two-dimensional code 464 at the bottom of the battery box 35 according to the parallax of the two images captured by the third camera 394 and the fourth camera 398, and ejects the battery box 35 on the upper part of the battery tray 380 below the preset position of the vehicle-mounted battery box replacement system 564.

And step 39, the second leveling control system 432 completes automatic leveling according to the leveling control scheme, and jacks the battery tray 380 at a preset preparation position for replacing the battery box 35.

Step 40: the third programmable logic controller 597 supplies power to the sixth motor 562 according to the action instruction, the third output shaft 561 of the sixth motor 562 drives the third screw rod section 577 to rotate in the forward direction, and the third screw rod section 577 drives the third connecting rod 576 to move towards the direction of the battery box 35, the third connecting rod 576 drives the ninth grabbing plate 569 and the tenth grabbing plate 571 to move towards the battery box 35, the third connecting rod 576 runs to the nineteenth limiting switch 579, the nineteenth limiting switch 579 is triggered to enable the sixth motor 562 to stop rotating, the ninth grabbing plate 569 and the tenth grabbing plate 571 are closed towards the eleventh grabbing plate 566 and the twelfth grabbing plate 551, and the ninth grabbing plate 569 and the tenth grabbing plate 571 clamp the battery box 35.

Step 41: the monitoring device 626 judges that the step is ended after the battery box 35 predetermined by the remote operator 7 is sent out, and the second leveling control system 432 returns to the original state.

and step 42, ending the operation of the robot 78 in the second operation area 588, enabling the action control system 629 to issue a control instruction according to a pre-generated action program, enabling the visual navigation system 437 of the first carrying robot 77 to start navigation, enabling the visual navigation system 437 to collect a thirteenth two-dimensional code 469 at the bottom of a battery box 35 of the electric vehicle 41 to be subjected to battery replacement as a starting position, enabling the sixth two-dimensional code 461 to be a second position, and controlling the first carrying robot 77 to start from the starting position to the second position.

Step 43: repeating the actions of step 17.

Step 44, after the robot 78 adjusts the posture, the finger 124 of the manipulator 200 closes and holds the first carrying robot 77.

Step 45: the visual sensor 631 starts to photograph the first support 80, the acquisition system 628 implements an acquisition process of acquiring the three-dimensional information of the first support 80 according to the output of the visual sensor 631, the acquisition system 628 generates three-dimensional information of the first support 80 according to the distance from the visual sensor 631 to the fifteenth two-dimensional code 657 on the top of the first support 80, and the acquisition system 628 calculates the distance from the visual sensor 631 to the first support 80 according to the parallax of the two images captured by the first camera 122 and the second camera 126.

Step 46: the selection system 627 selects a selection process of the first transfer robot 77 placed by the robot 78 according to the three-dimensional information of the first transfer robot 77, the selection system 627 selects the first transfer robot 77 according to the position and posture of the first transfer robot 77, the manipulator 200 holds the first transfer robot 77 and conveys the first transfer robot 77 to the first support 80, and the first support charging port 658 is connected to the transfer robot charging port 662.

Step 47: The action control system 629 sends the action instruction of the driven door system 146 to the first programmable logic controller 188 of the rear door control system 303 according to a pre-generated action program, and the first programmable logic controller 188 supplies power to the first motor 298 according to the action instruction. The first programmable logic controller 188 controls the first motor 298 to drive the third threaded screw section 295 to rotate reversely, the fifth nut 300 drives the first supporting rod 143 to move towards the fifth support 297, the rear vehicle door upper section 130 starts to be closed, the fifth nut 300 triggers the second limiting switch 296, the first motor 298 stops working, and the rear vehicle door upper section 130 is closed.

Step 48: The monitoring device 626 ends the control after determining that the first bracket 80 puts down the robot 78 predetermined by the remote operator 7.

Step 49, the intelligent battery replacing vehicle 30 navigates to the optimal operation position near the third charging and replacing cabinet 31 according to the position coordinates of the third charging and replacing cabinet 31.

Step 50, the visual sensor 631 starts to shoot the battery box 35 in the third charging and replacing cabinet 31, and the obtaining system 628 implements the obtaining process of obtaining the three-dimensional information of the battery box 35 in the third charging and replacing cabinet 31 according to the output of the visual sensor 631. The obtaining system 628 generates three-dimensional information of the third charging and replacing cabinet 31 according to the distance from the visual sensor 631 to the first measuring point of the battery box 35 in the third charging and replacing cabinet 31. The acquisition system 628 calculates the distance from the vision sensor 631 to the first measurement point according to the parallax of the two images captured by the first camera 122 and the second camera 126.

Step 51: the selection system 627 implements a selection step of selecting a fully charged battery box 35 in a target thirteenth battery compartment 357 removed by the robot 78 according to the three-dimensional information of the third charging and swapping cabinet (31). The selection system 627 selects a fully charged battery box 35 from the thirteenth battery compartment 357 to the sixteenth battery compartment 360 in a descending order of the position and posture of the third charging and swapping cabinet 31.

Step 52: the selection system 627 sets the target position of the robot 78 according to the position and posture of the target battery box 35, and the motion control system 629 enables the robot slider system 83 to drive the robot 78 to travel to the second operation position 71, and at this time, the finger 124 of the manipulator 200 is opened.

Step 53: After the robot 78 adjusts the posture, the finger 124 of the manipulator 200 closes and holds the battery box 35

Step 54: the second wireless programmable logic controller 361 starts the fifth motor 235; the second output shaft 234 of the fifth motor 235 drives the second screw rod section 253 to rotate reversely; the second screw rod section 253 drives the second connecting rod 255 to move; the second connecting rod 255 drives the fifth grabbing plate 241 and the sixth grabbing plate 231 to move towards the tenth limiting switch 257; the second connecting rod 25 triggers the tenth limiting switch 257; the fifth motor 235 stops rotating; and the fifth grabbing plate 241 and the sixth grabbing plate 231 are separated from the battery box 35.

Step 55, the manipulator 200 takes out the battery box 35 in the thirteenth battery compartment 357, and the manipulator 200 holds the battery box 35.

And step 56, the visual sensor 631 starts to shoot the battery box 35 in the first charging and replacing cabinet 72, and the obtaining system 628 implements the obtaining process of obtaining the three-dimensional information of the vacant first battery box bin 305 in the first charging and replacing cabinet 72 according to the output of the visual sensor 631. The acquisition system 628 generates three-dimensional information of the first charging and swapping cabinet 72 according to the distance from the vision sensor 631 to the vacant first battery compartment 305. The acquisition system 628 calculates the distance from the vision sensor 631 to the first battery compartment 305 according to the parallax of the two images captured by the first camera 122 and the second camera 126.

Step 57: the selection system 627 selects a selection process for placing the battery box 35 into the target first battery compartment 305 by the robot 78 according to the three-dimensional information of the first charging and swapping cabinet 72. The selection system 627 selects a vacant battery compartment according to the position and the posture of the first charging and swapping cabinet 72 from high to low.

Step 58: after the robot 78 adjusts the posture, the fingers 124 of the manipulator 200 close and hold the battery box 35, and the manipulator 200 holds the battery box 35 and conveys the battery box 35 into the first battery compartment 305 of the first charging and swapping cabinet 72.

Step 59: the first programmable logic controller 188 supplies power to the fifth motor 235 according to the action instruction; the first programmable logic controller 188 starts the fifth motor 235; the second output shaft 234 of the fifth motor 235 drives the second screw rod section 253 to rotate in the forward direction; the second nut 254 drives the second connecting rod 255 to move towards the battery box 35; the second connecting rod 255 triggers the ninth limiting switch 252 to enable the fifth motor 235 to stop rotating; and the fifth grabbing plate 241 and the sixth grabbing plate 231 close to the seventh grabbing plate 245 and the eighth grabbing plate 228 and clamp the battery box 35.

Step 60: The monitoring device 626 ends the control after it is determined that the first battery compartment 305 of the first battery charging and swapping cabinet 72 is placed in a predetermined number of fully charged battery boxes 35 by a remote operator 7.

Step 61: the selection system 627 sets the target position of the robot 78 according to the position coordinates of the target first transfer robot 77, and the motion control system 629 enables the robot slider system 83 to drive the robot 78 to travel to the second operation position 71, and at this time, the manipulator 200 means 124 is opened.

And step 62, the visual sensor 631 starts to shoot the battery box 35 in the first charging and replacing cabinet 72, and the obtaining system 628 implements the obtaining process of obtaining the three-dimensional information of the power shortage battery box 35 in the first charging and replacing cabinet 72 according to the output of the visual sensor 631. The acquisition system 628 generates three-dimensional information of the first charging and swapping cabinet 72 according to the distance from the vision sensor 631 to a first measurement point of the battery box 35 that is lack of electricity in the first charging and swapping cabinet 72. The acquisition system 628 calculates the distance from the vision sensor 631 to the first measurement point according to the parallax of the two images captured by the first camera 122 and the second camera 126.

Step 63: an acquisition system 628 implements an acquisition step of acquiring three-dimensional information of a battery box 35 under power shortage in a first battery compartment 305 of a first battery charging and swapping cabinet 72 according to the output of the visual sensor 631. The acquisition system 628 generates three-dimensional information of the first charging and swapping cabinet 72 according to the distance from the vision sensor 631 to the power-deficient battery box 35. The acquisition system 628 calculates the distance from the vision sensor 631 to the power-deficient battery box 35 according to the parallax of the two images captured by the first camera 122 and the second camera 126.

Step 64: the selection system 627 selects a selection step of taking out the power-deficient battery box 35 by the robot 78 according to the three-dimensional information of the first battery charging and replacing cabinet 72. The selection system 627 selects a power-deficient battery box 35 from a high-to-low order and two-dimensional code information of the battery box 35 according to the position and posture of the first battery charging and replacing cabinet 72.

Step 65: After the robot 78 adjusts the posture, the finger 124 of the manipulator 200 closes and holds the battery box 35.

Step 66: the first programmable logic controller 188 supplies power to the fifth motor 235 according to the action instruction, the first programmable logic controller 188 starts the fifth motor 235, the second output shaft 234 of the fifth motor 235 drives the second screw rod section 253 to rotate reversely, the second nut 254 drives the second connecting rod 255 to move, the second connecting rod 255 drives the fifth grabbing plate 241 and the sixth grabbing plate 231 to move towards the tenth limiting switch 257, the second connecting rod 255 triggers the tenth limiting switch 257 to enable the fifth motor 235 to stop rotating, and the fifth grabbing plate 241 and the sixth grabbing plate 231 are separated from the battery box 35.

Step 67, the manipulator 200 takes out the battery box 35 in the first battery box 305, the manipulator 200 holds the battery box 35, and after the robot 78 adjusts the posture, the finger 124 of the manipulator 200 closes and holds the battery box 35.

Step 68, the visual sensor 631 starts to photograph the battery box 35 in the third charging and replacing cabinet 31, and the obtaining system 628 implements the obtaining process of obtaining the three-dimensional information of the vacant thirteenth battery compartment 357 in the third charging and replacing cabinet 31 according to the output of the visual sensor 631. The acquisition system 628 generates three-dimensional information of the third charging and swapping cabinet 31 according to the distance from the vision sensor 631 to the vacant thirteenth battery compartment 357. The acquisition system 628 calculates the distance from the vision sensor 631 to the vacant thirteenth battery compartment 357 according to the parallax of the two images captured by the first camera 122 and the second camera 126.

Step 69: the selection system 627 selects a selection process for placing the battery box 35 into the target thirteenth battery compartment 357 by the robot 78 according to the three-dimensional information of the third charging and swapping cabinet 31. The selection system 627 selects a vacant battery compartment from high to low according to the position and posture of the third charging and swapping cabinet 31.

Step 70, after the robot 78 adjusts the posture, the finger portion 124 of the manipulator 200 closes and holds the battery box 35, and the manipulator 200 holds the battery box 35 and conveys the battery box 35 to the thirteenth battery compartment 357 of the third charging and replacing cabinet 31.

Step 71, the action control system 629 sends an action instruction for driving the thirteenth battery compartment control system 653 to a second wireless programmable logic controller 361 of the thirteenth battery compartment control system 653 according to a pre-generated action program, and the second wireless programmable logic controller 361 supplies power to the fifth motor 235 according to the action instruction. The second output shaft 234 of the fifth motor 235 drives the second screw section 253 to rotate in the forward direction, the second screw section 253 pushes the second connecting rod 255 to move towards the battery box 35, the second connecting rod 255 drives the fifth grabbing plate 241 and the sixth grabbing plate 231 to move towards the battery box 35, the second connecting rod 255 triggers the ninth limiting switch 252 to enable the fifth motor 235 to stop rotating, and the fifth grabbing plate 241 and the sixth grabbing plate 231 clamp the battery box 35.

Step 72: repeating the actions of step 47.

Step 73: The monitoring device 626 ends the control after it is determined that the thirteenth battery compartment 357 of the third battery charging and replacing cabinet 31 is placed in a battery box 35 predetermined by a remote operator 7 for a predetermined number.

Step 74: The action control system 629 sends the action instruction of the driving side door system 158 to the first programmable logic controller 188 of the side door control system 304 according to a pre-generated action program, and the first programmable logic controller 188 supplies power to the second motor 168 according to the action instruction. The first programmable logic controller 188 controls the second motor 168 to drive the threaded lead screw 169 to rotate in the forward direction, the first lead screw section 161 and the second lead screw section 164 on the threaded lead screw 169 are opposite in thread rotation direction, the first sliding door 132 and the second sliding door 133 move towards the two sides at the same time, the second sliding door 133 triggers the fourth limiting switch 180 to stop working, and the side door system 158 is opened.

Step 75: the acquisition system 628 acquires three-dimensional information of the first carrying robot 77 according to the distance from the visual sensor 631 to a fourteenth two-dimensional code 338 at the front part of the first carrying robot 77, and the acquisition system 628 calculates the distance from the visual sensor 631 to the fourteenth two-dimensional code 338 according to the parallax of the two images photographed by the first camera 122 and the second camera 126.

Step 76: the selection system 627 selects a selection process of the first transfer robot 77 taken out by the robot 78 according to the three-dimensional information of the first transfer robot 77, and the selection system 627 selects the first transfer robot 77 according to the position and posture of the first transfer robot 77.

Step 77: repeating the actions of step 2, step 3 and step 4.

Step 78, after the robot 78 adjusts the posture, the finger 124 of the manipulator 200 closes and holds the first carrying robot 77, the first carrying robot 77 is taken out on the first bracket 80, and the manipulator 200 holds the first carrying robot 77 and conveys the first carrying robot 77 to the second working point 592 of the first operation region 593.

Step 79: after the operation of the robot 78 in the first operation area 593 ends, the action control system 629 issues a control instruction according to a pre-generated action program, so that the visual navigation system 437 of the first carrying robot 77 starts navigation; and after the first carrying robot 77 runs to a sixth working point 596 of the fourth operation area 594 according to a predetermined fourth path 595, the visual navigation system 437 collects a first two-dimensional code 456 of the electric vehicle 41 to be subjected to battery replacement as a starting position, and a thirteenth two-dimensional code 469 arranged on the battery box 35 is a second position.

Step 80: repeating the actions of step 13, step 14 and step 15.

Step 81: the action control system 629 issues a control instruction according to a pre-generated action program, so that the visual navigation system 437 of the first carrying robot 77 starts navigation, the visual navigation system 437 collects a ninth two-dimensional code 464 of the electric vehicle 41 to be subjected to battery replacement as a starting position, the fifth two-dimensional code 465 is a second position, the first carrying robot 77 is controlled to travel forwards from the starting position to the second position, and the first carrying robot 77 runs to a second working point 592 of the first operation area 593 according to a predetermined fourth path 595.

Step 82: repeating the actions from step 16 to step 25.

Step 83: The action control system 629 sends the action instruction of the driving side door system 158 to the first programmable logic controller 188 of the side door control system 304 according to a pre-generated action program, and the first programmable logic controller 188 supplies power to the second motor 168 according to the action instruction. The first programmable logic controller 188 controls the second motor 168 to drive the threaded lead screw 169 to rotate reversely, the first lead screw section 161 and the second lead screw section 164 on the threaded lead screw 169 are opposite in thread rotation direction, and when the first sliding door 132 and the second sliding door 133 move towards the center at the same time, when the second sliding door 133 moves to the position of the third limiting switch 176, the second motor 168 stops working, and the side door system 158 is closed.

And step 84, the intelligent battery replacing vehicle 30 navigates to the optimal operation position near the second to-be-replaced electric vehicle 780 according to the position coordinates of the second to-be-replaced electric vehicle 780.

In step 85, a front cabin cover plate 733 of the second electric vehicle 780 to be subjected to battery replacement is opened.

86, a control action instruction of a fourth leveling control system 696 is issued by a remote operator 7 through a remote operation table system 13 and is uploaded to a fourth programmable logic controller 695 through a remote control system 2, a fourth programmable logic controller 695 sends a control signal to complete leveling action according to data fed back by the sensor and a preset action instruction, and the second vehicle-mounted battery box replacement system 617 abuts against a preset preparation position 815 of the battery replacement box 35.

And step 87, the visual sensor 631 starts to shoot the battery box 35 in the second vehicle-mounted battery box replacement system 617, and the acquisition system 628 implements an acquisition process of acquiring three-dimensional information of the battery box 35 in the second vehicle-mounted battery box replacement system 617 according to the output of the visual sensor 631. The acquisition system 628 generates three-dimensional information of the second vehicle-mounted battery box replacement system 617 according to the distance from the visual sensor 631 to the first measurement point of the battery box 35 in the second vehicle-mounted battery box replacement system 617. The acquisition system 628 calculates the distance from the vision sensor 631 to the first measurement point according to the parallax of the two images captured by the first camera 122 and the second camera 126.

Step 88: the selection system 627 implements a selection step of selecting the battery case 35 in the target second vehicle-mounted battery case replacement system 617 taken out by the robot 78 according to the three-dimensional information of the second vehicle-mounted battery case replacement system 617.

Step 89: The selection system 627 sets the target position of the robot 78 according to the position and posture of the target battery box 35, and the motion control system 629 causes the robot slider system 83 to drive the robot 78 to travel to the second operation position 71.

Step 90: After the robot 78 adjusts the posture, the finger 124 of the manipulator 200 closes and holds the battery box 35

Step 91, the action control system 629 sends an action instruction for driving the second vehicle-mounted battery box replacement system 617 to a fourth programmable logic controller 695 of the second battery box replacement control system 697 according to a pre-generated action program, and the fourth programmable logic controller 695 supplies power to the seventh motor 688 according to the action instruction. A fourth output shaft 687 of a seventh motor 688 drives a fourth screw section 675 to rotate reversely, a fourth screw section 675 drives a sixth nut 676 to rotate, a sixth nut 676 drives a fourth connecting rod 677 to rotate, a fourth connecting rod 677 drives a thirteenth grabbing plate 667 and a fourteenth grabbing plate 685 to move towards a twenty-second limiting switch 681, a fourth connecting rod 677 triggers a twenty-second limiting switch 681 to enable a seventh motor 688 to stop rotating, and a thirteenth grabbing plate 667 and a fourteenth grabbing plate 685 are separated from a battery box 35.

Step 92, the manipulator 200 takes out the battery box 35 in the second vehicle-mounted battery box replacement system 617, and the manipulator 200 holds the battery box 35.

Step 93: repeating the actions from step 56 to step 60.

Step 94: repeating the actions from step 26 to step 31.

And step 95, the visual sensor 631 starts to shoot a second vehicle-mounted battery box replacement system 617, and the acquisition system 628 implements an acquisition process of acquiring three-dimensional information of the vacant seventeenth battery compartment 698 in the second vehicle-mounted battery box replacement system 617 according to the output of the visual sensor 631. The acquisition system 628 generates three-dimensional information of the second vehicle-mounted battery box replacement system 617 according to the distance from the visual sensor 631 to the vacant second vehicle-mounted battery box replacement system 617. The acquisition system 628 calculates the distance from the visual sensor 631 to the second vehicle-mounted battery box replacement system 617 according to the parallax of the two images captured by the first camera 122 and the second camera 126.

Step 96: the selection system 627 selects a selection step of placing the battery box 35 into the target seventeenth battery compartment 698 by the robot 78 according to the three-dimensional information of the second vehicle-mounted battery box replacement system 617.

Step 97: after the robot 78 adjusts the posture, the finger part 124 of the manipulator 200 closes and holds the battery box 35, and the manipulator 200 holds the battery box 35 and conveys the battery box 35 to the seventeenth battery compartment 698 of the second vehicle-mounted battery box replacement system 617.

Step 98: The action control system 629 sends an action instruction for driving the second battery case replacement control system 697 to a fourth programmable logic controller 695 of the second battery case replacement control system 697 according to a pre-generated action program, and the fourth programmable logic controller 695 supplies power to the seventh motor 688 according to the action instruction. A fourth output shaft 687 of the seventh motor 688 drives a fourth screw section 675 to rotate forwards, a fourth screw section 675 drives a sixth nut 676 to rotate, a sixth nut 676 drives a fourth connecting rod 677 to rotate, a fourth connecting rod 677 drives a thirteenth grabbing plate 667 and a fourteenth grabbing plate 685 to move towards a battery box 35, a fourth connecting rod 677 triggers a twenty-first limiting switch 680 to enable a seventh motor 688 to stop rotating, and a thirteenth grabbing plate 667 and a fourteenth grabbing plate 685 clamp a battery box 35.

Step 99: The monitoring device 626 ends the control after determining that the seventeenth battery compartment 698 of the second vehicle-mounted battery box replacement system 617 is placed in a battery box 35 predetermined by a remote operator 7.

Step 100: the acquisition system 628 acquires three-dimensional information of the second carrying robot 79 according to the distance from the visual sensor 631 to a sixteenth two-dimensional code 714 at the front of the second carrying robot 79, and the acquisition system 628 calculates the distance from the visual sensor 631 to the sixteenth two-dimensional code 714 according to the parallax of the two images photographed by the first camera 122 and the second camera 126.

Step 101: a selection system 627 selects a selection process of a second transfer robot 79 taken out by a robot 78 according to three-dimensional information of a second transfer robot 79, and a selection system 627 selects a second transfer robot 79 according to the position and posture of the second transfer robot 79.

Step 102: The motion control system 629 sends an action instruction for driving the first pressure sensor 222 and the second pressure sensor 247 to a second programmable logic controller 224 of the manipulator control system 225 according to a pre-generated action program, and the second programmable logic controller 224 supplies power to the first pressure sensor 222 and the second pressure sensor 247.

Step 103: the finger portion 124 of the manipulator 200 closes and holds the first pressure sensor 222 and the second pressure sensor 247 of the first transfer robot 77 to transmit the pressure information to the second programmable logic controller 224; the second programmable logic controller 224 compares the received pressure information with a preset information and then determines that the second transfer robot 79 has been grasped; the second programmable logic controller 224 closes the fourth motor 205; the second transfer robot 79 is taken out on the second support 81; and the manipulator 200 holds the second transfer robot 79 and conveys the second transfer robot 79 to the first working point 591 of the first work area 593.

Step 104: The monitoring device 626 ends the control after determining that the second carrying robot 79 predetermined by the remote operator 7 is taken out.

Step 105: the action control system 629 issues a control instruction according to a pre-generated action program to enable the second carrying robot 79 to start navigation, the magnetic navigation system 435 is in a closed state, and after the second visual navigation system 776 fails, the second visual navigation system 776 collects a second two-dimensional code 455 of the electric vehicle 41 to be subjected to battery replacement as a starting position, and sets a thirteenth two-dimensional code 469 of the battery box 35 as a second position to control the second carrying robot 79 to run to the starting position.

Step 106: the action control system 629 sends an action instruction for driving the second terminal platform rotation control system 778 to a fourth wireless programmable logic controller 752 of the second terminal platform rotation control system 778 according to a pre-generated action program, the fourth wireless programmable logic controller 752 supplies power to the twelfth motor 745, and the twelfth motor 745 drives the second terminal platform 718 to rotate to the twenty-fourth limit switch 750 to rotate to the position of the twenty-fourth limit switch 750 to trigger the twenty-fourth limit switch 750, the twelfth motor 745 stops rotating, the fifth camera 728 and the sixth camera 732 on the second terminal platform 718 are aligned with a thirteenth two-dimensional code 469 at the bottom of the power-deficient battery box 35 for shooting, the acquisition system 628 calculates the distance from the fifth camera 728 and the sixth camera 732 to the thirteenth two-dimensional code 469 according to the parallax of the two images shot by the fifth camera 728 and the sixth camera 732, and three-dimensional information of the vehicle-mounted battery box replacement system 564 is generated. The acquisition system 628 calculates the distance from the fifth camera 728 and the sixth camera 732 to the thirteenth QR code 469 at the bottom of the battery box 35 according to the parallax of the two images captured by the fifth camera 728 and the sixth camera 732, and the second transfer robot 79 starts to travel forwards from the starting position to the position directly below the second position, and pushes the second support plate 784 at a preset position on the outer side of the lower portion of the battery box 35.

Step 107, the second carrying robot leveling control system 751 is leveled to a predetermined height.

Step 108: repeating the actions from step 7 to step 48.

Step 109, the intelligent battery replacement vehicle 30 navigates to the optimal operation position near the electric vehicle 41 to be subjected to battery replacement according to the position coordinates of the electric vehicle 41 to be subjected to battery replacement.

Step 110: repeating the actions of step 3.

Step 111: repeating the actions of step 74.

Step 112: the third programmable logic controller 597 supplies power to the thirteenth motor 789; the thirteenth motor 789 drives the rotating shaft 791 and the protection plate 787 to rotate to the twenty-sixth limiting switch 796 to rotate to the position of the twenty-sixth limiting switch 796; the twenty-sixth limiting switch 796 is triggered; the thirteenth motor 789 stops rotating; and at the moment, the side face of the whole vehicle-mounted battery box replacement system 564 is exposed.

Step 113: the visual sensor 631 starts to photograph the battery box 35 in the vehicle-mounted battery box replacement system 564, and the acquisition system 628 implements the acquisition process of acquiring the three-dimensional information of the battery box 35 in the vehicle-mounted battery box replacement system 564 according to the output of the visual sensor 631. The acquisition system 628 generates three-dimensional information of the vehicle-mounted battery box replacement system 564 according to the distance from the visual sensor 631 to the first measurement point of the battery box 35 in the vehicle-mounted battery box replacement system 564. The acquisition system 628 calculates the distance from the vision sensor 631 to the first measurement point according to the parallax of the two images captured by the first camera 122 and the second camera 126.

Step 114: the selection system 627 implements a selection step of selecting the battery case 35 in the target vehicle-mounted battery case replacement system 564 taken out by the robot 78 according to the three-dimensional information of the vehicle-mounted battery case replacement system 564.

Step 115: the selection system 627 sets the target position of the robot 78 according to the position and posture of the target battery box 35, and the motion control system 629 enables the robot slider system 83 to drive the robot 78 to travel to the first operation position 74, and at this time, the manipulator 200 refers to the part 124 to be opened.

Step 116: After the robot 78 adjusts the posture, the finger 124 of the robot 200 closes and holds the battery box 35

Step 117: the third output shaft 561 of the sixth motor 562 drives the third screw rod section 577 to rotate, the third screw rod section 577 drives the third nut 578 to rotate, the third nut 578 drives the third connecting rod 576 to rotate, the third connecting rod 576 drives the ninth grabbing plate 569 and the tenth grabbing plate 571 to move towards the twenty-limiting switch 581, the third connecting rod 576 triggers the second ten-limiting switch 581 to stop rotating, and the ninth grabbing plate 569 and the tenth grabbing plate 571 are separated from the battery box 35.

Step 118, the manipulator 200 takes out the battery box 35 in the vehicle-mounted battery box replacement system 564, and the manipulator 200 holds the battery box 35.

Step 119: repeating the actions from step 56 to step 60.

Step 120: repeating the actions from step 26 to step 31.

Step 121, the visual sensor 631 starts to shoot the vehicle-mounted battery box replacement system 564, and the acquisition system 628 implements the acquisition process of acquiring the three-dimensional information of the vacant vehicle-mounted battery box replacement system 564 in the vehicle-mounted battery box replacement system 564 according to the output of the visual sensor 631. The acquisition system 628 generates three-dimensional information of the vehicle-mounted battery box replacement system 564 according to the distance from the visual sensor 631 to the vacant vehicle-mounted battery box replacement system 564. The acquisition system 628 calculates the distance from the vision sensor 631 to the on-board battery box replacement system 564 according to the parallax of the two images captured by the first camera 122 and the second camera 126.

Step 122: the selection system 627 selects a selection step of putting the battery box 35 into the target vehicle-mounted battery box replacement system 564 by the robot 78 according to the three-dimensional information of the vehicle-mounted battery box replacement system 564.

Step 123, after the robot 78 adjusts the posture, the fingers 124 of the manipulator 200 close and hold the battery box 35, and the manipulator 200 holds the battery box 35 and conveys the battery box 35 into the vehicle-mounted battery box replacement system 564.

Step 124: the third programmable logic controller 597 supplies power to the sixth motor 562 according to the action instruction, the third output shaft 561 of the sixth motor 562 drives the third screw rod section 577 to rotate in the forward direction, and the third screw rod section 577 pushes the third connecting rod 576 to move towards the direction of the battery box 35, the third connecting rod 576 drives the ninth grabbing plate 569 and the tenth grabbing plate 571 to move towards the battery box 35, the third connecting rod 576 runs to the nineteenth limiting switch 579, the nineteenth limiting switch 579 is triggered to enable the sixth motor 562 to stop rotating, the ninth grabbing plate 569 and the tenth grabbing plate 571 are closed to the seventh grabbing plate 245 and the eighth grabbing plate 228, and the ninth grabbing plate 569 and the tenth grabbing plate 571 clamp the battery box 35.

Step 125: The monitoring device 626 ends the control after determining that the battery box 35 predetermined by the remote operator 7 is placed in the vehicle battery box replacement system 564.

Step 126: the third programmable logic controller 597 supplies power to the thirteenth motor 789, the thirteenth motor 789 drives the rotating shaft 791 and the protection plate 787 to rotate towards the twenty-fifth limiting switch 795, the thirteenth motor 789 rotates to the position of the twenty-fifth limiting switch 795, the twenty-fifth limiting switch 795 is triggered, the thirteenth motor 789 stops rotating, and the protection plate 787 is closed.

And step 127, the second to-be-replaced electric vehicle 780 navigates to the optimal operation position near the fourth charging and replacing cabinet 781 according to the position coordinates provided by the remote client waiters 6.

Step 128: repeating steps 85 and 86.

Step 129: the remote operator 7 activates the second robot 735, ie the control system of the robot 78, the selection system 627 sets the position of the robot 78 according to the position coordinates of the target second electric vehicle 780 to be replaced, the motion control system 629 enables the robot 78 to enter the operation position, and at this time, the fingers 124 of the manipulator 200 are opened.

Step 130: repeating the actions from step 87 to step 92.

Step 131: repeating the actions from step 68 to step 73.

Step 132: repeating the actions from step 50 to step 55.

Step 133: repeating the actions from step 95 to step 99.

What is claimed is:

1. The invention discloses a supply system of a service base electric energy supply and replenishment vehicle through an Internet of things architecture the supply system is characterized in that: the service base electric energy supply and replenishment vehicle is composed of a remote control system (2), an intelligent battery replacement control system (45), a carrying robot control system (442), an electric vehicle battery replacement control system (600), a third charging and replacing cabinet control system (362), a first supply base system (34) and a second supply base system (38) and supports the circulation of the battery box conveying network (44),
the remote control system (2) is provided with a remote communication system (1), a standby remote communication system (4) and a remote service terminal system (19),
the remote communication system (1) has a wireless carrier system (28), a global navigation satellite system (24), a communication satellite (23), an uplink transmitting station (22), a computer (21), and a ground network (20),
the wireless carrier system (28) is a cellular telephone system having a cellular tower (25), a mobile switching center (26), and other networking components required to connect the wireless carrier system (28) to the terrestrial network (20), the cellular tower (25) having a transmitting and receiving antenna and a base station, the base stations from different cellular towers (25) being directly connected to the mobile switching center (27) or to the mobile switching center (27) via an intermediate device of the base station controller, the communication technology implemented by the wireless carrier system (28) having AMPS analog technology and CDMA and GSM/GPRS digital technology,
a global navigation satellite system (24) is a space-based radio navigation positioning system capable of providing all-weather three-dimensional coordinates and speed and time information for a user at any place on the earth surface or near-earth space,
the communication satellite (23) serves as an artificial earth satellite of a radio communication relay station, and the communication satellite can transmit telephone and data information,
an uplink transmitting station (22), an uplink finger signal, from the mobile station to a physical channel of the base station,
the computer (21) provides a computer for Internet connection access, provides DNS services and serves as a network address server, which uses DHCP or other suitable protocols to assign IP addresses to the smart battery exchange (30) and the electric vehicle (41),
the terrestrial network (20) has a public switched telephone network (PSTN) and an Internet Protocol (IP) network, a standard wired network, an optical fiber network, a cable network, and a wireless network,
a second switch (17), a server (16), a database (15), a computer device (14) and a remote console system (13) of the remote service terminal system (19) are communicatively connected via a wired and wireless local area network (18),
the second switch (17) routes the input signal, transmits the voice transmission to a remote client attendant (6) of the remote console system (13), and transmits the data transfer to the computer device (14) for demodulation and further signal processing,
a computer device (14) has an encoder connected to a server (16) and a database),
a server (16) transmits and receives data information stored in a database (15), a first telematics unit (55), and a second telematics unit (61),
the database (15) can store account information, user authentication information and a vehicle identifier, and can also perform data transmission by means of a wireless system 422,11 x and GPRS,
the remote console system (13) has a remote console (5), a remote operator (7), and a remote client attendant),
the remote console (5) has an input device (9), a display device (10), a second memory (11) (RAM, ROM), and a second processor (12) (CPU, GPU) are communicatively connected by means of a third communication bus (8), The input device (9) has a keyboard of a plurality of operating keys for receiving an input operation of the remote operator (7), the display device (10) displays data as an image to the remote operator (7) for the LCD organic EL display, the remote operator (7) starts to execute remote control work after the remote console (5) activates the second processor (12),
the standby remote communication system (4) uses a communication satellite (23) and an uplink transmitting station (22) to complete one-way communication and two-way communication between the remote service terminal system (19) and the first charging base communication system (29), the second charging base communication system (42), the third charging base communication system (43), the intelligent battery replacement communication system (57), and the electric vehicle communication system (63),
a third communication bus (8) of the remote communication system (1) is connected to the wired and wireless local area network (18), The second processor (12) is connected to the first switch (13),
the first switch (13) is connected to the wired and wireless local area network (18), the wired and wireless local area network (18) is connected to the second switch (17) communication; the first short-range wireless communication circuit (46) is connected with the wireless communication unit (343) through a second antenna (355) of the first carrying robot (77) through a first short-distance wireless communication antenna (53); the wireless carrier system (28) is connected with a second wireless programmable logic controller (361) through a second main antenna (59) through a first antenna (354) and a cellular wireless network antenna interface (347); and the second wireless programmable logic controller (361) is connected with a thirteenth battery compartment control system (653), a fourteenth battery compartment control system (654), a fifteenth battery compartment control system (655) and a sixteenth battery compartment control system (656).

2. According to the supply system of the service base electric energy supply and supplied vehicle passing through the Internet of things architecture of claim 1, the method is characterized in that: the intelligent battery replacement control system (45) is provided with a tool of a transport battery box (35) capable of driving, an intelligent battery replacement vehicle (30) with a passenger car body and a second intelligent battery replacement vehicle (39) taking the container as a vehicle body, and the intelligent battery replacement control system (45) is provided with an intelligent battery replacement communication system (57), an intelligent battery replacement charging system (128), a rear vehicle door control system (303) and a rear vehicle door system (146); a side door control system (304), a side door system (158); a robot slider control system (226), a robot slider system (83); a first leveling control system (197), a manipulator control system (225), and a manipulator system (200); a first charging and replacing cabinet control system (632), a first charging and replacing cabinet (72), a second charging and replacing cabinet control system (633), a second charging and replacing cabinet (75), a magnetic attraction and plugging dual-acting connector system (278), a robot control system (618), a robot (78), a third charging and replacing cabinet control system (362), a third charging and replacing cabinet (31), a carrying robot control system (442), a carrying robot system (638), a first carrying robot (77), a second carrying robot (79), a monitor (73), a first bracket (80) and a second bracket (81): a first support leg (84), a second support leg (85), a third support leg (86) and a fourth support leg (87),
the first global navigation satellite system receiver (50) receives radio signals from the global navigation satellite system (24), The first global navigation satellite system receiver (50) can be configured for various GNSS systems, the first remote information processing unit (55) has a first short range wireless communication circuit (46), a first cellular chipset (47), a first processor (48), a first memory 49, and a first short range wireless communication an antenna (53) and a first main antenna (54); the first short-range wireless communication antenna (53) is connected to the first short-range wireless communication circuit (46); the first main antenna (54) is connected to the first cellular chip group (47); the first remote information processing unit (55) is configured to perform any one of wireless communication, Wi-Fi™, Wis, Bluetooth™ and Bluetooth™ according to the first short-range wireless communication circuit (46); and the first processor (48) is a device for processing an electronic instruction, and comprises a microprocessor, a microcontroller, a main processor, a controller, a vehicle communication processor and an application-specific integrated circuit (ASIC), an intelligent battery replacement charging system (128) of an intelligent battery replacement system (33) is provided with a photovoltaic cell layer (134), a charging controller (154), a vehicle-mounted charging device (OBC) (156), a battery management system (BMS) (157), a first charging and swapping cabinet (72), and a second charging and swapping cabinet (75), the charging controller (154) controls rapid charging; the charging controller (154), the vehicle-mounted charging device (OBC) (156), and the battery management system (BMS) (157) are connected to the charging interface (135) of the intelligent battery replacement vehicle (30) by means of the first circuit (155) The charging controller (154), the vehicle-mounted charging device (OBC) (156), and the battery management system (BMS) (157) are connected to the charging interface (135) of the intelligent battery replacement vehicle (30) by means of the first circuit (155) The photovoltaic cell layer (134) absorbs solar energy, and charges the first charging and swapping cabinet (72) and the second charging and swapping cabinet (75) by means of the charging controller (154).

3. According to the supply system of the service base electric energy supply and supplied vehicle passing through the Internet of things architecture according to claim 1, the service base electric energy supply and replenishment vehicle is characterized: the battery box (35) with power shortage in the electric vehicle (41) to be subjected to battery replacement is taken out and replaced with a battery box (35) fully charged, the power shortage battery box (35) is transported back to the first charging base (34) by the intelligent battery replacement vehicle (30), and after the intelligent battery replacement vehicle (30) returns to the first charging base (34), the driver (40) inserts the charging gun (136) of the self-charging pile (36) onto the charging interface (135) of the intelligent battery replacement vehicle (30), to charge the battery box (35) in the first charging and replacing cabinet (72) and the second charging and replacing cabinet (75) of the intelligent battery replacing trolley (30); the intelligent battery replacing trolley (30) reaches a public charging pile (37) of the second charging base (38); the driver (40) inserts a charging gun (137) of the public charging pile (37) onto a charging interface (135) of the intelligent battery replacing trolley (30); and the public charging gun (137) is connected to the charging interface (135) to charge the battery box (35) in the first charging and replacing cabinet (72) and the second charging and replacing cabinet (75) of the intelligent battery replacing trolley (30).

4. According to the supply system of the service base electric energy supply and supplied vehicle passing through the Internet of things architecture according to claim 1, the service base electric energy supply and replenishment vehicle is characterized: a third threaded lead screw section (295), a fourth support (299), a fifth support (297), a sixth support (301), a first limiting switch (294) and a second limiting switch (296) which are installed on a bottom plate (139) of a first side face (142) of a rear door frame (149) of the intelligent battery replacement vehicle (30), a first motor (298) is installed on the sixth support (301), the third threaded lead screw section (295) penetrates through the fifth nut (300), the fourth support (299) and the fifth support (297), and the upper end of the first supporting rod (143) is hinged to the upper portion of the inner side face of the rear door upper section (130); the lower end of the first supporting rod (143) is connected to the fifth nut (300), and the lower end of the first air pressure rod (145) is hinged to the upper portion of the inner side face of the rear door upper section (130); the upper end of the first air pressure rod (145) is hinged to the upper portion of the inner side face of the rear vehicle door lower section (131), and the lower end of the second air pressure rod (144) is hinged to the upper portion of the inner side face of the rear vehicle door upper section (130); the upper end of the second air pressure rod (144) is hinged to the upper portion of the inner side face of the rear vehicle door lower section (131), and the upper ends of the first hinge (140) and the second hinge (141) are connected to a rear door frame (149) of the intelligent battery replacement vehicle (30); a first limit switch (294) and a second limit switch (296) of the rear door control system (303) are connected to the first programmable logic controller (188), the first limit switch (294) and the second limit switch (296) are connected to the first motor (298), the first motor (298) is connected to the first programmable logic controller (188),
a side door system (158) mounted on a side (147) of an intelligent vehicle (30) compartment has a threaded screw (169), a lower rail (179), a first sliding door (132), a second sliding door (133), a first bracket (159), a second bracket (166), and a third bracket (167), a third limiting switch (176) and a fourth limiting switch (180) are mounted on the lower rail (179), a third pulley (177) and a fourth pulley (178) are mounted at the bottom of the first sliding door (132), The first pulley (174), the second pulley (175), the third pulley (177) and the fourth pulley (178) slide on the lower rail (179); the first nut (160) is connected to the first connecting block (170), the second nut (162) is connected to the second connecting block (171), the third nut (163) is connected to the third connecting block (172), the fourth nut (165) is connected to the fourth connecting block (173), and the first connecting block (170) and the second connecting block (171) are connected to the first sliding door (132); the third connecting block (172) and the fourth connecting block (173) are connected to the second sliding door (133), the first programmable logic controller (188) is connected to a third limiting switch (176) and a fourth limiting switch (180) provided on the side door control system (304), the second motor (168) is connected to the third limiting switch (176) and the fourth limiting switch (180), the second motor (168) is connected to the first programmable logic controller (188),
a robot (78) mounted on a robotic slider system (83) has a base (110) supported for rotation relative to a base (110) about a vertical first shaft (111); and a first arm (114) supported so as to be rotatable relative to the rotating body (112) about a horizontal second shaft (113); and a second arm (118) supported so as to be rotatable relative to the first arm (114) about a horizontal third shaft (115); and a first wrist element (119) supported so as to be rotatable relative to the second arm (118) about a fourth shaft (116) orthogonal to the third shaft (115); and a second wrist element (120) supported so as to be rotatable relative to the first wrist element (119) about a fifth shaft (117) orthogonal to the fourth shaft (116); and a third wrist element (125) supported so as to be rotatable with respect to the second wrist element (120) about a sixth axis (121) orthogonal to the fifth shaft (117), each of the first to sixth axes being provided with a servo motor and an encoder, the robot drive motor (634) being used for rotational drive, the encoder being configured to detect a rotation angle of the robot drive motor (634), a video sensor (631) mounted on the second wrist element (120) being composed of a first camera (122) and a second camera (126) arranged separately, a fill light (127) being mounted on the second wrist element (120), and a manipulator (200) mounted on the third wrist element (125) having a finger (124) opened and closed to grab or release the battery box (35); the finger part (124) is composed of a first gripping plate (201) and a second gripping plate (209),
a first sliding rail (202), a second sliding rail (207), a first fixing plate (214), and a second fixing plate (221) are mounted on a first side surface (208) of a first main plate (211) of the manipulator system (200), a first flange (213) is mounted in the middle of the first bearing plate (220), a first hollow groove (199) and a second hollow groove (210) are provided on the first main plate (211), a third grabbing plate (198) and a fourth grabbing plate (212) are vertically installed on the third side face (217), a first fixing frame (203) is installed outside the first side face (208), a fourth motor (205) is installed on the first fixing frame (203), a first screw rod section (218) is installed on the first rotating rod (220), the first nut (216) is sleeved on the first screw rod section (218), a first connecting rod (215) is installed on the first nut (216), the first connecting rod (215) is connected with the first grabbing plate (201) and the second grabbing plate (209), and a second programmable logic controller (224) of the manipulator control system (225) is connected with the seventh limiting switch (219) and the eighth limiting switch (206); the fourth motor (205) is connected to the seventh limiting switch (219) and the eighth limiting switch (206); the fourth motor (205) is connected to the second programmable logic controller (224), the first pressure sensor (222) and the second pressure sensor (247) are electrically connected to the second programmable logic controller (224),
a stop block (103), a guide rail (105), a coupler (108), a fifth limit switch (109), a sixth limit switch (107), and a third motor (129) are mounted on a robot slider system (83) mounted on the intelligent battery replacement trolley (30), a spiral guide rod (104) is mounted on the guide rail (105), a sliding base (106), a fifth limit switch (109), and a second operation position (71) are mounted on the guide rail (105), the first programmable logic controller (188) of the robot slider control system (226) is connected to the fifth limit switch (109) and the sixth limit switch (107), the third motor (129) is connected to the fifth limit switch (109) and the sixth limit switch (107), the third motor (129) is connected to the first programmable logic controller (188), the first programmable logic controller (188) controls the third motor (129) to drive the robot (78) mounted on the sliding base (106), and after the first operation position (74) reaches the position of the fifth limit switch (109) along the first axis (82), the third motor (129) stops rotating, and the robot (78) reaches the second operation position (71); the robot (78) returns to the sixth limit switch (107) along the first axis (82), the third motor (129) stops rotating, the robot (78) returns to the first operation position (74),
the first supporting leg (84), the second supporting leg (85), the third supporting leg (86) and the fourth supporting leg (87) of the intelligent battery replacing vehicle (30) are composed of a first leveling control system (197) and a second double-acting multi-stage hydraulic cylinder (543), The first leveling control system (197) is provided with a first hydraulic pressure sensor (182), a first position sensor (183), a first length measuring sensor (184), a first microwave distance measuring sensor (185), a first inclination sensor (186), a second inclination sensor (187), a first hydraulic servo controller (189), a second hydraulic servo controller (191), a third hydraulic servo controller (193) and a fourth hydraulic servo controller (195); the second hydraulic servo controller (191) is connected to the second hydraulic valve group (192) by means of a data line; the third hydraulic servo controller (193) is connected to the third hydraulic valve group (194) by means of a data line; and the fourth hydraulic servo controller (195) is connected to the fourth hydraulic valve group (196) by means of a data line,
a first hydraulic pressure sensor (182) mounted on the lower portion of the second base (535) of the second double-acting multi-stage hydraulic cylinder (543) feeds back data of its stress condition to the first programmable logic controller (188); a first position sensor (183) mounted on the lower portion of the second base (535) detects the fully retracted state of the strut oil cylinder and feeds back data to the first programmable logic controller (188); the first length measuring sensor (184) is mounted at the top of the second double acting multi-stage hydraulic cylinder (543) to detect the telescopic position distance of the strut oil cylinder and feed back the telescopic speed and position data of the strut oil cylinder to the first programmable logic controller (188); the first microwave ranging sensor (185) is mounted at the top of the hydraulic strut and is used for detecting the distance from the strut to the ground and feeding back the data to the first programmable logic controller (188).

5. The invention discloses a supply system of a service base electric energy supply and replenishment vehicle through an internet of things architecture according to claim 1 the supply system is characterized: the first programmable logic controller (188) sends a control signal to the first hydraulic servo controller (189), the second hydraulic servo controller (191), the third hydraulic servo controller (193) and the fourth hydraulic servo controller (195) according to data fed back by the sensor, the second hydraulic servo controller (191), the third hydraulic servo controller (193) and the fourth hydraulic servo controller (195), and the first hydraulic servo controller (189) controls the first hydraulic valve group (190) to act according to the control signal; so as to control a second double-acting multi-stage hydraulic cylinder (543) of the first supporting leg (84) to complete the telescopic action to a designated position, and the second hydraulic servo controller (191) controls, according to the control signal, the second hydraulic valve set (192) to act, so as to control the second double-acting multi-stage hydraulic cylinder (543) of the second supporting leg (86) to complete the telescopic action to a designated position: an action instruction of the first leveling control system (197) is issued by the remote operator (7) by means of the remote console system (13), and is uploaded to the first programmable logic controller (188) by means of the remote control system (2) to start a leveling operation; the first leveling control system (197) controls the extension length of the strut oil cylinder according to the calculated distance from the strut to the ground; and the first length measurement sensor (184) correspondingly detects the value of the extension length of the strut oil cylinder until the first hydraulic pressure sensor (182) of the strut oil cylinder detects that the bearing pressure of the strut oil cylinder reaches a preset value, the first inclination sensor (186) and the second inclination sensor (187) are simultaneously read to detect the inclination state of the vehicle in the X-axis direction and the Y-axis direction respectively; and the first leveling control system (197) calculates the inclination state of the chassis of the intelligent battery replacement vehicle (30) according to the feedback information of each sensor according to the preset model, provides a leveling control scheme according to the system setting, and controls the supporting columns to complete automatic leveling according to the leveling control scheme.

6. According to the supply system of the service base electric energy supply and supplied vehicle passing through the Internet of things architecture according to claim 1, the service base electric energy supply and replenishment vehicle is characterized: a third fixing plate (251) and a fourth fixing plate (232) are installed on the lower portion of a second main plate (240) of the first battery box system (243), a third sliding rail (250) is installed on the third fixing plate (251), a fourth sliding rail (258) is installed on the fourth fixing plate (232), a fifth grabbing plate (241) is vertically installed on the third sliding rail (250), a sixth grabbing plate (231) is vertically installed on the fourth sliding rail (258), a second gripper (233) is arranged on the sixth grabbing plate (231), the sixth grabbing plate (231) slides on the fourth sliding rail (258), and a plug (261) is installed on the seventh side face (238); a seventh holding plate (245) is vertically mounted on the seventh side surface (238), and a third gripper (246) is arranged on the seventh holding plate (245); a fourth gripper (229) is arranged on the eighth gripping plate (228), the first gripper (258), the second gripper (233), the third gripper (246) and the fourth gripper (229) are both semicircular, a battery box (35) is conveniently fixed, a fifth motor (235) is mounted on a second fixing frame (236) mounted on the fifth side surface (244), a second output shaft (234) of the fifth motor (235) penetrates through the second fixing frame (236) and is connected with the second rotating rod (256) through a coupler, and a second lead screw section (253) is mounted on the second rotating rod (256), a second connecting rod (255) is installed on the second nut (254), the second connecting rod (255) is connected to the fifth grabbing plate (241) and the sixth grabbing plate (231), a ninth limiting switch (252) and a tenth limiting switch (257) are installed on the lower portion of the second bearing plate (249), a first programmable logic controller (188) installed on the intelligent battery replacing trolley (30) is connected to the ninth limiting switch (252) and the tenth limiting switch (257), the ninth limiting switch (252) and the tenth limiting switch (257) are connected to the fifth motor (235), the fifth motor (235) is connected to the first programmable logic controller (188),
a plurality of first battery box systems (243) are respectively fixed on the first support (237) by means of first screws (227) to form a first battery compartment (305), a second battery compartment (307), a third battery compartment (309), a fourth battery compartment (311), a fifth battery compartment (313), a sixth battery compartment (315), and a second charging and swapping cabinet (75) in the first charging and swapping cabinet (72); the eighth battery compartment (308), the ninth battery compartment (310), the tenth battery compartment (312), the eleventh battery compartment (314), and the twelfth battery compartment (316) control the first battery compartment control system (260) and a first battery compartment control system (641), a second battery compartment control system (643), a third battery compartment control system (645), a fourth battery compartment control system (647), a fifth battery compartment control system (649), a sixth battery compartment control system (651), and a second charging and swapping cabinet control system (633) formed by the first battery compartment system (243) have the actions of a seventh battery compartment control system (642), an eighth battery compartment control system (644), a ninth battery compartment controller system (646), a tenth battery compartment control system (648), an eleventh battery compartment control system (650) and a twelfth battery compartment control system (652).

7. According to the supply system of the service base electric energy supply and supplied vehicle passing through the Internet of things architecture according to claim 1, the method is characterized in that: the plug (261) is mounted on the electric vehicle chassis device, the socket (262) is mounted on the battery box (35), and the plug (261) is provided with a plug housing (266), a plug damping rubber ball (267), a first output port (268), a second output port (269), a third output port (270), a floating plug body (263), and a floating plug body front end (265); a first N-pole magnet cone positioner (264), a second N-pole magnet cone positioner (273), a first high-voltage positive electrode plug-in piece (274), a first high-voltage negative electrode plug-in piece (276) and a first grounding plug-in piece (275) which are mounted on the front end (265) of the floating plug body, wherein the plug damping rubber ball (267) is mounted in the plug shell (266), the plug shell (266) and the floating plug body (263) are in close contact with the outside of the plug shell (266), and the plug damping rubber ball (267) has elasticity and buffering effects; the second output port (269) is a channel connecting the first high-voltage positive electrode plug-in member (274), the first high-voltage negative electrode plug-in member (276) and the first ground plug-in member (275) into the electric vehicle chassis (497); and the third output port (270) is a channel of the first pin array (271) connecting line entering the electric vehicle chassis (497),
the socket (262) has a floating socket body (279), a socket housing (282), a fourth output port (283), a fifth output port (284), a sixth output port (285), and a socket damping rubber ball (286), a first S-pole magnet inverted cone positioner (280), a second S-pole magnet inverted cone positioner (287), a second high-voltage positive electrode connector (288), a second high-voltage negative electrode connector (291), and a second ground connector 289 are mounted on a floating socket body front end (281) of the floating socket body (279); the fifth output port (284) is a channel connecting a wire of the second high-voltage positive electrode connector (288) and the second high-voltage negative electrode connector (291) into the battery box (35); and the sixth output port (285) is a channel for connecting the second pin base (290) to the battery box (35),
a signal line, a control line protector (640) and a power supply surge protector (639) are installed on the lower portion of a third mainboard (557) of the vehicle-mounted battery box replacement system (564), the first pin array (271) connecting line is connected with the signal line and the control line protector (640) in series,
a connecting line of the first high-voltage positive electrode plug-in member (274), the first high-voltage negative electrode plug-in member (276) and the first ground plug-in member (275) is connected in parallel with the power surge protector (639).

8. The supply system of the service base electric energy supply and supplied vehicle passing through the internet of things architecture according to claim 1 is characterized in that: the first processor (342) is in signal connection with the wireless communication unit (343), the main control unit (345) is in signal connection with the input and output unit (344), the ethernet communication unit (349), the RS485 communication unit (350), the RS232 communication unit (351) and the CAN communication unit (352), the main control unit (345) is connected with the power supply unit (353), the wireless communication unit (343) comprises a short message and GPRS communication radio frequency circuit, the wireless communication unit (343) is in signal connection with the SIM card seat interface (346), the cellular wireless network antenna interface (347) and the WiFi antenna interface (348), and the cellular wireless network antenna interface (347) is in signal connection with the first antenna (354); the WIFI antenna interface (348) is in signal connection with the second antenna (355), and the first wireless programmable logic controller (356) directly constructs a remote control system and has the five scanning period processes of input acquisition, relay control, timer and serial port communication, GPRS, short message and wireless data transmission radio station communication,
the third charging and swapping cabinet (31) is provided with a box body (321), a door body (324), a top rainproof plate (317), and a second monitor (322), a battery compartment (329) is mounted in the box body (321), a thirteenth battery compartment (357), a fourteenth battery compartment (358), a fifteenth battery compartment (359), and a sixteenth battery compartment (360) are mounted inside the battery compartment (329)),
a compressor bin (337) is installed on the upper portion of the battery box bin (329), a door body (324) is installed on the front surface of the box body (321), a heat preservation layer (323) is installed in the box body (321), an air inlet (328) and an air outlet (327) are installed in the box body (321), the compressor bin (337) communicates with an external space below the box body (321) through the air inlet (328) and the air outlet (327), heat dissipation is conducted on the compressor bin (337), and a condenser (333) and a mounting compressor (334) are installed in the compressor bin (337); a side face air inlet (330) is installed on the first side face plate (331), a side face air outlet (336) is installed on the second side face plate (335), and a charging gun (137) of the public charging pile (37) is connected with the third charging and replacing cabinet (31) charging interface (318),
a second wireless programmable logic controller (361) is installed in the third charging and replacing cabinet (31), the second wireless programmable logic controller (361) is composed of functions of a first wireless programmable logic controller (356), and the second wireless programmable logic controller (361) controls actions of a thirteenth battery compartment control system (653), a fourteenth battery compartment control system (654), a fifteenth battery compartment control system (655) and a sixteenth battery compartment control system (656) formed by the first battery box system (243), the second wireless programmable logic controller (361) is connected to the ninth limiting switch (252) and the tenth limiting switch (257), the ninth limiting switch (252) and the tenth limiting switch (257) are connected to the fifth motor (235), the fifth motor (235) is connected to the second wireless programmable logic controller (361), the thirteenth battery compartment control system (653), the fourteenth battery compartment control system (654), the fifteenth battery compartment control system (655) and the sixteenth battery compartment control system (656) are simultaneously connected to the second wireless programmable logic controller (361).

9. According to the supply system of the service base electric energy supply and supplied vehicle passing through the Internet of things architecture according to claim 1, the system is characterized in that the intelligent battery replacement control system (45) is provided with a robot control system (618) and a remote operation table system (13), the robot control system (618) is provided with a third memory (624) and a third processor (622), and the third memory (624) is provided with ROM and RAM to store various data; the third processor (622) is a CPU or a GPU, the third memory (624) is in communication connection with the third processor (622) via a fourth communication bus (623), and the robot control system (618) controls the electric vehicle battery swapping control system (600), the carrying robot control system (442), the third charging and swapping cabinet control system (362), the robot slider control system (226), the third programmable logic controller (597), the second wireless programmable logic controller (361), the third wireless programmable logic controller (433), the fourth wireless programmable logic controller (752), the first leveling control system (197), the second leveling control system (432), the third leveling control system (616) and the fourth leveling control system),
the remote console system (13) has a remote console (5), a remote operator (7) and a remote client attendant (6), the remote console (5) having an input device (9), a display device (10), a second memory (11) (RAM, ROM) and a second processor (12) (CPU, GPU) being communicatively connected by means of a third communication bus (8), the input device (9) having a plurality of operating keys, the remote console system (13) being communicatively connected to the robot control system (618) via the remote control system (2), the second processor (12) of the remote console (5) receiving, via the input device (9), an input of an action program pre-generated by the remote operator (7), and sending the input information of the action command to an action program storage system of a third memory (624) of the robot control system (618)),
an operation control system (629) transmits an operation instruction of a driving-side vehicle door system (158) to a first programmable logic controller (188) of a side door control system (304) according to a pre-generated action program of a remote operator (7), the first programmable logic controller (188) supplies power to a second motor (168) according to the action instruction, the action control system (629) sends an action instruction of the driven vehicle door system (146) to a first programmable logic controller (188) of the rear door control system (303) according to a pre-generated action program, the action control system (629) sends an action program instruction for driving the robot (78) to the robot driving system (630) according to a pre-generated action program; the robot driving system (630) has a circuit for driving the robot to drive the motor (634); the robot driving system (630) supplies power to the robot driving motor (634) according to the action instruction; the action control system (629) sends an action instruction of the driving manipulator (200) to a second programmable logic controller (224) of the manipulator control system (225) according to a pre-generated action program; and the second programmable logic controller (224) supplies power to the fourth motor (205) according to the action instruction, the motion control system (629) transmits an action instruction of the driver robot slider system (83) to a first programmable logic controller (188) of the robot slider control system (226) according to a pre-generated action program, the first programmable logic controller (188) supplies power to the third motor (129) according to the action instruction, the robot slider system (83) configures the robot (78) in the first operation position (74) or the second operation position (71), inputs a pre-generated action program to the robot control system (618) to perform the action of the robot (78), and the pre-generated action program is stored in the action program storage system (625) of the third memory (624), the robot control system (618) conveys the battery box (35) according to a pre-generated action program the robot (78) can automatically convey the battery box (35) to a predetermined position the action control system (629) sends an action instruction for driving the video sensor (631) to the video sensor (631) according to a pre-generated action program the action control system (629) sends, according to the image pre-generated by the remote operator (7),
the robot control system (618) has an acquisition system (628) for processing an image captured by a first camera (122) and a second camera (126), the acquisition system (628) can generate three-dimensional information of the battery box (35) by means of a stereoscopic method, the three-dimensional information has information related to a distance from the video sensor (631) to the first measurement point, the acquisition system (628) calculates a distance until the first measurement point set by the battery box (35) according to the parallax of the two images captured by the first camera (122) and the second camera (126),
the selection system (627) selects a target battery box (35) according to the three-dimensional information acquired from the image of the video sensor (631), the selection system (627) selects the battery box (35) from high to low according to the three-dimensional information, the robot (78), after reaching the target position and the target posture, closes the finger (124) of the robot (200) to hold the battery box (35), the motion control system (629) changes the position and posture of the robot (78) and conveys the battery box (35) to a desired position.

10. The invention discloses a supply system of a service base electric energy supply and supplied vehicle through an Internet of things architecture according to claim 1, and is characterized in that: the remote operator (7) sets the robot slider coordinate system CT on the keyboard of the input device (9), the origin of which is arranged at the left end of the guide rail (105), the X-axis direction is consistent with the direction of the first axis (82), the Z-axis direction is parallel to the vertical direction, the remote operator (7) sets the robot coordinate system C/R as the center of the base (110), the X-axis direction of the remote operator (7) is consistent with the direction of the first axis (82), and the Y-axis direction is consistent with the direction in which the battery box (35) is taken out and placed in the first charging and replacing cabinet (72), the X-axis direction of which is consistent with the direction of the first axis (82), the Y-axis direction of which is consistent with the Y-axis direction of the robot coordinate system C/R, the Z-axis direction of which is parallel to the vertical direction, the X-axis direction of which is consistent with the direction of the first axis (82), the Y-axis direction of which is consistent with the Y-axis direction of the robot coordinate system C/R, and the Z-axis direction of which is parallel to the vertical direction, the X-axis direction is consistent with the Y-axis direction of the robot coordinate system C/R, the Z-axis direction is parallel to the Y-axis direction of the robot coordinate system C/R, the X-axis direction of the first carrying robot (77) is consistent with the Y-axis direction of the first axis (82), the Y-axis direction of the first carrying robot (77) is consistent with the Y-axis direction of the robot coordinate system C/R, the Z-axis direction of the first carrying robot (77) is parallel to the vertical direction, and the coordinate system CN of the second carrying robot (79) is set to be, the X-axis direction thereof is consistent with the direction of the first axis (82), the Y-axis direction thereof is consistent with the Y-axis direction of the robot coordinate system C/R, the Z-axis direction thereof is parallel to the vertical direction, the X-axis direction thereof is consistent with the direction of the first axis (82), the Y-axis direction thereof is 90° from the direction in which the battery box (35) is taken out and placed in the third charging and swapping cabinet (31), and the Z-axis direction thereof is parallel to the vertical direction.

11. According to the supply system of the service base electric energy supply and supplied vehicle passing through the Internet of things architecture of claim 1, the method is characterized in that: when the robot (78) operates the first charging and replacing cabinet (72), the robot slider system (83) conveys the robot (78) to a pre-selected first operation position (74), the first operation position (74) controls the robot (78) in the first axis (82) direction in the first axis (82) direction, and the robot (78) is connected to the battery box (35) in the first battery compartment control system (641), the second battery compartment control system (643), the third battery compartment control system (645), the fourth battery compartment control system (647), the fifth battery compartment control system (649), and the sixth battery compartment control system (651), the robot slider system (83) transports the robot (78) to a pre-selected first work position (74), the first work position (74) controls the robot (78) in the first axis (82) direction at the first work position (74) by taking the robot coordinate system C/R as a reference, and the robot (78) is connected to the seventh battery compartment control system (642) and the eighth battery compartment control system (644), a ninth battery compartment controller system (646), a tenth battery compartment control system (648), an eleventh battery compartment control system (650), and a battery compartment (35) in the twelfth battery compartment control system (652) the operation of taking out and placing the battery compartment (35) in the second charging and swapping cabinet (75) is sequentially completed, and when the robot (78) operates the third charging and swapping cabinet (31), the robot slider system (83) conveys the robot (78) to a pre-selected second working position (71), the robot (78) and the thirteenth battery compartment control system (653), the fourteenth battery compartment control system (654), the fifteenth battery compartment control system (655) and the sixteenth battery compartment control system (656) in the direction of the first axis (82), the robot (78) and the thirteenth battery compartment control system (653), the fourteenth battery compartment control system (654), the fifteenth battery compartment control system (655), and the sixteenth battery compartment control system (656) are coordinated with each other in the X-axis direction of the third charging and swapping cabinet coordinate system C/H, and the operation of taking out and placing the battery compartment (35) in the third charging and swapping cabinet (31) is completed in sequence.

12. According to the supply system of the service base electric energy supply and supplied vehicle passing through the Internet of things architecture of claim 1, the method is characterized in that: the carrying robot control system (442) is provided with a second leveling control system (432), an obstacle avoidance system (434), a magnetic navigation system (435), a walking mechanism control system (436), a visual navigation system (437), a terminal platform rotation control system (438) and an angle deviation correction mechanism control system (439); the carrying robot system (638) is provided with a carrying robot walking system (637), a carrying robot lifting system (636) and an angle deviation rectifying system (635); the carrying robot chassis (384) is provided with a carrying robot walking system (637), a carrying robot lifting system (636) and an angle deviation rectifying system (635); and a second leveling control system (432), an angle deviation rectifying mechanism control system (439) and a walking mechanism of the carrying robot control system (442) are controlled system; the third wireless programmable logic controller (433) is composed of functions of a first wireless programmable logic controller (356); a first cellular chipset (47) included in a first telematics unit (55) of the wireless carrier system (28) is connected to a data acquisition device (621) of the robot control system (618) via a cellular protocol; the first short-range wireless communication circuit (46) is connected to the wireless communication unit (343) by means of a first short-range wireless communication antenna (53) by means of a second antenna (355) of the first transport robot (77),
a smart battery swapping communication system (57) outputs a received sensor signal to a data acquisition device (621), the data acquisition device (621) stores the acquired sensor signal in a third memory (624), The motion control system (629) performs feedback control according to a signal from a position detector of a rotary encoder included in each of the transport robot control systems (442), The motion control system (629) outputs a driving instruction to a third wireless programmable logic controller (433) by means of a remote control system (2) according to a pre-generated action program, the third wireless programmable logic controller (433) controls the first carrying robot (77) to execute each program,
a third wireless programmable logic controller (433), an obstacle avoidance system (434), a visual navigation system (437), a signal pre-processor (449), an electronic differential controller (450), a first motor controller (390), a first driving motor (389), a first rotating speed sensor (451), a second motor controller (391), a third driving motor (403), a third rotating speed sensor (452), a battery charging port (406), a battery (401) and a starting switch (405); the third wireless programmable logic controller (433) is connected to the signal pre-processor (449); the signal pre-processor (449) is connected to the electronic differential controller (450); the electronic differential controller (450) is connected to the first motor controller (390), the second motor controller (391), the third motor controller (404) and the fourth motor controller (402); and the first driving motor (389) is connected to and controlled by the first motor controller (390); and the second drive motor (392) is connected to and controlled by the second motor controller (391); and the third drive motor (403) is connected to and controlled by the third motor controller (404); the first driving motor (389) is connected to and directly driven by the first wheel (382), the second driving motor (392) is connected to and directly driven by the second wheel (386), the third driving motor (403) is connected to and directly driven by the third wheel (385), the battery (401) is connected to the third wireless programmable logic controller (433) by means of the starting switch (405), the starting switch (405) controls the battery (401) to be on and off, and the battery charging port (406) is connected to the battery (401), the obstacle avoidance system (434) is provided with an ultrasonic ranging sensor (395) and a laser ranging sensor (396), the ultrasonic ranging sensor (395) is divided into eight ultrasonic probes, and is connected to a third wireless programmable logic controller (433) by means of an RS485 communication unit (350), the laser ranging sensor (396) is connected in series to a CAN communication unit (352) of a third wireless programmable logic controller (433) by means of four sensors, a third camera (394) and a fourth camera (398) provided by the visual navigation system (437) are electrically connected to the image sensor (393),
the transfer robot lifting system (636) controlled by the second leveling control system (432) is composed of a plurality of first double-acting multi-stage hydraulic cylinders (431) mounted at four corners of the second bottom plate (377), In the embodiment, there are four first double-acting multi-stage hydraulic cylinders (431), that is, the first jacking columns (383), the second jacking columns (376), the third jacking columns (387) and the fourth jacking columns (373) are all composed of a second leveling control system (432) and a first double-acting multi-stage hydraulic cylinder (431) and a second hydraulic pressure sensor (429), a second position sensor (408), a second length measuring sensor (419), a second microwave distance measuring sensor (420), a third inclined sensor (399), a fourth inclined sensor (400), a fifth hydraulic servo controller (440), a sixth hydraulic servo controller (443), a seventh hydraulic servo controller (445) and an eighth hydraulic servo controller (447) are respectively connected with the third wireless programmable logic controller (433) through data lines, and the fifth hydraulic servo controller (440) is connected with the fifth hydraulic valve group (441) through a data line; the sixth hydraulic servo controller (443) is connected to the sixth hydraulic valve group (444) by means of a data line; the seventh hydraulic servo controller (445) is connected to the seventh hydraulic valve group (446) by means of a data line; and the eighth hydraulic servo controller (447) is connected to the eighth hydraulic valve group (448) by means of a data line, a second eleven limiting switch (364), a twenty-second limiting switch (368), a connecting circular ring (367), an outer ring of a bearing (370), a seventh support (378), a third inclined sensor (399), and a fourth inclined sensor (400) are mounted on a support plate (363) of the angle correction system (635), a servo motor (374) is mounted on the seventh support (378), an encoder (375) is mounted on a shaft of the servo motor (374), a positioning gear (365) is mounted on the ball bearing; a rotating positioning block (366) and a battery tray (380) are mounted on the positioning gear (365); a fifteenth two-dimensional code (663) and a positioning block (604) are mounted on the battery tray (380); and when the servo motor (374) drives the pinion (369) to rotate, the positioning gear (365) drives the battery tray (380) to rotate, a servo motor controller (372) is mounted on the second bottom plate (377), and the second bottom plate (377) is fixed on the carrying robot chassis (384) through the mounting opening (371) by using screws,
the servo motor controller (372) is connected to the servo motor (374), the servo motor (374) is connected to the encoder (375), The encoder (375) is connected to the third wireless programmable logic controller (433), the twenty-first limit switch (364) and the twenty-second limit switch (368) are connected to the third wireless programmable logic controller (433); the encoder (375) is used for detecting the rotation angle of the shaft of the servo motor (374); the encoder (375) transmits the detected angle value to the third wireless programmable logic controller (433); the servo motor (374) drives the positioning gear (365) to rotate anticlockwise by 90 degrees to the position of the twenty-first limiting switch (364); the servo motor (374) drives the positioning gear (365) to rotate clockwise by 90 degrees to the position of the twenty-second limiting switch (368); and the rotating positioning block (366) triggers the second twelve-limiting switch (368) to stop rotating the servo motor (374), an eleventh motor (549) and a rotating shaft (605) are installed on the supporting plate (363), a terminal platform (381) is installed on the rotating shaft (605), a third camera (394), a fourth camera (398), an ultrasonic distance measuring sensor (395), a laser distance measuring sensor (396), a magnetic navigation sensor (397), a wire inlet and outlet (606) and a fourteenth two-dimensional code (338) are installed on the terminal platform (381), and a nineteenth limiting switch (547) and a twenty-limiting switch (548) are installed on the supporting plate (363).

13. According to the supply system of the service base electric energy supply and supplied vehicle passing through the internet of things architecture according to claim 1, the method is characterized in that: the electric vehicle battery replacement control system (600) is composed of an electric vehicle communication system (63), a third programmable logic controller (597), a battery box replacement control system (598), a vehicle-mounted battery box replacement system (564), a first rotation control system (599), a second rotation control system (601), a third rotation control system (602), a fourth rotation control system (603), and a third leveling control system (616), a second main antenna (59) and a second short-range wireless communication antenna (60); the second main antenna (59) is connected to the second cellular chipset (64); the second short-range wireless communication antenna (60) is connected to the second short-range wireless communication circuit (65); the second remote information processing unit (61) is configured to be capable of being communicatively connected to a third programmable logic controller (597) mounted on the electric vehicle (41); the second communication bus (62) is communicatively connected to a third programmable logic controller (597) mounted on the electric vehicle (41); the wireless carrier system (28) and the second cellular chipset (64) included in the second telematics unit (61) of the electric vehicle communication system (63) perform cellular communication by means of the second main antenna (59) via a cellular protocol,
the electric vehicle landing leg lifting system (573) is provided with a first lifter (472), a second lifter (491), a third lifter (505), and a fourth lifter (516), The first lifter (472) is composed of the following components: an eighth bracket (477) is mounted on the electric vehicle chassis (497); a seventh motor (476), a first universal gear (478) and a second universal gear (479) are mounted on the eighth bracket (477); the first universal gear (478) is engaged with the second universal gear (479); a first supporting leg (475) is mounted on a first rotating rod (473) of the second universal gear (479); a first dustproof cover (474) and an output shaft of the seventh motor (476) are mounted on the first supporting leg (475); an eleventh limiting switch (480) and a twelfth limiting switch (481) are mounted on the electric vehicle chassis (497), the seventh motor (476) is connected to the eleventh limiting switch (480) and the twelfth limiting switch (481), the seventh motor (476) is connected to the eleventh limiting switch (480) and the twelfth limiting switch (481), and the seventh motor (476) is connected to the third programmable logic controller (597) during use, the third programmable logic controller (597) controls the seventh motor (476) to start, the seventh motor (476) drives the first universal gear (478) to rotate, the first universal gear (478) drives the second universal gear (479) to rotate, the second universal gear (479) drives the first rotating rod (473) to rotate, and the first rotating rod (473) drives the first supporting leg (475) to rotate,
the second lifter (491) is formed as follows: a ninth bracket (488) is mounted on the electric vehicle chassis (497); an eighth motor (489), a third universal gear (485) and a fourth universal gear (487) are mounted on the ninth bracket (488); a second supporting leg (490) is mounted on a second rotating rod (484) of the third universal gear (485); a second dustproof cover (483) and an output shaft of the eighth motor (489) are mounted on the second supporting leg (490); a thirteenth limiting switch (492) and a fourteenth limiting switch (493) are mounted on the electric vehicle chassis (497), the thirteenth limiting switch (492) and the fourteenth limiting switch (493) are connected to the eighth motor (489), and the eighth motor (489) is connected to the third programmable logic controller (597) During use, the third programmable logic controller (597) controls the eighth motor (489) to start, the eighth motor (489) drives the fourth universal gear (487) to rotate, the fourth universal gear (487) drives the third universal gear (485) to rotate, the third universal gear (485) drives the second rotating rod (484) to rotate, and the second rotating rod (484) drives the second supporting leg (490) to rotate, the third lifter (505) is formed as follows: a tenth bracket (500) is mounted on the electric vehicle chassis (497); a ninth motor (501), a fifth universal gear (498) and a sixth universal gear (499) are mounted on the tenth bracket (500); a third supporting leg (502) is mounted on a third rotating rod (504) of the fifth universal gear (498); a third dustproof cover (503) and an output shaft of the ninth motor (501) are mounted on the third supporting leg (502); a fifteenth limiting switch (506) and a sixteenth limiting switch (507) are mounted on the electric vehicle chassis (497), the fifteenth limiting switch (506) and the sixteenth limiting switch (507) are connected to the ninth motor (501), and the ninth motor (501) is connected to the third programmable logic controller (597) When in use, the third programmable logic controller (597) controls the ninth motor (501) to start, the ninth motor (501) drives the sixth universal gear (499) to rotate, the sixth universal gear (499) drives the fifth universal gear (498) to rotate, the fifth universal gear (498) drives the third rotating rod (504) to rotate, and the third rotating rod (504) drives the third supporting leg (502) to rotate,
the fourth lifter (516) is formed as follows: an eleventh bracket (510) is mounted on an electric vehicle chassis (497); a tenth motor (509), a seventh universal gear (511) and an eighth universal gear (512) are mounted on the eleventh bracket (510); a fourth supporting leg (515) is mounted on a fourth rotating rod (513) of the eighth universal gear (512); a fourth dustproof cover (514) and an eighteenth limiting switch (545) are mounted on the fourth supporting leg (515); a seventeenth limiting switch (544) and an eighteenth limiting switch (545) are mounted on the electric vehicle chassis (497); and the third programmable logic controller (597) is connected with the seventeenth limiting switch (544) and the eighteenth limiting switch (545), the tenth motor (509) drives the seventh universal gear (511) to rotate, the seventh universal gear (511) drives the eighth universal gear (512) to rotate, the eighth universal gear (512) drives the fourth rotating rod (513) to rotate, the fourth rotating rod (513) drives the fourth supporting leg (515) to rotate, and the third programmable logic controller (597) controls the seventh motor (476), the eighth motor (489), the ninth motor (501) and the tenth motor (509) to be started at the same time,
a first telescopic leg (482) is installed in a first supporting leg (475) of an electric vehicle supporting leg lifting system (573), a second telescopic leg (494) is installed in the second supporting leg (490), a third telescopic leg (508) is installed in the third supporting leg (502), a fourth telescopic leg (546), a first telescopic leg (482), a second telescopic leg (494), a third telescopic leg (508) and a fourth telescopic leg (546) are installed in the fourth supporting leg (515), and the first telescopic leg (482), the second telescopic leg (494), the third telescopic leg (508) and the fourth telescopic leg (546) are both composed of a third leveling control system (616) and a second double-acting multi-stage hydraulic cylinder (543), a second hydraulic pressure sensor (528), a second position sensor (530), a third length measurement sensor (533), a second microwave ranging sensor (525), a third tilt sensor (495), a fourth tilt sensor (496), a fifth hydraulic servo controller (608), a sixth hydraulic servo controller (610), a seventh hydraulic servo controller (612) and an eighth hydraulic servo controller (614) are all connected with a third programmable logic controller (597) through data lines, and the fifth hydraulic servo controller (608) is connected with a fifth hydraulic valve group (609) through a data line; the sixth hydraulic servo controller (610) is connected to the sixth hydraulic valve group (611) by means of a data line; the seventh hydraulic servo controller (612) is connected to the seventh hydraulic valve group (613) by means of a data line; and the eighth hydraulic servo controller (614) is connected to the eighth hydraulic valve group (615) by means of a data line.

14. According to the supply system of the service base electric energy supply and supplied vehicle passing through the Internet of things architecture according to claim 1, the method is characterized in that; and the second double-acting multi-stage hydraulic cylinder (543) is an N-stage hydraulic cylinder N≥2 the present application relates to a three-stage cylinder when a third-stage hydraulic cylinder is jacked up, hydraulic oil enters a second-stage cylinder jacking oil cavity (524) from a third oil port (526) and then ejects a second-stage cylinder piston (534) downwards, then hydraulic oil enters a second-stage cylinder jacking oil cavity (520) through a second-stage cylinder jacking oil cavity (521) to jack up a second three-stage cylinder piston (519), and residual oil in each stage of contraction oil cavity flows out of a fourth oil port (532), when the third-stage hydraulic cylinder contracts, the hydraulic oil enters the second-stage cylinder contraction oil cavity (536) from the fourth oil port (532) and enters the second-stage cylinder contraction oil cavity (536) through the second-stage cylinder contraction oil cavity (535) to compress the second-stage cylinder piston (534) upwards, then the second-stage cylinder contraction oil cavity (541) enters the second-stage cylinder contraction oil cavity (518) to compress the second three-stage cylinder piston (519) upwards, the residual oil in each stage of jacking oil cavity flows out of the third oil port (526) through the jacking oil cavity oil channel,
a second hydraulic pressure sensor (528) installed at the lower part of the second base (535) of the second double-acting multi-stage hydraulic cylinder (543) feeds back the data of the stress condition to the third programmable logic controller (597); a second position sensor (530) mounted on the lower portion of the second base (535) detects the fully retracted state of the strut oil cylinder and feeds back data to the third programmable logic controller (597); the third length measuring sensor 533 is mounted at the top of the strut oil cylinder to detect the telescopic position distance of the strut oil cylinder and feed back the telescopic speed and position data of the strut oil cylinder to the third programmable logic controller (597); the second microwave ranging sensor (525) is mounted at the center of the electric vehicle chassis (497) and is used for detecting inclination data of the electric vehicle chassis (497) in the X-axis direction and the Y-axis direction; and a concave base (542) is mounted on the spherical end (517) of the telescopic leg.

15. According to the supply system of the service base electric energy supply and supplied vehicle passing through the internet of things architecture of claim 1, the method is characterized in that: a fifth sliding rail front end fixing plate (574), a sixth sliding rail front end fixing plate (582), a fifth sliding rail (575) and a sixth sliding rail (583) are installed on the lower portion of a third main plate (557) of the vehicle-mounted battery box replacement system (564), a second flange (553) is installed on the third bearing plate (558), the second flange (553) is fixed to the electric vehicle chassis (497) through a second screw (554), other parts of the vehicle-mounted battery box replacement system (564) are fixed to the electric vehicle chassis (497) through a third screw (555), and a fifth hollow groove (568) and a sixth hollow groove (572) are formed in the third main plate (557), a ninth grabbing plate (569) is vertically installed on the fifth sliding rail (575), a fifth gripper (570) is arranged on the ninth grabbing plate (569), a ninth grabbing plate (569) slides on the fifth sliding rail (575), a tenth grabbing plate (571) is vertically installed on the sixth sliding rail (583), a sixth gripper (559) is arranged on the tenth grabbing plate (571), the tenth grabbing plate (571) slides on the sixth sliding rail (583), a nineteenth limiting switch (579) and a twenty-limiting switch (581) are installed on the lower portion of the third bearing plate (558), and a plug (261) is installed on the eleventh side face (550); an eleventh holding plate (566) is vertically mounted on the eleventh side surface (550), and a seventh gripper (567) is arranged on the eleventh holding plate (566); a twelfth grasping plate (551) is vertically mounted on the eleventh side surface (550), an eighth gripper (552), a fifth gripper (570), a sixth gripper (559), a seventh gripper (567), and an eighth gripper (552) are provided on the twelfth gripping plate (551) to be semicircular, so as to facilitate fixing the captured battery box (35); a second fixing frame (563) is mounted outside the ninth side surface (565); a sixth motor (562) and a third output shaft (561) of the sixth motor (562) are mounted on the second fixing frame (563); and the third output shaft (561) passes through the second fixing frame (563) and is connected to the third rotating rod (580) by means of the coupling, a third screw rod section (577) is mounted on the third rotating rod (580), a third nut (578) is sleeved on the third screw rod section (577), a third connecting rod (576) is mounted on the third nut (578), the third connecting rod (576) is connected with the ninth holding plate (569) and the tenth holding plate (571), the third programmable logic controller (597) is connected with the nineteenth limiting switch (579) and the second ten limiting switch (581), the sixth motor (562) is connected with the nineteenth limiting switch (579) and the second ten limiting switch (581), and the sixth motor (562) is connected with the third programmable logic controller (597).

16. the invention discloses a supply system of a service base electric energy supply and supplied vehicle through an internet of things architecture according to claim 1, and is characterized in that: a third working point (586) and a fourth working point (584) of the first working area (593), a second working point (592) of the first working area (593), and a sixth working point (596) of the fourth working area (594) the third processor (622) generates, by means of the third memory (624) and the video image information received by the monitoring device (626), digital panoramic image navigation information in a preset area, and sets a first path (585), a second path (587), a third path (589) and a fourth path (595) as navigation routes, is stored in the action program storage system (625) and is sent to the third wireless programmable logic controller (433); the signal pre-processor (449) receives the digital panoramic image navigation information in the preset area generated by the third processor (622); the electronic differential controller (450) receives the expected driving torque and the critical vehicle speed of the signal pre-processor (449) and the wheel speed signals of the first rotating speed sensor (451), the second rotating speed sensor (452), the third rotating speed sensor (453) and the fourth rotating speed sensor (454); and the electronic differential controller (450) sends a torque control target signal to the first motor controller (390), the second motor controller (391), the third motor controller (404) and the fourth motor controller (402).

17. According to the supply system of the service base electric energy supply and supplied vehicle passing through the internet of things architecture of claim 1, the second electric vehicle battery replacement control system (803) provided by the second electric vehicle (780) to be replaced is composed of a second electric vehicle communication system (814) as hereinafter referred to as a second communication system (814), a fourth programmable logic controller (695), a second battery box replacement control system (697), a second vehicle-mounted battery box replacement system (617) and a fourth leveling control system (696),
the third global navigation satellite system receiver (805) receives radio signals from the global navigation satellite system (24), the third global navigation satellite system receiver (805) can be configured for various GNSS systems, the third remote information processing unit (813) has a third cellular chipset (807), a third short-range wireless communication circuit (808), a third processor (809), a third memory (810), a third main antenna (811), and a third short-range wireless communication antenna (812) COMMUNICATION an antenna (812) and a third short-range wireless communication circuit (808) the third remote information processing unit (813) is configured to be capable of performing wireless communication according to a third short-range wireless communication circuit (808) the third processor (809) is any one of a microprocessor, a microcontroller, a main processor, a controller, a vehicle communication processor, and an application specific integrated circuit (ASIC) the fourth communication bus (804) is communicatively connected to a fourth programmable logic controller (695) mounted on the electric vehicle (41),
a seventh sliding rail front end fixing plate (672), an eighth sliding rail front end fixing plate (679), a seventh sliding rail (668) and an eighth sliding rail (684) are installed on a fourth main plate (692) of a second vehicle-mounted battery box replacement system (617) provided with a second battery box replacement control system (697), a third flange (691) is installed on the fourth bearing plate (683), a fourth flange (703) is installed on the second supporting plate (699), a third flange (691) and a fourth flange (703) are connected through a fourth screw (701), and a seventh hollow groove (665) and an eighth hollow groove (674) are formed in the fourth main plate (692), a thirteenth grabbing plate (667) is vertically installed on the seventh sliding rail (668), a ninth gripper (693) is arranged on the thirteenth grabbing plate (667), a thirteenth grabbing plate (667) slides on the seventh sliding rail (668), a fourteenth grabbing plate (685) is vertically installed on the eighth sliding rail (684), a tenth gripper (663) is arranged on the fourteenth grabbing plate (685), the fourteenth grabbing plate (685) slides on the eighth sliding rail (684), a twenty-first limiting switch (680) and a twenty-second limiting switch (681) are installed on the lower portion of the fourth bearing plate (683), and a plug (261) is installed on the fifteenth side face (664); a fifteenth holding plate (669) is vertically mounted on the fifteenth side surface (664), and an eleventh gripper (670) is arranged on the fifteenth holding plate (669); a twelfth gripper (682), a ninth gripper (693), a tenth gripper (663), an eleventh gripper (670), and a twelfth gripper (682) are vertically mounted on a fifteenth side (664); a twelfth gripper (682), a ninth gripper (693), a tenth gripper (663), an eleventh gripper (670), and a twelfth gripper (682) are semicircular; a seventh motor (688) and a fourth output shaft (687) of the seventh motor (688) are mounted on the third fixing frame (690); a fourth lead screw section (675) is mounted on the fourth rotating rod (678); and a sixth nut (676) is sleeved on the fourth lead screw section (675), a fourth connecting rod (677) is mounted on the sixth nut (676), the fourth connecting rod (677) is connected to the thirteenth grabbing plate (667) and the fourteenth grabbing plate (685), a driving motor (607) is mounted in a rear bin of the second electric vehicle (780) to be replaced, the driving motor (607) is connected to the plug (261), a fourth programmable logic controller (695) of the second battery box replacement control system (697) is connected to the twenty-first limiting switch (680) and the twenty-second limiting switch (681), the twenty-first limiting switch (680) and the twenty-second limiting switch (681) are connected to the seventh motor (688), the seventh motor (688) is connected to the fourth programmable logic controller (695),
the second battery box lifting system (700) controlled by the fourth leveling control system (696) is composed of a plurality of first double-acting multi-stage hydraulic cylinders (431) mounted on four corners of a third bottom plate (707) In the embodiment, the first double-acting multi-stage hydraulic cylinder (431) is four, that is, the fifth jacking column (706), the sixth jacking column (713), the seventh jacking column (705) and the eighth jacking column (712) are all composed of a fourth leveling control system (696), the fourth leveling control system (696) is composed of a second leveling control system (432) and a first double-acting multi-stage hydraulic cylinder (431), a sixth jacking column (713), a seventh jacking column (705) and an eighth jacking column (712); the second leveling control system (432) is provided with a second hydraulic pressure sensor (429), a second position sensor (408), a second length measuring sensor (419), a second microwave distance measuring sensor (420), a third inclination sensor (399), a fourth inclination sensor (400), a fifth hydraulic servo controller (440), a sixth hydraulic servo controller (443), a seventh hydraulic servo controller (445) and an eighth hydraulic servo controller (447) are respectively connected with the third wireless programmable logic controller (433) through data lines, and the fifth hydraulic servo controller (440) is connected with the fifth hydraulic valve group (441) through a data line; the sixth hydraulic servo controller (443) is connected to the sixth hydraulic valve group (444) by means of a data line; the seventh hydraulic servo controller (445) is connected to the seventh hydraulic valve group (446) by means of a data line; and the eighth hydraulic servo controller (447) is connected to the eighth hydraulic valve group (448) by means of a data line.

18. According to the supply system of the service base electric energy supply and supplied vehicle passing through the internet of things architecture according to claim 1, the method is characterized in that: a second transport robot control system (753) has a second transport robot leveling control system (751), a second obstacle avoidance system (769), a second magnetic navigation system (775), a second travel mechanism control system (774), a second visual navigation system (776), and a second terminal platform rotation control system (778) The second transport robot system (743) has a second transport robot travel system (747) and a second transport robot lift system (746) COMMUNICATION An antenna (53) is connected to the wireless communication unit (343) by means of a second antenna (355) of the second carrying robot (79), the intelligent battery swapping communication system (57) outputs the received sensor signals to a data acquisition device (621), the data acquisition device (621) stores the acquired sensor signals in a third memory (624), the motion control system (629) outputs a driving instruction to a fourth wireless programmable logic controller (752) by means of a remote control system (2) according to a pre-generated action program, and the fourth wireless programmable logic controller (752) controls the second carrying robot (79) to execute each program,
a sixth screw (720) passes through the mounting hole 721, a fourth bottom plate (726) is fixed on the second carrying robot chassis (744), a fourth wireless programmable logic controller (752), a second signal pre-processor (770), a second electronic differential controller (771), a fifth motor controller (735), a sixth driving motor (736), a sixth rotating speed sensor (773), a second battery charging port (742), a second battery (737) and a second starting switch (768) are mounted on the lower portion of the second supporting plate (784), a twelfth motor (745) and a second rotating shaft (748) are mounted on the second supporting plate (784), and a second terminal platform (718) is mounted on the second rotating shaft (748), a fifth camera (728), a sixth camera (732), a second ultrasonic ranging sensor (729), a second laser ranging sensor (730), a second magnetic navigation sensor (731), a second wire inlet/outlet 759, and a sixteenth QR code 714 are mounted on the second terminal platform (718); a twenty-third limiting switch (749) and a twenty-fourth limiting switch (750) are mounted on the second support plate (784); the fourth wireless programmable logic controller (752) is connected to the second signal pre-processor (770); the second signal pre-processor (770) is connected to the second electronic differential controller (771); the second electronic differential controller (771) is connected to the fifth motor controller (734) and the sixth motor controller (735); and the fifth driving motor (733) is connected to and controlled by the fifth motor controller (734); the fifth driving motor (733) is connected to and directly driven by the fifth wheel 738, the sixth driving motor (736) is connected to and directly driven by the sixth wheel 740, the seventh wheel 739 and the eighth wheel 741 are driven wheels, the second battery (737) is connected to the fourth wireless programmable logic controller (752) by means of the second starting switch (768), the second starting switch (768) controls the second battery (737) to be on and off, and the second battery charging port (742) is connected to the second battery (737),
the second obstacle avoidance system (769) is provided with a second ultrasonic ranging sensor (729) and a second laser ranging sensor (730), The second ultrasonic ranging sensor (729) is divided into two total eight ultrasonic probes, The RS485 communication unit (350) is connected to the fourth wireless programmable logic controller (752), the second laser ranging sensor (730) is connected in series to a CAN communication unit (352) of the fourth wireless programmable logic controller (752) by means of four sensors; the second image sensor (777) is electrically connected to the fourth wireless programmable logic controller (752), the second magnetic navigation sensor (731) of the second magnetic navigation system (775) is electrically connected to the fourth wireless programmable logic controller (752), the fourth wireless programmable logic controller (752) is connected to the twenty-third limiting switch (749) and the twenty-fourth limiting switch (750), the twenty-third limiting switch (749) is connected to the twenty-fourth limiting switch (750), and the twelfth motor (745) is connected to the fourth wireless programmable logic controller (752),
the second carrying robot lifting system (746) controlled by the second carrying robot leveling control system (751) is composed of a plurality of second double-acting multi-stage hydraulic cylinder systems (758) mounted at four corners of a fourth bottom plate (726), In the embodiment, the second double-acting multi-stage hydraulic cylinder system (758) is composed of four second carrying robot leveling control systems (751) and second double-acting multi-stage hydraulic cylinder systems (758), the structure of the second double-acting multi-stage hydraulic cylinder system (758) is the same as that of the first double-acting multi-stage hydraulic cylinder (431), and in the fifth jacking column (721) and the sixth jacking column (722), a second support plate (784) is mounted at the top of the seventh jacking column (724) and the top of the eighth jacking column (725), the second support plate (784) is of a concave structure, so that the first carrying robot (77) can conveniently enter the second support plate (784) from the inlet and outlet 717, the second carrying robot leveling control system (751) has a third hydraulic pressure sensor (754), a third position sensor (783), a sixth inclination sensor (719), a ninth hydraulic servo controller (760) and a tenth hydraulic servo controller (762), the eleventh hydraulic servo controller (764) and the twelfth hydraulic servo controller (766) are respectively connected to the fourth wireless programmable logic controller (752) by means of data lines, and the ninth hydraulic servo controller (760) is connected to the ninth hydraulic valve group (761) by means of a data line; and the tenth hydraulic servo controller (762) is connected to the tenth hydraulic valve group (763) by means of a data line; and the eleventh hydraulic servo controller (764) is connected to the eleventh hydraulic valve group (765) by means of a data line; a twelfth hydraulic servo controller (766) is connected to a twelfth hydraulic valve group (767) by means of a data line; a third hydraulic pressure sensor (754) is mounted on a second base (779) at the bottom end of the support column; data of the stress condition of the pillar oil cylinder is fed back to a fourth wireless programmable logic controller (752); a third position sensor (755) is mounted on a second base (779) at the bottom end of the support column; a complete retraction state of the support column oil cylinder is detected and data is fed back to the fourth wireless programmable logic controller (752); and a fourth length measurement sensor (756) is mounted at the top of the support column oil cylinder, and feeds back the telescopic speed and position data of the strut cylinder to a fourth wireless programmable logic controller (752); the third microwave ranging sensor (757) is mounted at the top of the hydraulic strut and is used for detecting the distance from the strut to the bottom end of the strut and feeding back the data to the fourth wireless programmable logic controller (752); and the fifth tilt sensor (783) and the sixth tilt sensor (719) are mounted on two sides of the second support plate (784) and are used for detecting tilt data of the second support plate (784) in the X-axis direction and the Y-axis direction.

19. According to the supply system of the service base electric energy supply and supplied vehicle passing through the internet of things architecture of claim 1, the method is characterized in that: a protective plate rotating system (797) is added to a side vehicle body (801) of an electric vehicle (41) to be subjected to battery replacement to form a third electric vehicle to be replaced (802) in the third embodiment of the present application a rotating shaft (791) of the protective plate rotating system (797) passes through a first fixing block (792) and a second fixing block (793) fixed on the side vehicle body (801); a protective plate (787) and a first gear (794) are mounted on the rotating shaft (791); a fixing frame (790) is mounted on the side vehicle body (801); a thirteenth motor (789) is mounted on the fixing frame (790); a second gear (788), a second gear (788) and a first gear (794) are mounted on the thirteenth motor (789) rotating shaft, a third programmable logic controller (597) of the guard plate rotation control system (798) is connected to the twenty-fifth limit switch (795) and the twenty-sixth limit switch (796), The thirteenth motor (789) drives the second gear (788) to rotate, the second gear (788) drives the first gear (794) to rotate, The first gear (794) drives the rotation shaft (791) to rotate, the rotation shaft (791) drives the guard plate (787) to rotate by 90 degrees to expose the battery box replacement control system (598).

20. The supply system of the service base electric energy supply and supplied vehicle passing through the Internet of things architecture according to claim 1 is characterized in that:
Step 1, a remote operator (7) activates an intelligent battery replacement control system (45), the intelligent battery replacement vehicle (30) reaches the optimal battery replacement parking position of the electric vehicle (41) to be subjected to battery replacement, the remote operator (7) controls the intelligent battery replacement vehicle (30) and the electric vehicle (41) to be subjected to battery replacement by means of the remote operation platform system (13), and the remote operator (7) starts a pre-generated action program to unfold the battery replacement box (35) of the electric vehicle (41) to be subjected to battery replacement,
step 2: the second rotation control system (601) starts the eighth motor (489) to drive the second support leg (490) to rotate, the third rotation control system (602) starts the ninth motor (501) to drive the third support leg (502) to rotate, and the fourth rotation control system (603) starts the tenth motor (509) to drive the fourth support leg (515) to rotate, so that the first support leg (475), the second support leg (490), the third support leg (502) and the fourth support leg (515) rotate to the ground at the same time to a preset position,
step 3: the remote operator (7) issues a control signal to the fifth hydraulic servo controller (608), the sixth hydraulic servo controller (610), the seventh hydraulic servo controller (612), and the eighth hydraulic servo controller (614) by means of the remote control system (2), and sends a control signal to the fifth hydraulic servo controller (608), the sixth hydraulic servo controller (610), the seventh hydraulic servo controller (612), and the eighth hydraulic servo controller (614) at the same time by means of the remote control system (2); and the fifth hydraulic servo controller (608) controls the fifth hydraulic valve group (609) to act according to the control signal, so as to control the second double-acting multi-stage hydraulic cylinder (543) of the first telescopic leg (482) to complete the telescopic action to a designated position, and the sixth hydraulic servo controller (610) controls the sixth hydraulic valve group (611) to act according to the control signal, so as to control a second double-acting multi-stage hydraulic cylinder (543) of a second telescopic leg (494) to complete a telescopic action to a designated position; a seventh hydraulic servo controller (612) controls, according to the control signal, a seventh hydraulic valve group (613) to act, so as to control a second double-acting multi-stage hydraulic cylinder (543) of the third telescopic leg (508) to complete a telescopic action to a designated position; and an eighth hydraulic servo controller (614) controls, according to the control signal, the eighth hydraulic valve group (615) to move to a designated position:the action instruction of the third leveling control system (616) is issued by the remote operator (7) through the remote console system (13), and is uploaded to the third programmable logic controller (597) through the remote control system (2) to start leveling operation, the third leveling control system (616) controls the extension length of the strut oil cylinder according to the calculated distance from the strut to the ground, and the third length measurement sensor (533) correspondingly detects and detects the extension length value of the strut oil cylinder until the strut cylinder second hydraulic pressure sensor (528) detects that the strut cylinder pressure reaches a preset value, Meanwhile, the third tilt sensor (495) and the fourth tilt sensor (496) are read to respectively detect the inclination state of the electric vehicle chassis (497) in the X-axis direction and the Y-axis direction, and the third leveling control system (616) calculates the inclination state of the electric vehicle chassis (497) according to the preset model according to the feedback information of each sensor, gives a leveling control scheme according to the system setting, and controls each support column to complete automatic leveling according to the leveling control scheme,
step 4: A selection system (627) sets the target position of the robot (78) according to the position coordinates of the target first transfer robot 77, The motion control system (629) supplies the action instruction of the robot slider system 83 to the first programmable logic controller 188 of the robot slider control system 226 according to a pre-generated action program, The robot slider system 83 configures the robot (78) in the second operation position 71, The motion control system (629) sends the action program instruction for driving the robot (78) to the robot driving system 630 according to a pre-generated action program,
step 5: the first programmable logic controller (188) controls the first motor (298) to drive the third threaded screw rod section (295) to rotate forwards, the fifth nut (300) drives the first supporting rod (143) to move towards the first limiting switch (294), the rear vehicle door upper section (130) starts to open, the fifth nut (300) moves to the position of the first limiting switch (294), the first limiting switch (294) is triggered, the first motor (298) stops working, and the rear vehicle doorupper section (130) is opened to a predetermined position,
step 6: the action control system (629) sends an action instruction for driving the video sensor (631) to the video sensor (631) according to a pre-generated action program, and the action control system (629) pre-generates an image definition automatic light supplementing program according to the remote operator (7), and sends an action instruction for driving the light supplementing lamp (127) to supplement light to the light supplementing lamp (127) to supplement light to the image acquisition area of the video sensor (631),
step 7: the acquisition system (628) generates three-dimensional information of the first transfer robot (77) according to the distance from the vision sensor (631) to a fourteenth QR code (338) at the front of the first transfer robot (77) The acquisition system (628) calculates the distance from the vision sensor (631) to the fourteenth QR code (338) according to the parallax of the two images captured by the first camera (122) and the second camera (126),
step 8: the selection system (627) selects a selection process of the first transfer robot (77) taken out by the robot (78) according to the three-dimensional information of the first transfer robot (77), and the selection system (627) selects the first transfer robot according to the position and posture of the first transfer robot (77)),
step 9: The action control system (629) sends an action instruction for driving the first pressure sensor (222) and the second pressure sensor (247) to a second programmable logic controller (224) of the manipulator control system (225) according to a pre-generated action program, and the second programmable logic controller (224) supplies power to the first pressure sensor (222) and the second pressure sensor (247),
step 10: after the robot (78) adjusts the posture, a finger part (124) of the manipulator (200) closes and holds the first carrying robot (77), the first pressure sensor (222) and the second pressure sensor (247), and transmits the pressure information to the second programmable logic controller (224); and the second programmable logic controller (224) compares the received pressure information with a preset information and then determines that the first carrying robot (77) has been grasped, the second programmable logic controller (224) closes the fourth motor (205), the first carrying robot (77) is taken out on the first bracket (80), and the manipulator (200) holds the first working point conveyed to the first operation area (593) by the first carrying robot (77)),
step 11: the monitoring device (626) ends the control after determining that the first transfer robot (77) predetermined by the remote operator (7) is taken out,
step 12: the action control system (629) issues a control instruction according to a pre-generated action program, so that the first carrying robot (77) visual navigation system (437) starts navigation, and the magnetic navigation system (435) is in a closed state After the visual navigation system (437) fails, the third processor (622) collects a second two-dimensional code (455) of the electric vehicle (41) to be subjected to battery replacement as a starting position, and sets a thirteenth two-dimensional code (469) of the battery box (35) to be a second position, and controls the first carrying robot (77) to travel forwards from the starting position to the position directly below the second position,
step 13: the third wireless programmable logic controller (433) supplies power to the eleventh motor (549); the eleventh motor (549) drives the terminal platform (381) to rotate to the twenty-first limit switch (548); the eleventh motor (549) stops rotating; and the third camera (394) and the fourth camera (398) on the terminal platform (381) are aligned with a thirteenth two-dimensional code (469) at the bottom of the power-deficient battery box (35) of the vehicle-mounted battery box replacement system (564) for shooting, the acquisition system (628) calculates the distance from the third camera (394) and the fourth camera (398) to the thirteenth two-dimensional code (469) according to the parallax of the two images captured by the third camera (394) and the fourth camera (398), generates three-dimensional information of the power-deficient battery box (35), and the acquisition system (628) calculates the distance from the third camera (394) and the fourth camera (398) to a thirteenth two-dimensional code (469) at the bottom of the battery box (35) according to the parallax of the two images captured by the third camera (394) and the fourth camera (398), and ejects the battery tray (380) at a preset position below the battery box (35),
step 14: the third wireless programmable logic controller (433) sends a control signal to the fifth hydraulic servo controller (440), the sixth hydraulic servo controller (443), the seventh hydraulic servo controller (445) and the eighth hydraulic servo controller (447) according to the data fed back by the sensor, the sixth hydraulic servo controller (443), the seventh hydraulic servo controller (445) and the eighth hydraulic servo controller (447), and the fifth hydraulic servo controller (440) controls the fifth hydraulic valve group (441) to act according to the control signal, thereby controlling the first double-acting multi-stage hydraulic cylinder (431) of the first support column to complete the telescopic action to a specified position; and the sixth hydraulic servo controller (443) controls the sixth hydraulic valve group (444) to act according to the control signal, so as to control the first double-acting multi-stage hydraulic cylinder (431) of the second support column to complete the telescopic action to a specified position; and the seventh hydraulic servo controller (445) controls the seventh hydraulic valve (446) to act according to the control signal, so as to control the first double-acting multi-stage hydraulic cylinder (431) of the third support column to complete the telescopic action to a specified position; the eighth hydraulic servo controller (447) controls the eighth hydraulic valve group (448) to act according to the control signal, so as to control the first double-acting multi-stage hydraulic cylinder (431) of the fourth supporting column to complete the telescopic action to a designated position; after the first supporting column (383), the second supporting column (376), the third supporting column (387) and the fourth supporting column (373) all reach a designated position, the first supporting column (383), the second supporting column (376), the third supporting column (387) and the fourth supporting column (373) are issued through the remote operation table system (13), and are uploaded to the third wireless programmable logic controller (433) through the remote control system (2) to start leveling operation, the system re-reads each second microwave distance measurement sensor (420) and the second length measurement sensor (419) to correspondingly detect the inclination state of the support column oil cylinder, and simultaneously reads the third inclination sensor (399) and the fourth inclination sensor (400) to respectively detect the inclination state of the carrying robot chassis (384) in the X-axis direction and the Y-axis direction; and the system calculates the inclination state of the carrying robot chassis (384) according to the information fed back by each sensor, gives a leveling control scheme according to the system setting, controls each supporting column to complete automatic leveling according to the leveling control scheme, and jacks the battery tray (380) at a preset preparation position for replacing the battery box (35),
step 15: the third output shaft (561) of the sixth motor (562) drives the third connecting rod (576) to move, the third connecting rod (576) drives the ninth grabbing plate (569) and the tenth grabbing plate (571) to move towards the twenty-limiting switch (581), the third connecting rod (576) triggers the second ten-limiting switch (581) to enable the sixth motor (562) to stop rotating, the ninth grabbing plate (569) and the tenth grabbing plate (571) are separated from the battery box (35), and the battery box (35) falls to the top of the first carrying robot (77),
step 16: at the end of the operation of the robot (78) in the second operation region (588), the action control system (629) issues a control instruction according to a pre-generated action program, so that the first carrying robot (77) visual navigation system (437) starts navigation, the visual navigation system (437) collects a ninth two-dimensional code (464) of the electric vehicle (41) as a starting position, the sixth two-dimensional code (461) is a second position, and controls the first carrying robot (77) to start forward from the starting position to the second position,
step 17: the third wireless programmable logic controller (433) supplies power to the eleventh motor (549); the eleventh motor (549) drives the terminal platform (381) to rotate towards the nineteenth limiting switch (547); the eleventh motor (549) drives the terminal platform (381) to rotate towards the nineteenth limiting switch (547); the action control system (629) issues a control instruction according to a pre-generated action program to enable the first carrying robot (77) to start navigation; and the first carrying robot (77) travels to a first working point of the first operation area (593) according to a predetermined second path (585)),
step 18: the acquisition system (628) generates three-dimensional information of the battery box (35) at the top of the first transfer robot (77) according to the distance from the vision sensor (631) to the eleventh QR code (467) mounted on the top of the battery box (35) The acquisition system (628) calculates the distance from the vision sensor (631) to the second measurement point according to the parallax of the two images captured by the first camera (122) and the second camera (126),
step 19: after the robot (78) adjusts the posture, the action control system (629) sends an action instruction of the driving manipulator (200) to a second programmable logic controller (224) of the manipulator control system (225) according to a pre-generated action program, the second programmable logic controller (224) supplies power to the fourth motor (205) according to the action instruction, the second programmable logic controller (224) starts the fourth motor (205), a first output shaft (204) of the fourth motor (205) drives the first screw rod section (218) to rotate in the forward direction, and the first screw rod section (218) pushes the first connecting rod (215) to drive the first grabbing plate (201) and the second grabbing plate (209) to move towards the battery box (35), the first connecting rod (215) runs to the position of the seventh limiting switch (219), the seventh limiting switch (219) is triggered to enable the fourth motor (205) to stop rotating, the first grabbing plate (201) and the second grabbing plate (209) clamp the battery box (35), the battery box (35) is clamped, the battery box (35) is taken away from the top of the first carrying robot (77), the manipulator (200) holds the battery box (35) to be conveyed to a predetermined position, and the battery box (35) does not fall off from the manipulator (200) during the conveying of the battery box (35),
step 20: the acquisition system (628) generates three-dimensional information of the first charging and swapping cabinet (72) according to the distance from the vision sensor (631) to the vacant first battery compartment (305) The acquisition system (628) calculates the distance from the vision sensor (631) to the vacant first battery compartment (305) according to the parallax of the two images captured by the first camera (122) and the second camera (126),
step 21: a selection system (627) implements a selection process for placing a battery box (35) into a target first battery compartment (305) by means of a robot (78) according to three-dimensional information of the first charging and swapping cabinet (72), and the selection system (627) selects a vacant battery compartment from high to low according to the position and posture of the first charging and swapping cabinet (72),
step 22: after the robot (78) adjusts the posture, the fingers (124) of the manipulator (200) close and hold the battery box (35), and the manipulator (200) holds the battery box (35) and conveys same into the vacant first battery compartment (305) of the first charging and swapping cabinet (72),
step 23: the first programmable logic controller (188) supplies power to the fifth motor (235) according to the action instruction, the second nut (254) drives the second connecting rod (255) to move in the direction of the battery box (35), the second connecting rod (255) drives the fifth clamping plate (241) and the sixth grabbing plate (231) to move in the direction of the battery box (35), the second connecting rod (255) runs to the ninth limiting switch (252), the ninth limiting switch (252) is triggered to enable the fifth motor (235) to stop rotating, and the fifth grabbing plate (241) and the sixth grabbing plate (231) close and clamp the battery box towards the seventh grabbing plate (245) and the eighth grabbing plate (228)),
step 24: the action control system (629) sends an action instruction of the driving manipulator (200) to a second programmable logic controller (224) of the manipulator control system (225) according to a pre-generated action program, the second programmable logic controller (224) starts the fourth motor (205), the first output shaft (204) of the fourth motor (205) drives the first screw rod section (218) to rotate, the first screw rod section (218) drives the first connecting rod (215) to move, the first connecting rod (215) drives the first grabbing plate (201) and the second grabbing plate (209) to move in the direction of the eighth limiting switch (206), the first connecting rod (215) triggers the eighth limiting switch (206), the fourth motor (205) stops rotating, and the first grabbing plate (201) and the second grabbing plate (209) are separated from the battery box),
step 25: the monitoring device (626) ends the control after determining that the battery box (35) predetermined by the remote operator (7) is placed in the first battery compartment (305) of the first battery charging and swapping cabinet (72),
step 26: the selection system (627) sets the target position of the robot (78) according to the position and posture of the target battery box (35), and the motion control system (629) causes the robot slider system (83) to drive the robot (78) to travel to the second operation position (71),
step 27: the acquisition system (628) generates three-dimensional information of the first charging and swapping cabinet (72) according to the distance from the vision sensor (631) to the first charging and swapping cabinet (72) and the first measurement point of the fully charged battery box (35) the acquisition system (628) calculates the distance from the vision sensor (631) to the first measurement point according to the parallax of the two images captured by the first camera (122) and the second camera (126),
step 28: the selection system (627) implements a selection process of selecting the battery box (35) in the target second battery compartment (307) taken out by the robot (78) according to the three-dimensional information of the first charging and swapping cabinet (72), and the selection system (627) selects a fully charged battery box from the second battery compartment (307) to the sixth battery compartment (315) according to the position and posture of the first charging and swapping cabinet (72), the order from high to low, and the QR code of each battery compartment),
step 29: after the robot (78) is aligned with the fully charged battery box (35) in the second battery compartment (307) to adjust the posture, the finger portion (124) of the manipulator (200) closes and holds the battery box (35),
step 30: the first programmable logic controller (188) supplies power to the fifth motor (235) according to the action instruction; the first programmable logic controller (188) starts the fifth motor (235); the second output shaft (234) of the fifth motor (235) drives the second screw rod section (253) to rotate; the second nut (254) drives the second connecting rod (255) to move; the second connecting rod (255) drives the fifth grabbing plate (241) and the sixth grabbing plate (231) to move towards the tenth limiting switch (257); the second connecting rod (255) triggers the tenth limiting switch (257); the fifth motor (235) stops rotating; and the fifth grabbing plate (241) and the sixth grabbing plate (231) are separated from the battery box),
step 31: the manipulator (200) takes out the battery box (35) in the second battery compartment (307), and the manipulator (200) holds the battery box),
step 32: the acquisition system (628) generates three-dimensional information of the battery box (35) at the top of the first transport robot (77) according to the distance from the visual sensor (631) to the fifteenth QR code (663) mounted on the battery tray (380) as the fourth measurement point The acquisition system (628) calculates the distance from the vision sensor (631) to the fourth measurement point according to the parallax of the two images captured by the first camera (122) and the second camera (126),
step 33: after the robot (78) adjusts the posture, the finger part (124) of the manipulator (200) closes and holds the battery box (35), the battery box (35) is put down on the top battery tray (380) of the first carrying robot (77), and the finger part (124) of the manipulator (200) is opened,
step 34: the monitoring device (626) ends the control after determining that the battery box (35) predetermined by the remote operator (7) is placed on the top of the first transfer robot (77),
step 35: when the battery box (35) in the second battery charging and replacing cabinet (75) is taken out and placed, the action control system (629) enables the robot slider system (83) to drive the robot (78) to travel to the first operation position),
step 36: repeating the actions from step 4 to step 34,
step 37: after the operation of the robot (78) in the first operation area (593) ends, the action control system (629) issues a control instruction according to a pre-generated action program, so that the first carrying robot (77) visual navigation system (437) starts navigation, and after the first carrying robot (77) travels to a third working point (586) of the second operation area (588) according to a predetermined second path (587), the visual navigation system (437) collects a ninth two-dimensional code (464) in the middle of the bottom of the electric vehicle chassis (497) as a second position,
step 38: the action control system (629) sends an action instruction of the driving terminal platform rotation control system (438) to a third wireless programmable logic controller (433) of the terminal platform rotation control system (438) according to a pre-generated action program, the third wireless programmable logic controller (433) supplies power to the eleventh motor (549), the eleventh motor (549) drives the terminal platform rotation control system (438) to rotate to the twenty-first limit switch (548), the second ten limit switch (548) is triggered, the eleventh motor (549) stops rotating, and the third camera (394) and the fourth camera (398) on the terminal platform (381) are aligned with a ninth two-dimensional code (464) in the middle of the bottom of the vehicle-mounted battery box replacement system (564) for shooting, the acquisition system (628) calculates the distance from the third camera (394) and the fourth camera (398) to the ninth two-dimensional code (464) according to the parallax of the two images captured by the third camera (394) and the fourth camera (398), and generates three-dimensional information of the vehicle-mounted battery box replacement system (564) the acquisition system (628) calculates the distance from the third camera (394) and the fourth camera (398) to a ninth two-dimensional code (464) at the bottom of the battery box (35) according to the parallax of the two images captured by the third camera (394) and the fourth camera (398), and ejects the battery box (35) at the upper part of the battery tray (380) below the preset position of the vehicle-mounted battery box replacement system (564),
step 39: a second leveling control system (432), completing automatic leveling according to the leveling control scheme, and jacking the battery tray (380) at a preset preparation position for replacing the battery box (35),
step 40: the action control system (629) sends an action instruction for driving the battery box replacement control system (598) to a third programmable logic controller (597) of the battery box replacement control system (598) according to a pre-generated action program, the third programmable logic controller (597) supplies power to the sixth motor (562) according to the action instruction, the third output shaft (561) of the sixth motor (562) drives the third screw rod section (577) to rotate in the forward direction, and the third screw rod section (577) drives the third connecting rod (576) to move towards the battery box (35), the third connecting rod (576) drives the ninth grabbing plate (569) and the tenth grabbing plate (571) to move towards the battery box (35), the third connecting rod (576) runs to the nineteenth limiting switch (579), the nineteenth limiting switch (579) is triggered to enable the sixth motor (562) to stop rotating, the ninth grabbing plate (569) and the tenth grabbing plate (571) are closed towards the eleventh grabbing plate (566) and the twelfth grabbing plate (551), the ninth grabbing plate (569) and the tenth grabbing plate (571) clamp the battery box (35),
step 41: the monitoring device (626) determines that the step is ended after the battery box (35) predetermined by the remote operator (7) is sent out, and the second leveling control system (432) returns to the original state,
step 42: At the end of the operation of the robot (78) in the second operation area (588), the action control system (629) issues a control instruction according to a pre-generated action program, so that the first carrying robot (77) visual navigation system (437) starts navigation, the visual navigation system (437) collects a thirteenth two-dimensional code (469) at the bottom of a battery box (35) of the electric vehicle (41) to be subjected to battery replacement as a starting position, and the sixth two-dimensional code 461 is a second position, and controls the first carrying robot (77) to start forward from the starting position to the second position,
step 43: repeating the actions of step 17,
step 44: after the robot (78) adjusts the posture, the finger portion (124) of the manipulator (200) closes and holds the first carrying robot (77),
step 45: the acquisition system (628) generates three-dimensional information of the first support (80) according to the distance from the visual sensor (631) to a fifteenth two-dimensional code (657) on the top of the first support (80), the acquisition system (628) calculates the distance from the visual sensor (631) to the first support (80) according to the parallax of the two images captured by the first camera (122) and the second camera (126),
step 46: the selection system (627) implements the selection process of the first transfer robot (77) placed by the robot (78) according to the three-dimensional information of the first transfer robot (77), the selection system (627) selects the first transfer robot (77) according to the position and posture of the first transfer robot (77), the manipulator (200) holds the first transfer robot (77) and conveys the first transfer robot (77) to the first support (80), and the first support charging port 658 is connected to the transfer robot charging port 662,
step 47: the first programmable logic controller (188) controls the first motor (298) to drive the third threaded screw rod section (295) to rotate reversely, the fifth nut (300) drives the first supporting rod (143) to move towards the fifth support (297), the rear vehicle door upper section (130) starts to be closed, the fifth nut (300) triggers the second limiting switch (296), the first motor (298) stops working, and the rear vehicle door upper section (130) is closed,
step 48: the monitoring device (626) ends the control after determining that the first bracket (80) puts the robot (78) predetermined by the remote operator (7),
step 49: the intelligent battery replacing vehicle (30) navigates to the optimal operation position near the third charging and replacing cabinet (31) according to the position coordinates of the third charging and replacing cabinet (31),
step 50: the acquisition system (628) generates three-dimensional information of the third charging and swapping cabinet (31) according to the distance from the vision sensor (631) to the first measurement point of the battery box (35) in the third charging and swapping cabinet (31) the acquisition system (628) calculates the distance from the vision sensor (631) to the first measurement point according to the parallax of the two images captured by the first camera (122) and the second camera (126),
step 51: a selection system (627) implements a selection step of selecting a fully charged battery box (35) in a target thirteenth battery compartment (357) taken out by a robot (78) according to the three-dimensional information of the third charging and swapping cabinet (31), and the selection system (627) selects a fully charged battery box from the thirteenth battery compartment (357) to the sixteenth battery compartment (360) according to the position and posture of the third charging and swapping cabinet (31) from high to low),
step 52: the selection system (627) sets the target position of the robot (78) according to the position and posture of the target battery box (35), and the motion control system (629) enables the robot slider system (83) to drive the robot (78) to travel to the second operation position (71), and at this time, the finger (124) of the manipulator (200) is opened,
step 53: after the robot (78) adjusts the posture, the finger part (124) of the manipulator (200) closes and holds the battery box (35),
step 54: the action control system (629) sends, according to a pre-generated action program, an action instruction for driving a thirteenth battery compartment control system (653) to a second wireless programmable logic controller (361) of a thirteenth battery compartment control system (653);
the second wireless programmable logic controller (361) starts a fifth electric motor (235); a second output shaft (234) of the fifth electric motor (235) drives a second connecting rod (255) to move; the second connecting rod (255) drives the fifth grabbing plate (241) and the sixth grabbing plate (231) to move towards the tenth limiting switch (257); the second connecting rod (25) triggers the tenth limiting switch (257); the fifth motor (235) stops rotating; the fifth grabbing plate (241) and the sixth grabbing plate (231) are separated from the battery box (35),
step 55: the manipulator (200) takes out the battery box (35) in the thirteenth battery compartment (357), the manipulator (200) holds the battery box (35),
step 56: the acquisition system (628) generates three-dimensional information of the first charging and swapping cabinet (72) according to the distance from the vision sensor (631) to the vacant first battery compartment (305) The acquisition system (628) calculates the distance from the vision sensor (631) to the first battery compartment (305) according to the parallax of the two images captured by the first camera (122) and the second camera (126),
step 57: the selection system (627) implements a selection process for placing the battery box (35) into the target first battery compartment (305) by means of the robot (78) according to the three-dimensional information of the first charging and swapping cabinet (72), and the selection system (627) selects a vacant battery compartment according to the position and posture of the first charging and swapping cabinet (72) from high to low,
step 58: after the robot (78) adjusts the posture, the fingers (124) of the manipulator (200) close and hold the battery box (35), and the manipulator (200) holds the battery box (35) and conveys the battery box (35) into a first battery compartment (305) of the first charging and swapping cabinet (72),
step 59: the first programmable logic controller (188) supplies power to the fifth motor (235) according to the action instruction, the second nut (254) drives the second connecting rod (255) to move in the direction of the battery box (35), the second connecting rod (255) triggers the ninth limiting switch (252) to enable the fifth motor (235) to stop rotating, and the fifth grabbing plate (241) and the sixth grabbing plate (231) close and clamp the battery box towards the seventh grabbing plate (245) and the eighth grabbing plate (228),
step 60: the monitoring device (626) ends the control after determining that the first battery compartment (305) of the first charging and swapping cabinet (72) is placed in a predetermined number of fully charged battery boxes (35) by a remote operator (7),
step 61: the selection system (627) sets the target position of the robot (78) according to the position coordinates of the target first transfer robot (77), and the motion control system (629) causes the robot slider system (83) to drive the robot (78) to travel to the second operation position (71), and at this time, the finger (124) of the manipulator (200) is opened,
step 62: the acquisition system (628) generates three-dimensional information of the first charging and swapping cabinet (72) on the basis of the distance from the vision sensor (631) to the first measurement point of the battery box (35) that is insufficient in the first charging and swapping cabinet (72) the acquisition system (628) calculates the distance from the vision sensor (631) to the first measurement point according to the parallax of the two images captured by the first camera (122) and the second camera (126),
step 63: an acquisition system (628) acquires three-dimensional information of a power-deficient battery box (35) in a first battery compartment (305) of the first charging and swapping cabinet (72) according to the output of the visual sensor (631) The acquisition system (628) generates three-dimensional information of the first charging and swapping cabinet (72) according to the distance from the visual sensor (631) to the power-deficient battery box (35) The acquisition system (628) calculates the distance from the visual sensor (631) to the power-deficient battery box (35) according to the parallax of the two images captured by the first camera (122) and the second camera (126),
step 64: the selection system (627) selects, according to the three-dimensional information of the first charging and replacing cabinet (72), a selection procedure for taking out the power-deficient battery box (35) by the robot (78), and the selection system (627) selects a power-deficient battery box from high to low and two-dimensional code information of the battery box (35) according to the position and posture of the first charging and replacing cabinet (72)),
step 65: after the robot (78) adjusts the posture, the finger part (124) of the manipulator (200) closes and holds the battery box),
step 66: the first programmable logic controller (188) starts the fifth motor (235), the second output shaft (234) of the fifth motor (235) drives the second screw rod section (253) to rotate reversely, the second nut (254) drives the second connecting rod (255) to move, the second connecting rod (255) drives the fifth grabbing plate (241) and the sixth grabbing plate (231) to move towards the tenth limiting switch (257), the second connecting rod (255) triggers the tenth limiting switch (257) to enable the fifth motor (235) to stop rotating, and the fifth grabbing plate (241) and the sixth grabbing plate (231) are separated from the battery box),
step 67, the manipulator (200) takes out the battery box (35) in the first battery box (305), the manipulator (200) holds the battery box (35), and after the robot (78) adjusts the posture, the finger (124) of the manipulator (200) closes and holds the battery box),
step 68: the acquisition system (628) generates three-dimensional information of the third charging and swapping cabinet (31) according to the distance from the vision sensor (631) to the vacant thirteenth battery compartment (357) the acquisition system (628) calculates the distance from the vision sensor (631) to the vacant thirteenth battery compartment (357) according to the parallax of the two images captured by the first camera (122) and the second camera (126),
step 69: the selection system (627) selects, according to the three-dimensional information of the third charging and swapping cabinet (31), a selection process for placing the battery box (35) into the target thirteenth battery compartment (357) by the robot (78), and the selection system (627) selects the vacant battery compartment from high to low according to the position and posture of the third charging and swapping cabinet (31),
step 70: after the robot (78) adjusts the posture, the fingers (124) of the manipulator (200) close and hold the battery box (35), and the manipulator (200) holds the battery box (35) and conveys the battery box (35) into a thirteenth battery compartment (357) of the third charging and swapping cabinet (31),
step 71: the action control system (629) sends, according to a pre-generated action program, an action instruction for driving a thirteenth battery compartment control system (653) to a second wireless programmable logic controller (361) of a thirteenth battery compartment control system (653); the second wireless programmable logic controller (361) starts a fifth electric motor (235); a second output shaft (234) of the fifth electric motor (235) drives the second lead screw section (253) to move in the direction; the second connecting rod (255) drives the fifth clamping plate (241) and the sixth clamping plate (231) to move towards the battery box (35); the second connecting rod (255) triggers the ninth limiting switch (252) to enable the fifth electric motor (235) to stop rotating; and the fifth clamping plate (241) and the sixth clamping plate (231) clamp the battery box (35),
step 72: repeating the actions of step 47,
step 73: the monitoring device (626) ends the control after determining the thirteenth battery compartment (357) of the third charging and swapping cabinet (31), after a predetermined number of power-deficient battery boxes (35) predetermined by the remote operator (7) are placed,
step 74: the first programmable logic controller (188) controls the second motor (168) to drive the threaded screw rod (169) to rotate in the forward direction, the first sliding door (132) and the second sliding door (133) move towards the two sides at the same time, the second sliding door (133) triggers the fourth limiting switch (180) to stop working, and the side door system (158) is opened,
step 75: the acquisition system (628) generates three-dimensional information of the first transfer robot (77) according to the distance from the vision sensor (631) to a fourteenth QR code (338) at the front of the first transfer robot (77) the acquisition system (628) calculates the distance from the vision sensor (631) to the fourteenth QR code (338) according to the parallax of the two images captured by the first camera (122) and the second camera (126),
step 76: the selection system (627) selects a selection process of the first transfer robot (77) taken out by the robot (78) according to the three-dimensional information of the first transfer robot (77), and the selection system (627) selects the first transfer robot according to the position and posture of the first transfer robot (77)),
step 77: repeating the actions of step 2, step 3 and step 4,
step 78: after the robot (78) adjusts the posture, the finger part (124) of the manipulator (200) closes and holds the first carrying robot (77), the first carrying robot (77) is taken out on the first bracket (80), and the manipulator (200) holds the second working point conveyed to the first operation area (593) by the first carrying robot (77)),
step 79: After the operation of the robot (78) in the first operation area (593) ends, the action control system (629) issues a control instruction according to a pre-generated action program, so that the first carrying robot (77) visual navigation system (437) starts navigation, and after the first carrying robot (77) travels to a sixth working point (596) of the fourth operation area (594), the visual navigation system (437) collects a first two-dimensional code (456) of the electric vehicle (41) to be subjected to battery replacement as a starting position, and the thirteenth two-dimensional code (469) set on the battery box (35) is a second position,
step 80: repeating the actions of step 13, step 14 and step 15,
step 81: in a sixth working point (596) of the fourth operation area (594), the action control system (629) issues a control instruction according to a pre-generated action program, so that the first carrying robot (77) visual navigation system (437) starts navigation, the visual navigation system (437) collects a ninth two-dimensional code (464) of the electric vehicle (41) to be subjected to battery replacement as a starting position, the fifth two-dimensional code 465 is a second position, controls the first carrying robot (77) to travel forwards from the starting position to the second position, and the first carrying robot (77) travels to a second working point of the first operation area (593) according to a predetermined fourth path (595)),
step 82: repeating the actions from step 16 to step 25,
step 83: the first programmable logic controller (188) controls the second motor (168) to drive the threaded screw rod (169) to rotate reversely, and when the first sliding door (132) and the second sliding door (133) move towards the center at the same time, the second motor (168) stops working when the second sliding door (133) moves to the position of the third limiting switch (176), and the side door system (158) is closed,
step 84: according to the position coordinates of the second electric vehicle (780) to be subjected to battery replacement, the intelligent battery replacement vehicle (30) navigates to the optimal operation position near the second electric vehicle to be replaced (780),
step 85: opening a front cabin cover plate (733) of the second electric vehicle to be subjected to battery replacement (780),
step 86: a control action instruction of a fourth leveling control system (696) is issued by a remote operator (7) by means of a remote console system (13), and is uploaded to a fourth programmable logic controller (695) by means of a remote control system (2); the fourth programmable logic controller (695) sends a control signal to complete a leveling action according to data fed back by the sensor and a preset action instruction; and the second vehicle-mounted battery box replacement system (617) abuts against a preset preparation position of the battery replacement box (35)),
step 87: the acquisition system (628) generates three-dimensional information of the second vehicle-mounted battery box replacement system (617) according to the distance from the visual sensor (631) to the first measurement point of the battery box (35) in the second vehicle-mounted battery box replacement system (617) the acquisition system (628) calculates the distance from the visual sensor (631) to the first measurement point according to the parallax of the two images captured by the first camera (122) and the second camera (126),
step 88: the selection system (627) implements a selection step of selecting the battery case (35) in the target second vehicle-mounted battery case replacement system (617) taken out by the robot (78) according to the three-dimensional information of the second vehicle-mounted battery case replacement system (617),
step 89: the selection system (627) sets the target position of the robot (78) according to the position and posture of the target battery box (35), and the motion control system (629) causes the robot slider system (83) to drive the robot (78) to travel to the second operation position (71), step 90: after the robot (78) adjusts the posture, the finger part (124) of the manipulator (200) closes and holds the battery box (35),
step 91: a fourth output shaft (687) of the seventh motor (688) drives the fourth lead screw section (675) to rotate, the fourth lead screw section (675) drives the sixth nut (676) to rotate, the sixth nut (676) drives the fourth connecting rod (677) to rotate, the fourth connecting rod (677) drives the thirteenth gripping plate (667) and the fourteenth gripping plate (685) to move in the direction of the twenty-second limiting switch (681), the fourth connecting rod (677) triggers the twenty-second limiting switch (681) to stop the seventh motor (688) from rotating, and the thirteenth gripping plate (667) and the fourteenth gripping plate (685) are separated from the battery box),
step 92, the manipulator (200) takes out the battery box (35) in the second vehicle-mounted battery box replacement system (617), the manipulator (200) holds the battery box (35),
step 93: repeating the actions from step 56 to step 60,
step 94: repeating the actions from step 26 to step 31,
step 95: the acquisition system (628) generates three-dimensional information of the second vehicle-mounted battery box replacement system (617) according to the distance from the visual sensor (631) to the vacant second vehicle-mounted battery box replacement system (617) the acquisition system (628) calculates the distance from the visual sensor (631) to the second vehicle-mounted battery box replacement system (617) according to the parallax of the two images captured by the first camera (122) and the second camera (126),
step 96: the selection system (627) implements a selection step of placing the battery case (35) into the target seventeenth battery compartment (698) by the robot (78) according to the three-dimensional information of the second vehicle-mounted battery case replacement system (617), step 97: after the robot (78) adjusts the posture, the fingers (124) of the manipulator (200) close and hold the battery box (35), and the manipulator (200) holds the battery box (35) and conveys the battery box (35) into a seventeenth battery compartment (698) of the second vehicle-mounted battery box replacement system (617),
step 98: a fourth output shaft (687) of the seventh motor (688) drives the fourth connecting rod (677) to rotate, the fourth connecting rod (677) drives the thirteenth grabbing plate (667) and the fourteenth grabbing plate (685) to move towards the battery box (35), the fourth connecting rod (677) triggers the twenty-first limiting switch (680) to enable the seventh motor (688) to stop rotating, and the thirteenth grabbing plate (667) and the fourteenth grabbing plate (685) clamp the battery box),
step 99: the monitoring device (626) ends the control after determining that the seventeenth battery compartment (698) of the second vehicle-mounted battery box replacement system (617) is placed in a battery box (35) predetermined by a remote operator (7),
step 100: the acquisition system (628) generates three-dimensional information of the second transfer robot (79) according to the distance from the vision sensor (631) to the sixteenth QR code 714 at the front of the second transfer robot (79) The acquisition system (628) calculates the distance from the vision sensor (631) to the sixteenth QR code 714 according to the parallax of the two images captured by the first camera (122) and the second camera (126),
step 101: a selection system (627) selects a selection process of a second transfer robot (79) taken out by a robot (78) according to three-dimensional information of a second transfer robot (79), the selection system (627) selects a second transfer robot (79) according to the position and posture of the second transfer robot (79),
step 102: the motion control system (629) sends an action instruction for driving the first pressure sensor (222) and the second pressure sensor (247) to a second programmable logic controller (224) of the manipulator control system (225) according to a pre-generated action program, and the second programmable logic controller (224) supplies power to the first pressure sensor (222) and the second pressure sensor (247),
step 103: after the robot (78) adjusts the posture, the finger part (124) of the manipulator (200) closes the first pressure sensor (222) and the second pressure sensor (247) holding the first transfer robot (77), and transmits the pressure information to the second programmable logic controller (224); after comparing the received pressure information with the preset information, the second programmable logic controller (224) determines that the second transfer robot (79) has been grasped; the second programmable logic controller (224) closes the fourth motor (205); the second transfer robot (79) is taken out on the second support (81); the manipulator (200) holds the second transfer robot (79) and conveys same to the first working point (591) of the first operation area (593),
step 104: after determining that the second transfer robot (79) predetermined by the remote operator (7) is taken out, the monitoring device (626) ends the control,
step 105: after the operation of the robot (78) in the first operation area (593) ends, the action control system (629) issues a control instruction according to a pre-generated action program to enable the second carrying robot (79) to start navigation, the magnetic navigation system (435) is in a closed state, and when the second visual navigation system (776) fails, the second visual navigation system (776) collects a second two-dimensional code (455) of the electric vehicle (41) to be subjected to battery replacement as a starting position, and sets a thirteenth two-dimensional code (469) of the battery box (35) as a second position to control the second carrying robot (79) to travel to the starting position,
step 106: the action control system (629) transmits an action instruction for driving the second terminal platform rotation control system (778) to a fourth wireless programmable logic controller (752) of the second terminal platform rotation control system (778) according to a pre-generated action program, the fourth wireless programmable logic controller (752) supplies power to the twelfth motor (745), the twelfth motor (745) drives the second terminal platform (718) to rotate to the twenty-fourth limit switch (750), the twelfth motor (745) stops rotating, the fifth camera (728) and the sixth camera (732) on the second terminal platform (718) are aligned with the thirteenth two-dimensional code (469) at the bottom of the power shortage battery box (35) for shooting, the acquisition system (628) calculates the distance from the fifth camera (728) and the sixth camera (732) to the thirteenth two-dimensional code (469) according to the parallax of the two images captured by the fifth camera (728) and the sixth camera (732), and generates three-dimensional information of the vehicle-mounted battery box replacement system (564) The acquisition system (628) calculates the distance from the fifth camera (728) and the sixth camera (732) to the thirteenth QR code (469) at the bottom of the battery box (35) according to the parallax of the two images captured by the fifth camera (728) and the sixth camera (732),
step 107: the second transfer robot leveling control system (751) is leveled to a predetermined height,
step 108: repeating the actions from step 7 to step 48,
step 109: the intelligent battery replacement vehicle (30) navigates to an optimal operation position near the electric vehicle (41) to be subjected to battery replacement according to the position coordinates of the electric vehicle (41) to be subjected to battery replacement,
step 110: repeating the actions of step 3,
step 111: repeating the actions of step 74,
step 112: the third programmable logic controller (597) supplies power to the thirteenth motor (789); the thirteenth motor (789) drives the rotating shaft (791) and the protective plate (787) to rotate to the twenty-sixth limiting switch (796) to rotate to the position of the twenty-sixth limiting switch (796); the twenty-sixth limiting switch (796) is triggered; the thirteenth motor (789) stops rotating; and at the moment, the side surface of the whole vehicle-mounted battery box replacement system (564) is exposed,
step 113: the acquisition system (628) generates three-dimensional information of the vehicle-mounted battery box replacement system (564) according to the distance from the visual sensor (631) to the first measurement point of the battery box (35) in the vehicle-mounted battery box replacement system (564) The acquisition system (628) calculates the distance from the visual sensor (631) to the first measurement point according to the parallax of the two images captured by the first camera (122) and the second camera (126),
step 114: a selection system (627) implements a selection step of selecting a battery case (35) in a target vehicle-mounted battery case replacement system (564) taken out by the robot (78) according to the three-dimensional information of the vehicle-mounted battery case replacement system (564),
step 115: the selection system (627) sets the target position of the robot (78) according to the position and posture of the target battery box (35), and the motion control system (629) enables the robot slider system (83) to drive the robot (78) to travel to the first operation position (74), and at this time, the finger (124) of the manipulator (200) is opened,
step 116: after the robot (78) adjusts the posture, the finger part (124) of the manipulator (200) closes and holds the battery box (35),
step 117: a third output shaft (561) of the sixth motor (562) drives the third screw rod section (576) to rotate, the third connecting rod (576) drives the ninth grabbing plate (569) and the tenth grabbing plate (571) to move towards the twenty-limiting switch (581), the third connecting rod (576) triggers the second ten-limiting switch (581) to stop rotating, and the ninth grabbing plate (569) and the tenth grabbing plate (571) are separated from the battery box),
step 118, the manipulator (200) takes out the battery box (35) in the vehicle-mounted battery box replacement system (564), the manipulator (200) holds the battery box (35),
step 119: repeating the actions from step 56 to step 60,
step 120: repeating the actions from step 26 to step 31,
step 121: the acquisition system (628) generates three-dimensional information of the vehicle-mounted battery box replacement system (564) according to the distance from the visual sensor (631) to the vacant vehicle-mounted battery box replacement system (564) the acquisition system (628) calculates the distance from the visual sensor (631) to the vehicle-mounted battery box replacement system (564) according to the parallax of the two images captured by the first camera (122) and the second camera (126),
step 122: the selection system (627) selects a selection process for placing the battery case (35) into the target vehicle-mounted battery case replacement system (564) by the robot (78) according to the three-dimensional information of the vehicle-mounted battery case replacement system (564),
step 123: after the robot (78) adjusts the posture, the finger part (124) of the manipulator (200) closes and holds the battery box (35), and the manipulator (200) holds the battery box (35) and conveys the battery box (35) into the vehicle-mounted battery box replacement system (564),
step 124: the action control system (629) sends an action instruction for driving the battery box replacement control system (598) to a third programmable logic controller (597) of the battery box replacement control system (598) according to a pre-generated action program, the third programmable logic controller (597) supplies power to the sixth motor (562) according to the action instruction, a third output shaft (561) of the sixth motor (562) drives the third screw rod section (577) to rotate in the forward direction, and the third screw rod section (577) pushes the third connecting rod (576) to move towards the battery box (35), the third connecting rod (576) drives the ninth grabbing plate (569) and the tenth grabbing plate (571) to move towards the battery box (35), the third connecting rod (576) runs to the nineteenth limiting switch (579), the nineteenth limiting switch (579) is triggered to enable the sixth motor (562) to stop rotating, the ninth grabbing plate (569) and the tenth grabbing plate (571) are closed to the seventh grabbing plate (245) and the eighth grabbing plate (228), and the ninth grabbing plate (569) and the tenth grabbing plate (571) clamp the battery box),
step 125: The monitoring device (626) ends the control after determining that the battery box (35) predetermined by the remote operator (7) is placed in the vehicle-mounted battery box replacement system (564),
step 126: the action control system (629) sends an action instruction of the drive guard plate rotation control system (798) to a third programmable logic controller (597) of the guard plate rotation control system (798) according to a pre-generated action program, the third programmable logic controller (597) supplies power to the thirteenth motor (789), the thirteenth motor (789) drives the rotation shaft (791) and the guard plate (787) to rotate to the twenty-fifth limit switch (795), rotates to the position of the twenty-fifth limit switch (795), triggers the twenty-fifth limit switch (795), the thirteenth motor (789) stops rotating, and the guard plate (787) is closed,
step 127: the second electric vehicle to be replaced (780) navigates to the optimal operation position near the fourth charging and swapping cabinet (781) according to the position coordinates provided by the remote client attendant (6),
step 128: repeating steps 85 and 86,
step 129: the remote operator (7) activates a control system of the second robot (735), ie the robot (78), the selection system (627) sets the position of the robot (78) according to the position coordinates of the target second electric vehicle (780) to be replaced, and the motion control system (629) enables the robot (78) to enter the operation position, and at this time, the fingers (124) of the manipulator (200) are opened,
step 130: repeating the actions from step 87 to step 92,
step 131: repeating the actions from step 68 to step 73,
step 132: repeating the actions from step 50 to step 55,
step 133: repeating the actions from step 95 to step 99.
